(19) United States
(12) Patent Application Publication
(10) Pub. No.: US 2026/0019699 A1
(43) Pub. Date: Jan. 15, 2026

(54) CAMERA USER INTERFACE

(71) Applicant: Apple Inc., Cupertino, CA (US)

(72) Inventors: Johnnie B. MANZARI, San Francisco, CA (US); Jeffrey A. BRASKET, San Francisco, CA (US); Brandon J. COREY, Palo Alto, CA (US); Alan C. DYE, San Francisco, CA (US); Craig M. FEDERIGHI, Los Altos, CA (US); Jonathan I. MCCORMACK, Los Altos, CA (US); Aaron MORING, Antioch, CA (US); William A. SORRENTINO, III, Kentfield, CA (US); Andre SOUZA DOS SANTOS, Curitiba (BR); Adrian ZUMBRUNNEN, San Francisco, CA (US)

(21) Appl. No.: 19/080,583

(22) Filed: Mar. 14, 2025

Related U.S. Application Data
(60) Provisional application No. 63/654,870, filed on May 31, 2024.

(51) Int. Cl. H04N 23/62; G06F 3/04817; G06F 3/0488; H04N 23/58; H04N 23/61; H04N 23/63; H04N 23/667; H04N 23/69

(52) U.S. Cl. CPC H04N 23/62; G06F 3/04817; G06F 3/0488; H04N 23/58; H04N 23/61; H04N 23/632; H04N 23/633; H04N 23/667; H04N 23/69

(57) ABSTRACT

The present disclosure generally relates to user interfaces for media capture, including user interfaces with capture controls for both stopping and pausing an ongoing video capture, user interfaces with integrated controls for simulated capture effects, and user interfaces for spatial capture with both limited-duration and variable-duration capture types.

### RELATED APPLICATIONS

This application claims priority to U.S. Provisional Patent Application Ser. No. 63/654,870, entitled “CAMERA USER INTERFACE”, filed on May 31, 2024, the contents of which are hereby incorporated by reference in their entirety.

### FIELD

The present disclosure relates generally to computer user interfaces, and more specifically to techniques for controlling media captures.

### BACKGROUND

Electronic devices, such as smart phones, tablets, and wearable devices, provide user interfaces for composing and capturing media, such as photo and video media. Example user interfaces for media capture can be interacted with (e.g., controlled) using displayed software controls, such as user interface elements that can be interacted with via a touch-sensitive surface of a display, and hardware controls, such as buttons and switches, to adjust capture settings, capture media, and view media.

### BRIEF SUMMARY

Some techniques for controlling media captures using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for controlling media captures. Such methods and interfaces optionally complement or replace other methods for controlling media captures. Such methods and interfaces reduce the cognitive burden on a user and produce a more efficient human-machine interface. Such methods and interfaces reduce the time and number of inputs used for controlling media captures and provide improved visual feedback on a state of a computer system without cluttering the display. For battery-operated computing devices, such methods and interfaces conserve power and increase the time between battery charges.

In accordance with some embodiments, a method is described. The method is performed at a computer system that is in communication with one or more display generation components, one or more input devices, and one or more cameras, and comprises: while displaying, via the one or more display generation components, a media capture user interface including a first video recording user interface object displayed with a first appearance, detecting, via the one or more input devices, a first input directed to the first video recording user interface object; in response to detecting the first input directed to the first video recording user interface object: initiating capturing first video media using the one or more cameras; displaying, via the one or more display generation components, the first video recording user interface object with a second appearance different from the first appearance; and displaying, via the one or more display generation components, a second video recording user interface object with a third appearance different from the first appearance and different from the second appearance; while capturing the first video media, detecting, via the one or more input devices, a second input directed to the media capture user interface; and in response to detecting the second input directed to the media capture user interface: in accordance with a determination that the second input is directed to the first video recording user interface object, ceasing capturing the first video media using the one or more cameras; and in accordance with a determination that the second input is directed to the second video recording user interface object, pausing capturing the first video media, using the one or more cameras, while maintaining ability to resume capturing the first video media.

In accordance with some embodiments, a non-transitory computer-readable storage medium is described. The non-transitory computer-readable storage medium stores one or more programs configured to be executed by one or more processors of a computer system that is in communication with one or more display generation components, one or more input devices, and one or more cameras, the one or more programs including instructions for: while displaying, via the one or more display generation components, a media capture user interface including a first video recording user interface object displayed with a first appearance, detecting, via the one or more input devices, a first input directed to the first video recording user interface object; in response to detecting the first input directed to the first video recording user interface object: initiating capturing first video media using the one or more cameras; displaying, via the one or more display generation components, the first video recording user interface object with a second appearance different from the first appearance; and displaying, via the one or more display generation components, a second video recording user interface object with a third appearance different from the first appearance and different from the second appearance; while capturing the first video media, detecting, via the one or more input devices, a second input directed to the media capture user interface; and in response to detecting the second input directed to the media capture user interface: in accordance with a determination that the second input is directed to the first video recording user interface object, ceasing capturing the first video media using the one or more cameras; and in accordance with a determination that the second input is directed to the second video recording user interface object, pausing capturing the first video media, using the one or more cameras, while maintaining ability to resume capturing the first video media.

In accordance with some embodiments, a transitory computer-readable storage medium is described. The transitory computer-readable storage medium stores one or more programs configured to be executed by one or more processors of a computer system that is in communication with one or more display generation components, one or more input devices, and one or more cameras, the one or more programs including instructions for: while displaying, via the one or more display generation components, a media capture user interface including a first video recording user interface object displayed with a first appearance, detecting, via the one or more input devices, a first input directed to the first video recording user interface object; in response to detecting the first input directed to the first video recording user interface object: initiating capturing first video media using the one or more cameras; displaying, via the one or more display generation components, the first video recording user interface object with a second appearance different from the first appearance; and displaying, via the one or more display generation components, a second video recording user interface object with a third appearance different from the first appearance and different from the second appearance; while capturing the first video media, detecting, via the one or more input devices, a second input directed to the media capture user interface; and in response to detecting the second input directed to the media capture user interface: in accordance with a determination that the second input is directed to the first video recording user interface object, ceasing capturing the first video media using the one or more cameras; and in accordance with a determination that the second input is directed to the second video recording user interface object, pausing capturing the first video media, using the one or more cameras, while maintaining ability to resume capturing the first video media.

In accordance with some embodiments, a computer system is described. The computer system is configured to communicate with one or more display generation components, one or more input devices, and one or more cameras, the computer system comprising one or more processors and memory storing one or more programs configured to be executed by the one or more processors, the one or more programs including instructions for: while displaying, via the one or more display generation components, a media capture user interface including a first video recording user interface object displayed with a first appearance, detecting, via the one or more input devices, a first input directed to the first video recording user interface object; in response to detecting the first input directed to the first video recording user interface object: initiating capturing first video media using the one or more cameras; displaying, via the one or more display generation components, the first video recording user interface object with a second appearance different from the first appearance; and displaying, via the one or more display generation components, a second video recording user interface object with a third appearance different from the first appearance and different from the second appearance; while capturing the first video media, detecting, via the one or more input devices, a second input directed to the media capture user interface; and in response to detecting the second input directed to the media capture user interface: in accordance with a determination that the second input is directed to the first video recording user interface object, ceasing capturing the first video media using the one or more cameras; and in accordance with a determination that the second input is directed to the second video recording user interface object, pausing capturing the first video media, using the one or more cameras, while maintaining ability to resume capturing the first video media.

In accordance with some embodiments, a computer system is described. The computer system is configured to communicate with one or more display generation components, one or more input devices, and one or more cameras, the computer system comprising: means for, while displaying, via the one or more display generation components, a media capture user interface including a first video recording user interface object displayed with a first appearance, detecting, via the one or more input devices, a first input directed to the first video recording user interface object; means for, in response to detecting the first input directed to the first video recording user interface object: initiating capturing first video media using the one or more cameras; displaying, via the one or more display generation components, the first video recording user interface object with a second appearance different from the first appearance; and displaying, via the one or more display generation components, a second video recording user interface object with a third appearance different from the first appearance and different from the second appearance; means for, while capturing the first video media, detecting, via the one or more input devices, a second input directed to the media capture user interface; and means for, in response to detecting the second input directed to the media capture user interface: in accordance with a determination that the second input is directed to the first video recording user interface object, ceasing capturing the first video media using the one or more cameras; and in accordance with a determination that the second input is directed to the second video recording user interface object, pausing capturing the first video media, using the one or more cameras, while maintaining ability to resume capturing the first video media.

In accordance with some embodiments, a computer program product is described. The computer program product comprises one or more programs configured to be executed by one or more processors of a computer system that is in communication with one or more display generation components, one or more input devices, and one or more cameras, the one or more programs including instructions for: while displaying, via the one or more display generation components, a media capture user interface including a first video recording user interface object displayed with a first appearance, detecting, via the one or more input devices, a first input directed to the first video recording user interface object; in response to detecting the first input directed to the first video recording user interface object: initiating capturing first video media using the one or more cameras; displaying, via the one or more display generation components, the first video recording user interface object with a second appearance different from the first appearance; and displaying, via the one or more display generation components, a second video recording user interface object with a third appearance different from the first appearance and different from the second appearance; while capturing the first video media, detecting, via the one or more input devices, a second input directed to the media capture user interface; and in response to detecting the second input directed to the media capture user interface: in accordance with a determination that the second input is directed to the first video recording user interface object, ceasing capturing the first video media using the one or more cameras; and in accordance with a determination that the second input is directed to the second video recording user interface object, pausing capturing the first video media, using the one or more cameras, while maintaining ability to resume capturing the first video media.

In accordance with some embodiments, a method is described. The method is performed at a computer system that is in communication with one or more display generation components, one or more input devices, and one or more cameras, and comprises: displaying, via the one or more display generation components, a media capture user interface, wherein displaying the media capture user interface includes: in accordance with a determination that a set of one or more portrait criteria is satisfied, displaying a camera preview and a portrait capture mode user interface object; and in accordance with a determination that the set of one or more portrait criteria is not satisfied, displaying the camera preview without displaying the portrait capture mode user interface object; while displaying the media capture user interface and while a portrait capture mode is not enabled, detecting, via the one or more input devices, an input directed to the portrait capture mode user interface object; in response to detecting the input directed to the portrait capture mode user interface object: changing an appearance of the media capture user interface to indicate that the portrait capture mode has been enabled; and displaying, via the one or more display generation components, a portrait filter control object that, when selected, initiate a process for selecting, from a set of one or more portrait filters, a portrait filter to be used when capturing media with the portrait capture mode enabled; detecting, via the one or more input devices, a sequence of one or more inputs including an input directed to the portrait filter control object; and in response to detecting the sequence of one or more inputs, selecting a respective portrait filter from the set of one or more portrait filters as the portrait filter to be used when capturing media with the portrait capture mode enabled.

In accordance with some embodiments, a non-transitory computer-readable storage medium is described. The non-transitory computer-readable storage medium stores one or more programs configured to be executed by one or more processors of a computer system that is in communication with one or more display generation components, one or more input devices, and one or more cameras, the one or more programs including instructions for: displaying, via the one or more display generation components, a media capture user interface, wherein displaying the media capture user interface includes: in accordance with a determination that a set of one or more portrait criteria is satisfied, displaying a camera preview and a portrait capture mode user interface object; and in accordance with a determination that the set of one or more portrait criteria is not satisfied, displaying the camera preview without displaying the portrait capture mode user interface object; while displaying the media capture user interface and while a portrait capture mode is not enabled, detecting, via the one or more input devices, an input directed to the portrait capture mode user interface object; in response to detecting the input directed to the portrait capture mode user interface object: changing an appearance of the media capture user interface to indicate that the portrait capture mode has been enabled; and displaying, via the one or more display generation components, a portrait filter control object that, when selected, initiate a process for selecting, from a set of one or more portrait filters, a portrait filter to be used when capturing media with the portrait capture mode enabled; detecting, via the one or more input devices, a sequence of one or more inputs including an input directed to the portrait filter control object; and in response to detecting the sequence of one or more inputs, selecting a respective portrait filter from the set of one or more portrait filters as the portrait filter to be used when capturing media with the portrait capture mode enabled.

In accordance with some embodiments, a transitory computer-readable storage medium is described. The transitory computer-readable storage medium stores one or more programs configured to be executed by one or more processors of a computer system that is in communication with one or more display generation components, one or more input devices, and one or more cameras, the one or more programs including instructions for: displaying, via the one or more display generation components, a media capture user interface, wherein displaying the media capture user interface includes: in accordance with a determination that a set of one or more portrait criteria is satisfied, displaying a camera preview and a portrait capture mode user interface object; and in accordance with a determination that the set of one or more portrait criteria is not satisfied, displaying the camera preview without displaying the portrait capture mode user interface object; while displaying the media capture user interface and while a portrait capture mode is not enabled, detecting, via the one or more input devices, an input directed to the portrait capture mode user interface object; in response to detecting the input directed to the portrait capture mode user interface object: changing an appearance of the media capture user interface to indicate that the portrait capture mode has been enabled; and displaying, via the one or more display generation components, a portrait filter control object that, when selected, initiate a process for selecting, from a set of one or more portrait filters, a portrait filter to be used when capturing media with the portrait capture mode enabled; detecting, via the one or more input devices, a sequence of one or more inputs including an input directed to the portrait filter control object; and in response to detecting the sequence of one or more inputs, selecting a respective portrait filter from the set of one or more portrait filters as the portrait filter to be used when capturing media with the portrait capture mode enabled.

In accordance with some embodiments, a computer system is described. The computer system is configured to communicate with one or more display generation components, one or more input devices, and one or more cameras, the computer system comprising one or more processors and memory storing one or more programs configured to be executed by the one or more processors, the one or more programs including instructions for: displaying, via the one or more display generation components, a media capture user interface, wherein displaying the media capture user interface includes: in accordance with a determination that a set of one or more portrait criteria is satisfied, displaying a camera preview and a portrait capture mode user interface object; and in accordance with a determination that the set of one or more portrait criteria is not satisfied, displaying the camera preview without displaying the portrait capture mode user interface object; while displaying the media capture user interface and while a portrait capture mode is not enabled, detecting, via the one or more input devices, an input directed to the portrait capture mode user interface object; in response to detecting the input directed to the portrait capture mode user interface object: changing an appearance of the media capture user interface to indicate that the portrait capture mode has been enabled; and displaying, via the one or more display generation components, a portrait filter control object that, when selected, initiate a process for selecting, from a set of one or more portrait filters, a portrait filter to be used when capturing media with the portrait capture mode enabled; detecting, via the one or more input devices, a sequence of one or more inputs including an input directed to the portrait filter control object; and in response to detecting the sequence of one or more inputs, selecting a respective portrait filter from the set of one or more portrait filters as the portrait filter to be used when capturing media with the portrait capture mode enabled.

In accordance with some embodiments, a computer system is described. The computer system is configured to communicate with one or more display generation components, one or more input devices, and one or more cameras, the computer system comprising: means for displaying, via the one or more display generation components, a media capture user interface, wherein displaying the media capture user interface includes: in accordance with a determination that a set of one or more portrait criteria is satisfied, displaying a camera preview and a portrait capture mode user interface object; and in accordance with a determination that the set of one or more portrait criteria is not satisfied, displaying the camera preview without displaying the portrait capture mode user interface object; means for, while displaying the media capture user interface and while a portrait capture mode is not enabled, detecting, via the one or more input devices, an input directed to the portrait capture mode user interface object; means for, in response to detecting the input directed to the portrait capture mode user interface object: changing an appearance of the media capture user interface to indicate that the portrait capture mode has been enabled; and displaying, via the one or more display generation components, a portrait filter control object that, when selected, initiate a process for selecting, from a set of one or more portrait filters, a portrait filter to be used when capturing media with the portrait capture mode enabled; means for detecting, via the one or more input devices, a sequence of one or more inputs including an input directed to the portrait filter control object; and means for, in response to detecting the sequence of one or more inputs, selecting a respective portrait filter from the set of one or more portrait filters as the portrait filter to be used when capturing media with the portrait capture mode enabled.

In accordance with some embodiments, a computer program product is described. The computer program product comprises one or more programs configured to be executed by one or more processors of a computer system that is in communication with one or more display generation components, one or more input devices, and one or more cameras, the one or more programs including instructions for: displaying, via the one or more display generation components, a media capture user interface, wherein displaying the media capture user interface includes: in accordance with a determination that a set of one or more portrait criteria is satisfied, displaying a camera preview and a portrait capture mode user interface object; and in accordance with a determination that the set of one or more portrait criteria is not satisfied, displaying the camera preview without displaying the portrait capture mode user interface object; while displaying the media capture user interface and while a portrait capture mode is not enabled, detecting, via the one or more input devices, an input directed to the portrait capture mode user interface object; in response to detecting the input directed to the portrait capture mode user interface object: changing an appearance of the media capture user interface to indicate that the portrait capture mode has been enabled; and displaying, via the one or more display generation components, a portrait filter control object that, when selected, initiate a process for selecting, from a set of one or more portrait filters, a portrait filter to be used when capturing media with the portrait capture mode enabled; detecting, via the one or more input devices, a sequence of one or more inputs including an input directed to the portrait filter control object; and in response to detecting the sequence of one or more inputs, selecting a respective portrait filter from the set of one or more portrait filters as the portrait filter to be used when capturing media with the portrait capture mode enabled.

In accordance with some embodiments, a method is described. The method is performed at a computer system that is in communication with one or more display generation components, one or more input devices, and a plurality of cameras including a first camera and a second camera that is different from the first camera, and comprises: displaying, via the one or more display generation components, a spatial media capture user interface that includes a spatial capture type user interface object; while displaying the spatial media capture user interface, detecting, via the one or more input devices, an input directed to the spatial capture type user interface object while a spatial capture mode is configured to capture a respective type of spatial media of a plurality of different types of spatial media; in response to detecting the input directed to the spatial capture type user interface object, changing a type of spatial media that the spatial capture mode is configured to capture; after changing the type of spatial media that the spatial capture mode is configured to capture, detecting, via the one or more input devices, a request to capture media using the spatial media capture user interface; and in response to detecting the request to capture media, capturing respective spatial media that includes stereoscopic depth information captured by two or more of the plurality of cameras, wherein: in accordance with a determination that the spatial capture mode is configured to capture a first type of spatial media of the plurality of different types of spatial media when the request to capture media is detected, the respective spatial media is the first type of spatial media; and in accordance with a determination that the spatial capture mode is configured to capture a second type of spatial media of the plurality of different types of spatial media when the request to capture media is detected, the respective spatial media is the second type of spatial media, wherein the first type of spatial media has a fixed duration and the second type of spatial media has a variable duration determined based on user input.

In accordance with some embodiments, a non-transitory computer-readable storage medium is described. The non-transitory computer-readable storage medium stores one or more programs configured to be executed by one or more processors of a computer system that is in communication with one or more display generation components, one or more input devices, and a plurality of cameras including a first camera and a second camera that is different from the first camera, the one or more programs including instructions for: displaying, via the one or more display generation components, a spatial media capture user interface that includes a spatial capture type user interface object; while displaying the spatial media capture user interface, detecting, via the one or more input devices, an input directed to the spatial capture type user interface object while a spatial capture mode is configured to capture a respective type of spatial media of a plurality of different types of spatial media; in response to detecting the input directed to the spatial capture type user interface object, changing a type of spatial media that the spatial capture mode is configured to capture; after changing the type of spatial media that the spatial capture mode is configured to capture, detecting, via the one or more input devices, a request to capture media using the spatial media capture user interface; and in response to detecting the request to capture media, capturing respective spatial media that includes stereoscopic depth information captured by two or more of the plurality of cameras, wherein: in accordance with a determination that the spatial capture mode is configured to capture a first type of spatial media of the plurality of different types of spatial media when the request to capture media is detected, the respective spatial media is the first type of spatial media; and in accordance with a determination that the spatial capture mode is configured to capture a second type of spatial media of the plurality of different types of spatial media when the request to capture media is detected, the respective spatial media is the second type of spatial media, wherein the first type of spatial media has a fixed duration and the second type of spatial media has a variable duration determined based on user input.

In accordance with some embodiments, a transitory computer-readable storage medium is described. The transitory computer-readable storage medium stores one or more programs configured to be executed by one or more processors of a computer system that is in communication with one or more display generation components, one or more input devices, and a plurality of cameras including a first camera and a second camera that is different from the first camera, the one or more programs including instructions for: displaying, via the one or more display generation components, a spatial media capture user interface that includes a spatial capture type user interface object; while displaying the spatial media capture user interface, detecting, via the one or more input devices, an input directed to the spatial capture type user interface object while a spatial capture mode is configured to capture a respective type of spatial media of a plurality of different types of spatial media; in response to detecting the input directed to the spatial capture type user interface object, changing a type of spatial media that the spatial capture mode is configured to capture; after changing the type of spatial media that the spatial capture mode is configured to capture, detecting, via the one or more input devices, a request to capture media using the spatial media capture user interface; and in response to detecting the request to capture media, capturing respective spatial media that includes stereoscopic depth information captured by two or more of the plurality of cameras, wherein: in accordance with a determination that the spatial capture mode is configured to capture a first type of spatial media of the plurality of different types of spatial media when the request to capture media is detected, the respective spatial media is the first type of spatial media; and in accordance with a determination that the spatial capture mode is configured to capture a second type of spatial media of the plurality of different types of spatial media when the request to capture media is detected, the respective spatial media is the second type of spatial media, wherein the first type of spatial media has a fixed duration and the second type of spatial media has a variable duration determined based on user input.

In accordance with some embodiments, a computer system is described. The computer system is configured to communicate with one or more display generation components, one or more input devices, and a plurality of cameras including a first camera and a second camera that is different from the first camera, the computer system comprising one or more processors and memory storing one or more programs configured to be executed by the one or more processors, the one or more programs including instructions for: displaying, via the one or more display generation components, a spatial media capture user interface that includes a spatial capture type user interface object; while displaying the spatial media capture user interface, detecting, via the one or more input devices, an input directed to the spatial capture type user interface object while a spatial capture mode is configured to capture a respective type of spatial media of a plurality of different types of spatial media; in response to detecting the input directed to the spatial capture type user interface object, changing a type of spatial media that the spatial capture mode is configured to capture; after changing the type of spatial media that the spatial capture mode is configured to capture, detecting, via the one or more input devices, a request to capture media using the spatial media capture user interface; and in response to detecting the request to capture media, capturing respective spatial media that includes stereoscopic depth information captured by two or more of the plurality of cameras, wherein: in accordance with a determination that the spatial capture mode is configured to capture a first type of spatial media of the plurality of different types of spatial media when the request to capture media is detected, the respective spatial media is the first type of spatial media; and in accordance with a determination that the spatial capture mode is configured to capture a second type of spatial media of the plurality of different types of spatial media when the request to capture media is detected, the respective spatial media is the second type of spatial media, wherein the first type of spatial media has a fixed duration and the second type of spatial media has a variable duration determined based on user input.

In accordance with some embodiments, a computer system is described. The computer system is configured to communicate with one or more display generation components, one or more input devices, and a plurality of cameras including a first camera and a second camera that is different from the first camera, the computer system comprising: means for displaying, via the one or more display generation components, a spatial media capture user interface that includes a spatial capture type user interface object; means for, while displaying the spatial media capture user interface, detecting, via the one or more input devices, an input directed to the spatial capture type user interface object while a spatial capture mode is configured to capture a respective type of spatial media of a plurality of different types of spatial media; means for, in response to detecting the input directed to the spatial capture type user interface object, changing a type of spatial media that the spatial capture mode is configured to capture; means for, after changing the type of spatial media that the spatial capture mode is configured to capture, detecting, via the one or more input devices, a request to capture media using the spatial media capture user interface; and means for, in response to detecting the request to capture media, capturing respective spatial media that includes stereoscopic depth information captured by two or more of the plurality of cameras, wherein: in accordance with a determination that the spatial capture mode is configured to capture a first type of spatial media of the plurality of different types of spatial media when the request to capture media is detected, the respective spatial media is the first type of spatial media; and in accordance with a determination that the spatial capture mode is configured to capture a second type of spatial media of the plurality of different types of spatial media when the request to capture media is detected, the respective spatial media is the second type of spatial media, wherein the first type of spatial media has a fixed duration and the second type of spatial media has a variable duration determined based on user input.

In accordance with some embodiments, a computer program product is described. The computer program product comprises one or more programs configured to be executed by one or more processors of a computer system that is in communication with one or more display generation components, one or more input devices, and a plurality of cameras including a first camera and a second camera that is different from the first camera, the one or more programs including instructions for: displaying, via the one or more display generation components, a spatial media capture user interface that includes a spatial capture type user interface object; while displaying the spatial media capture user interface, detecting, via the one or more input devices, an input directed to the spatial capture type user interface object while a spatial capture mode is configured to capture a respective type of spatial media of a plurality of different types of spatial media; in response to detecting the input directed to the spatial capture type user interface object, changing a type of spatial media that the spatial capture mode is configured to capture; after changing the type of spatial media that the spatial capture mode is configured to capture, detecting, via the one or more input devices, a request to capture media using the spatial media capture user interface; and in response to detecting the request to capture media, capturing respective spatial media that includes stereoscopic depth information captured by two or more of the plurality of cameras, wherein: in accordance with a determination that the spatial capture mode is configured to capture a first type of spatial media of the plurality of different types of spatial media when the request to capture media is detected, the respective spatial media is the first type of spatial media; and in accordance with a determination that the spatial capture mode is configured to capture a second type of spatial media of the plurality of different types of spatial media when the request to capture media is detected, the respective spatial media is the second type of spatial media, wherein the first type of spatial media has a fixed duration and the second type of spatial media has a variable duration determined based on user input.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for controlling media captures, thereby increasing the effectiveness, efficiency, and user satisfaction with such devices. Such methods and interfaces may complement or replace other methods for controlling media captures.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5H illustrate exemplary components of a personal electronic device having a touch-sensitive display and intensity sensors in accordance with some embodiments.

FIGS. 6A-6P illustrate example techniques and systems for controlling video media capture, in accordance with some embodiments.

FIGS. 7A-7B are a flow diagram of methods for controlling video media capture, in accordance with some embodiments.

FIGS. 8A-8V illustrate example techniques and systems for controlling media capture effects, in accordance with some embodiments.

FIGS. 9A-9B are a flow diagram of methods for controlling media capture effects, in accordance with some embodiments.

FIGS. 10A-10K illustrate example techniques and systems for controlling spatial media captures, in accordance with some embodiments.

FIG. 11 is a flow diagram of methods for controlling spatial media captures, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for controlling media captures. For example, an efficient user interfaces can integrate both pause and stop recording functionality while capturing video media, integrate portrait capture effects into a standard media capture interface, and/or integrate multiple capture types into a spatial media capture user interface, reducing the time and number of inputs needed to access various media capture capabilities while intuitively conveying information about the state of media capture. Such techniques can reduce the cognitive burden on a user who use computer systems to control media captures, thereby enhancing productivity. Further, such techniques can reduce processor and battery power otherwise wasted on redundant, inadvertent, or mistaken user inputs.

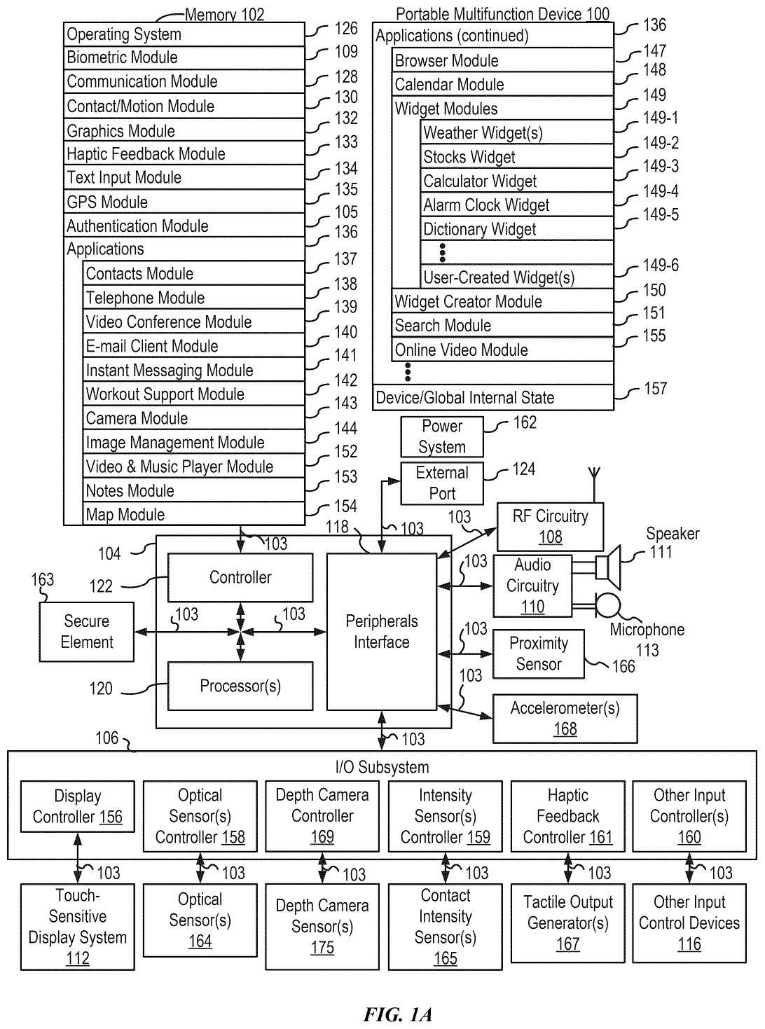

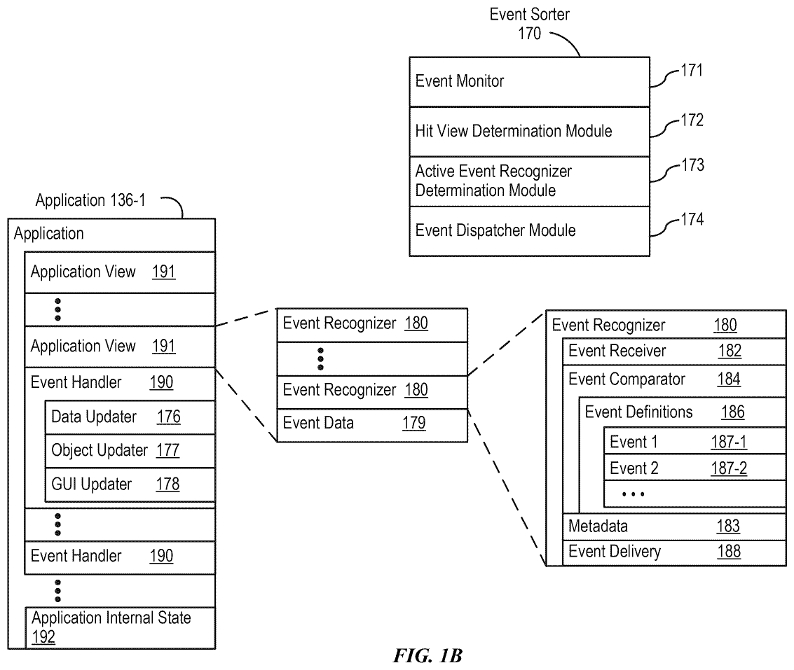

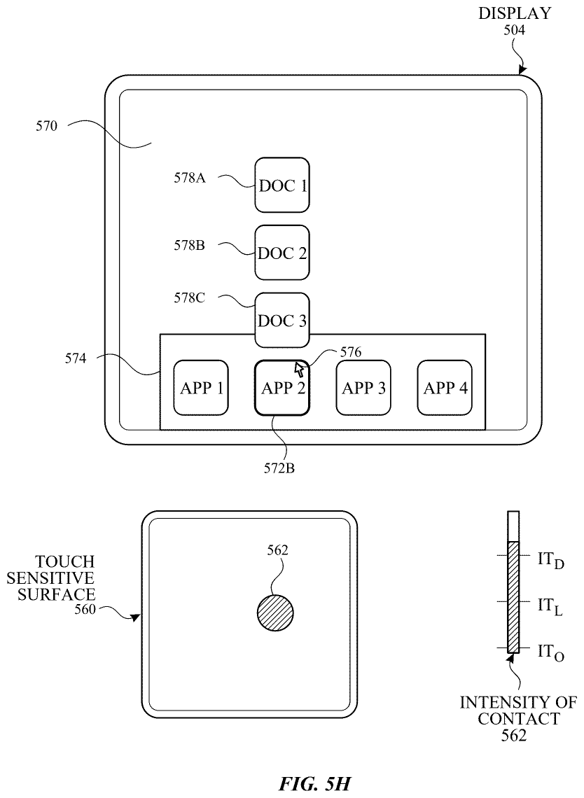

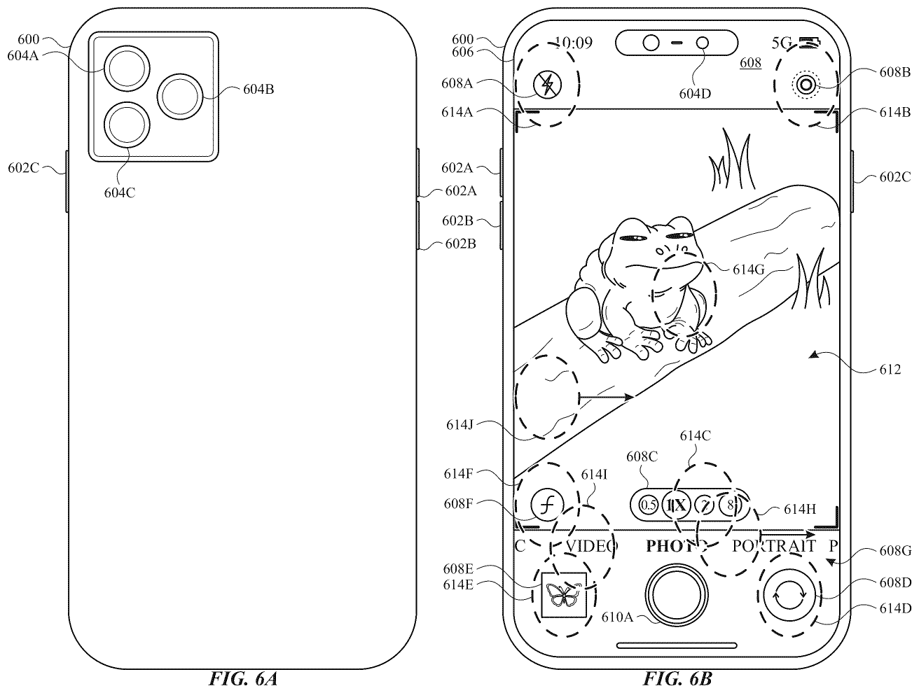

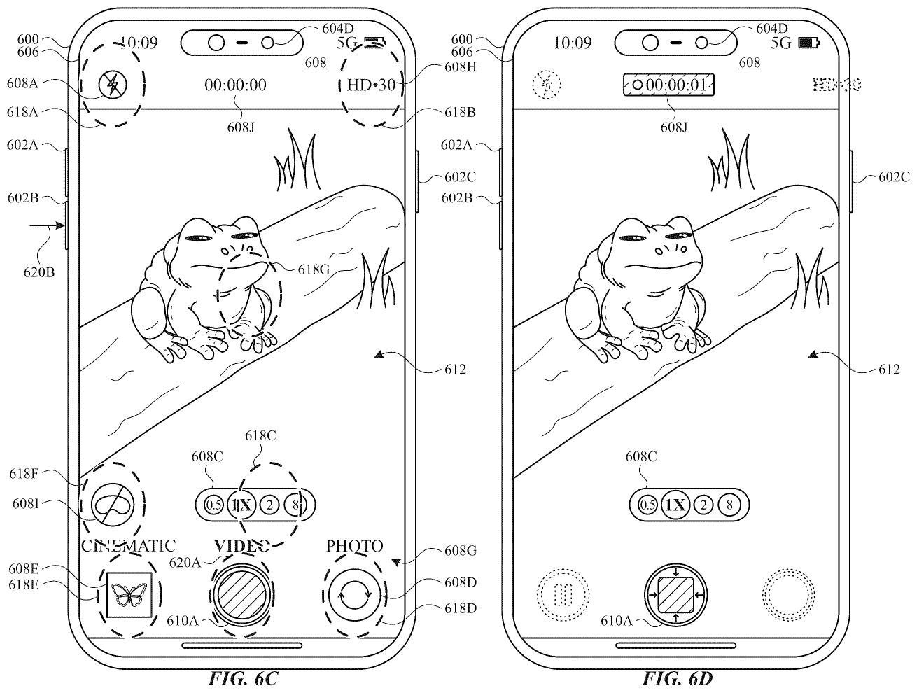

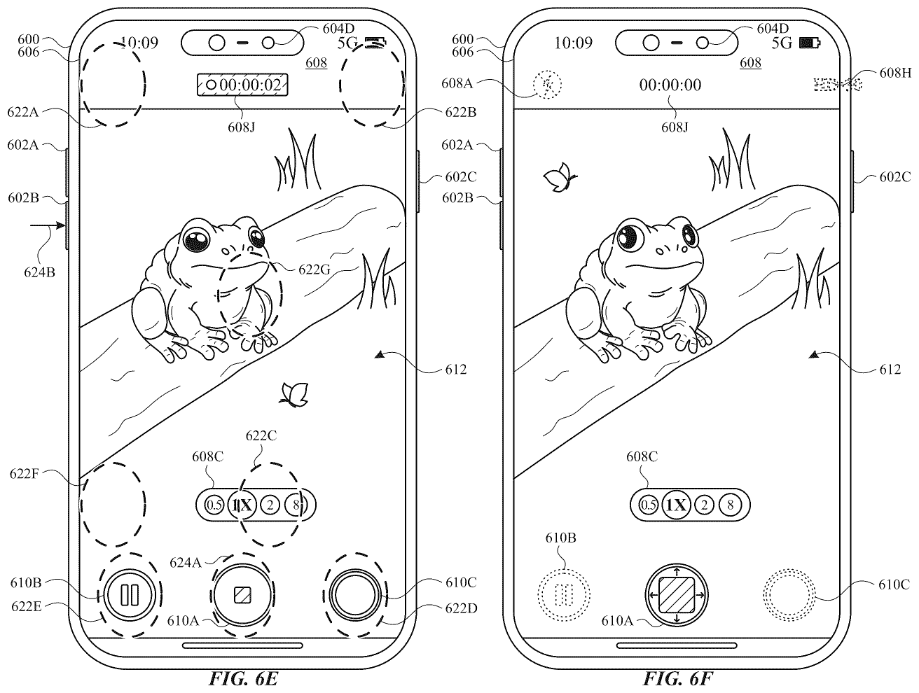

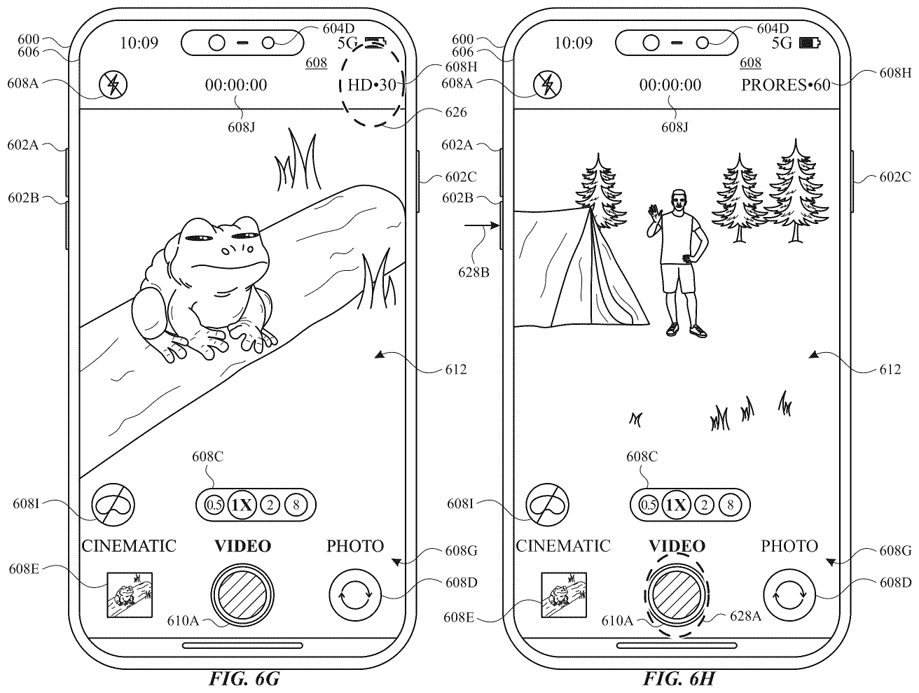

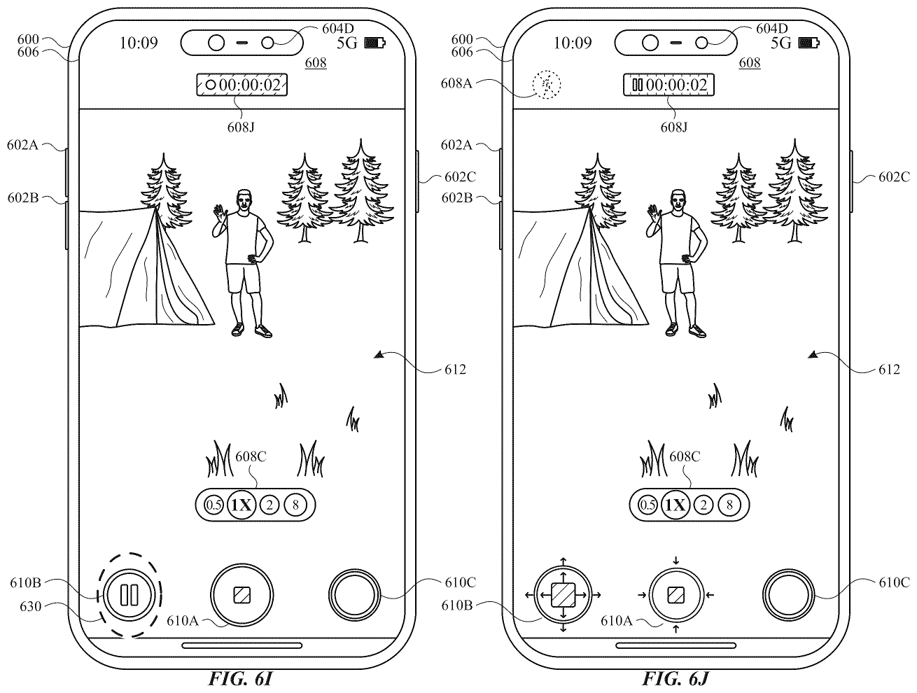

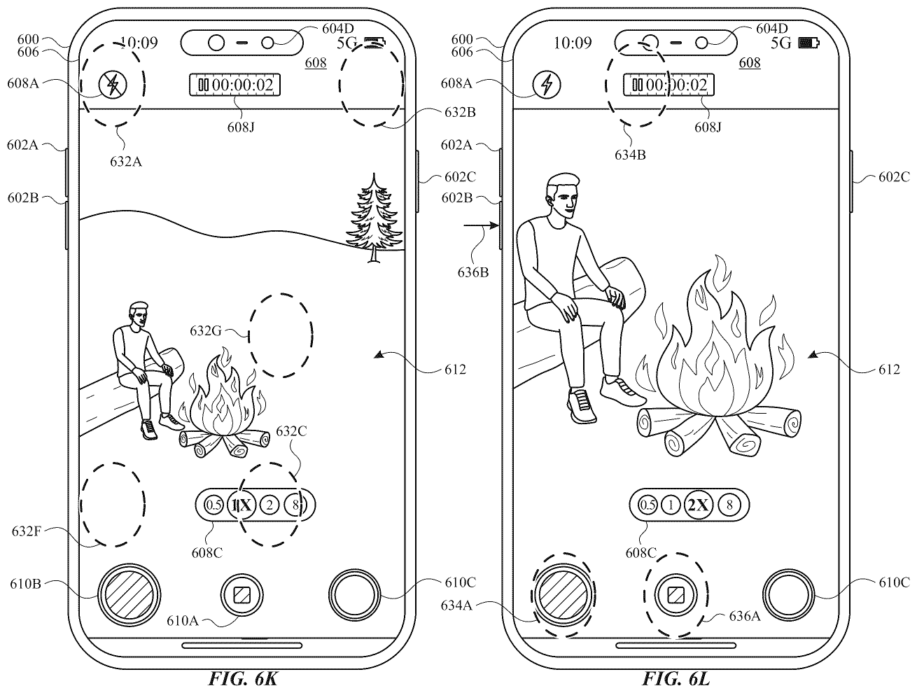

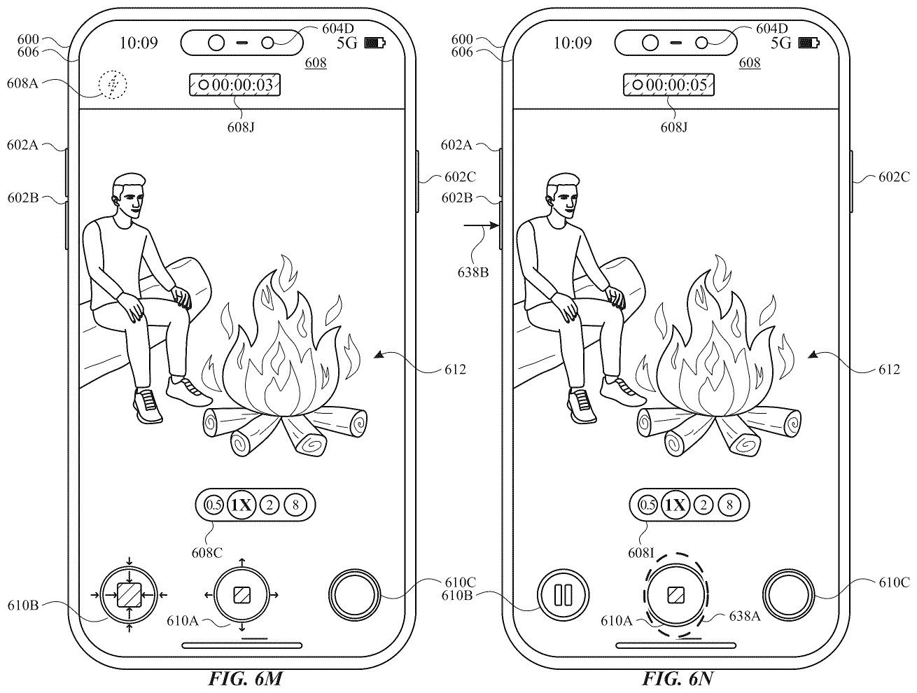

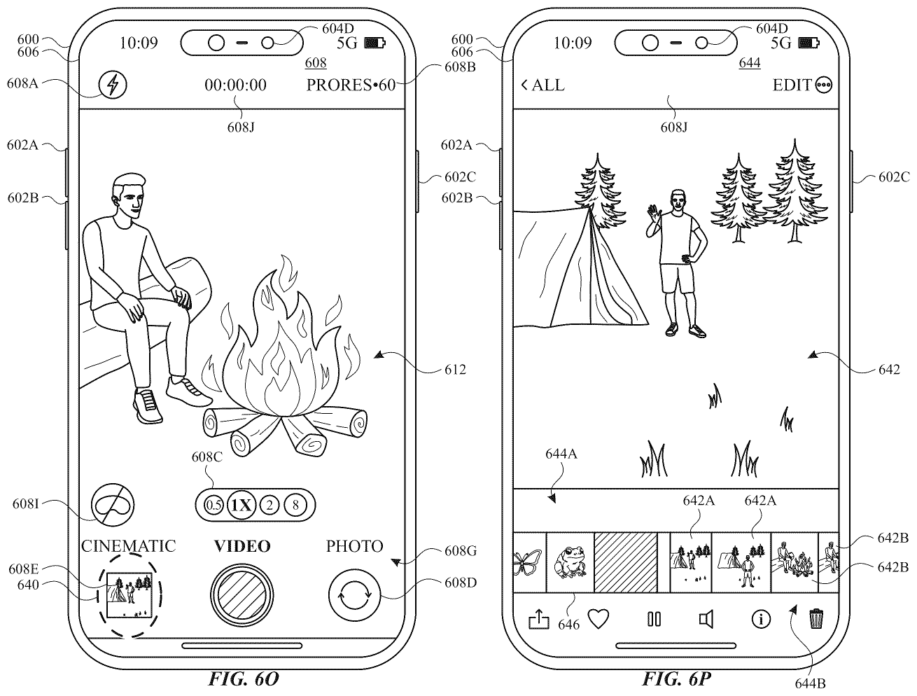

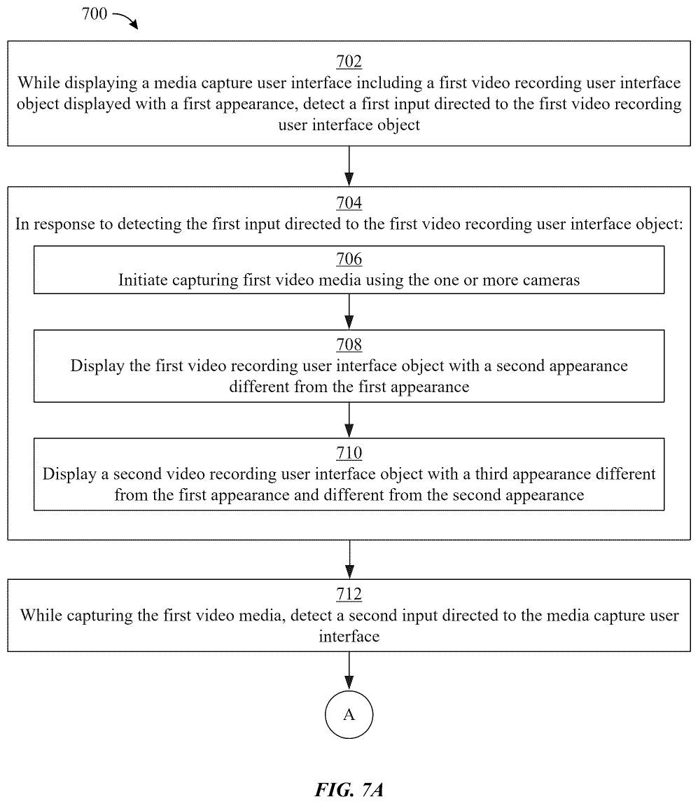

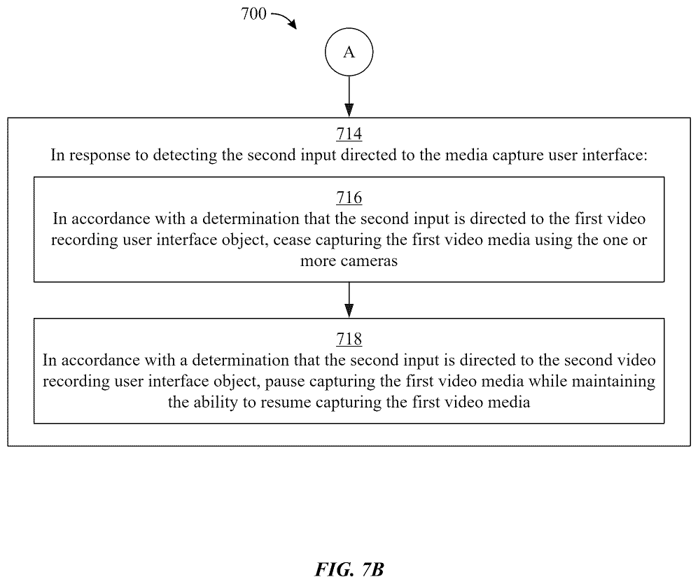

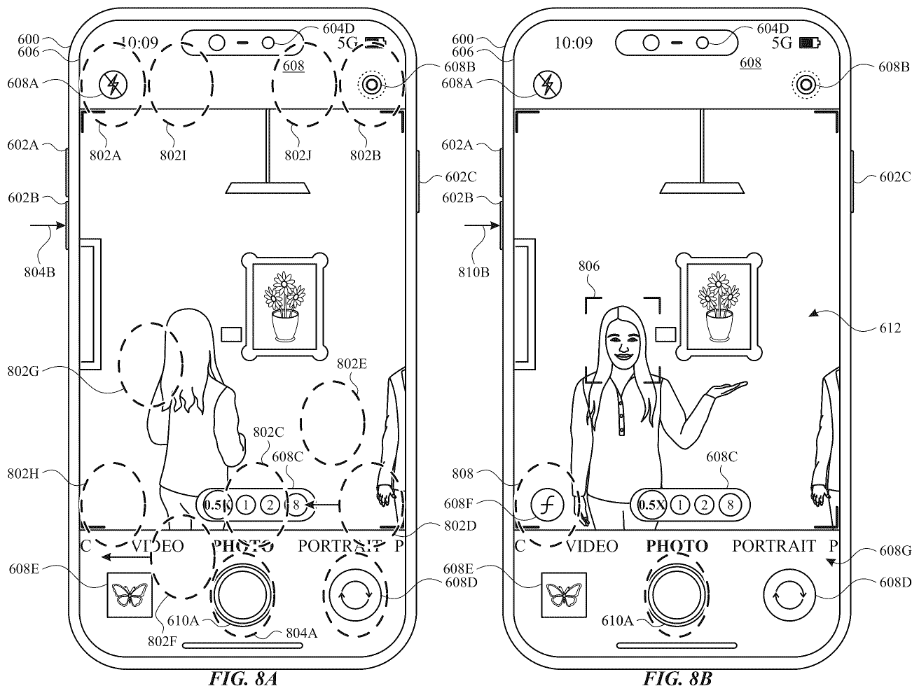

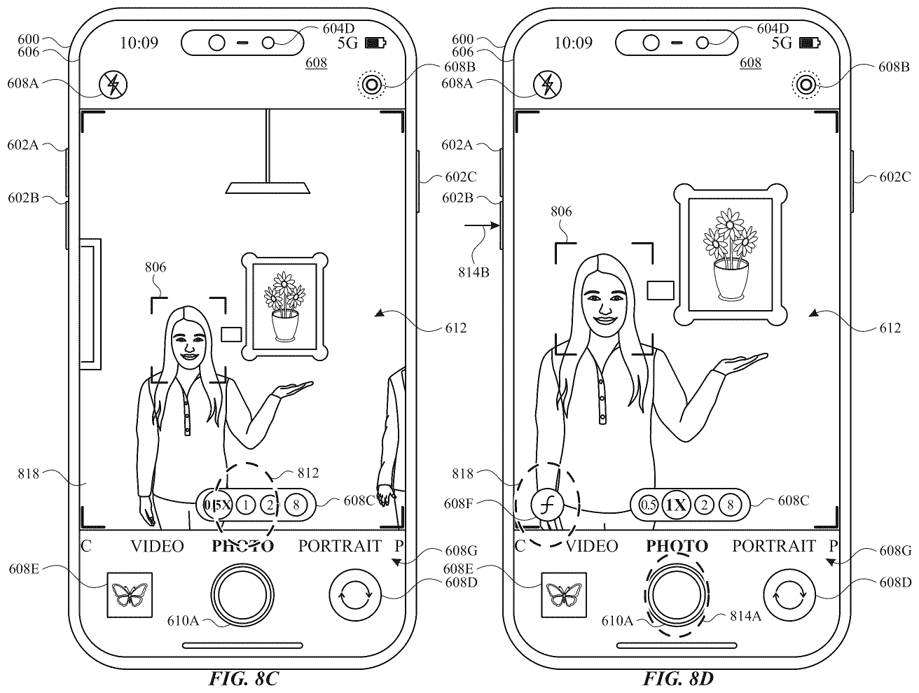

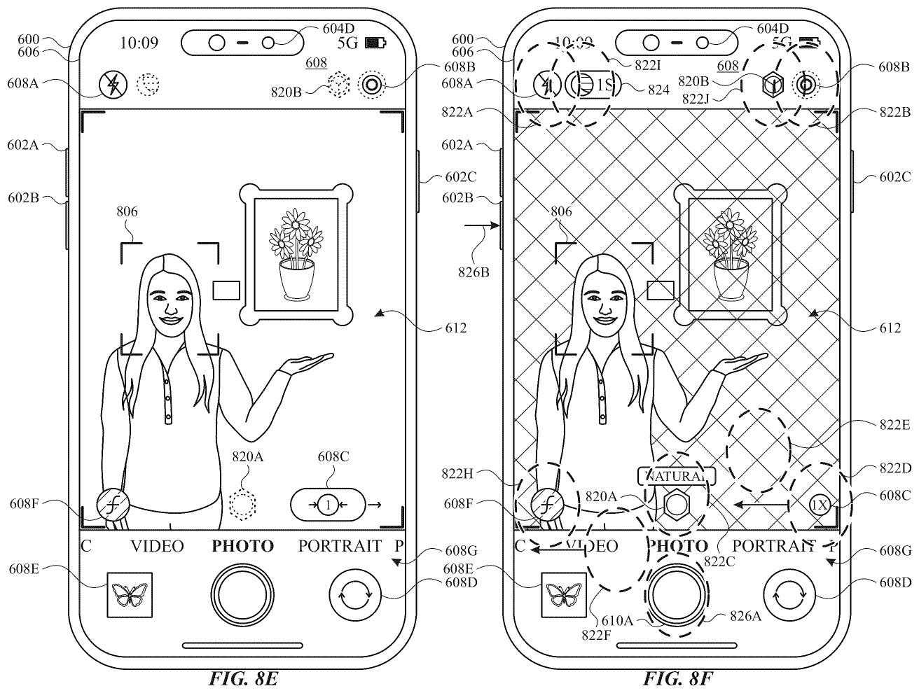

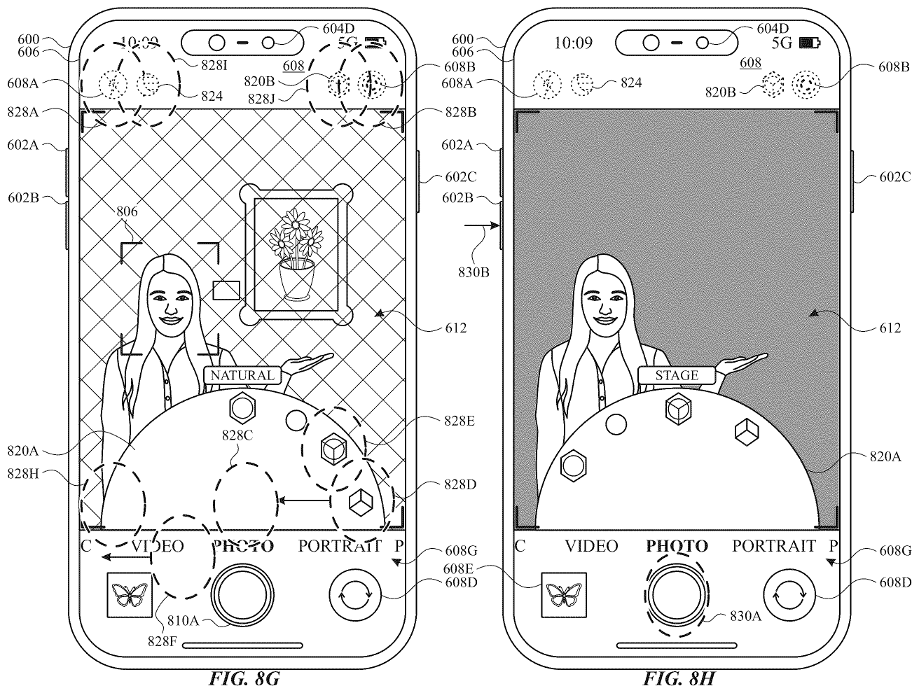

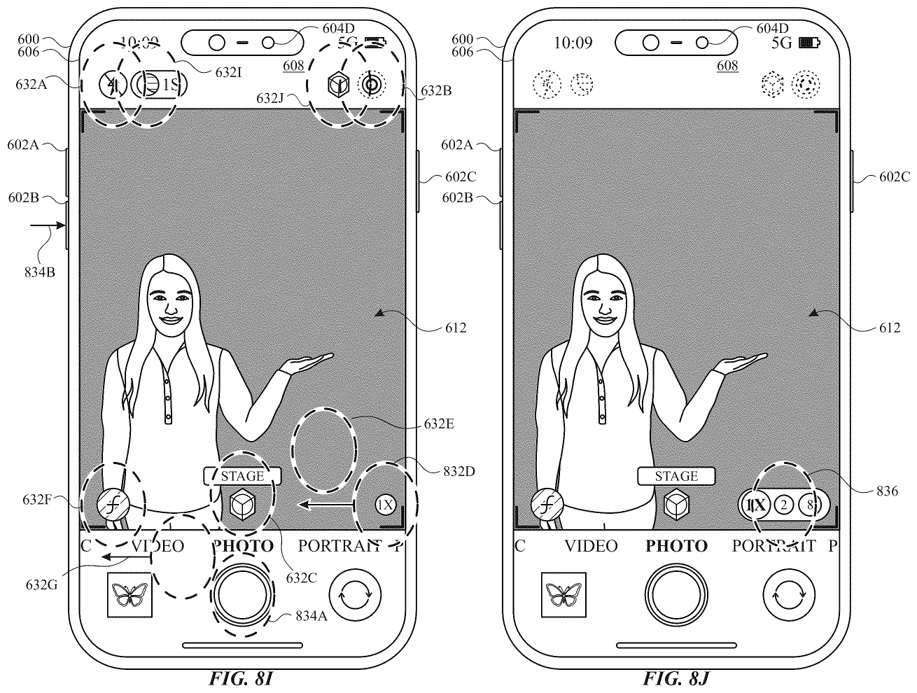

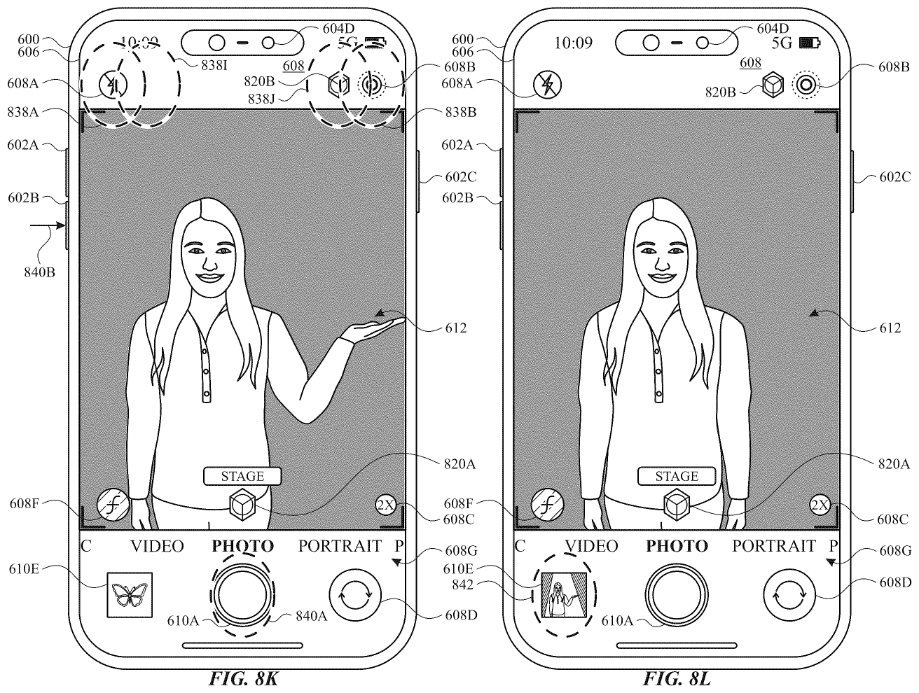

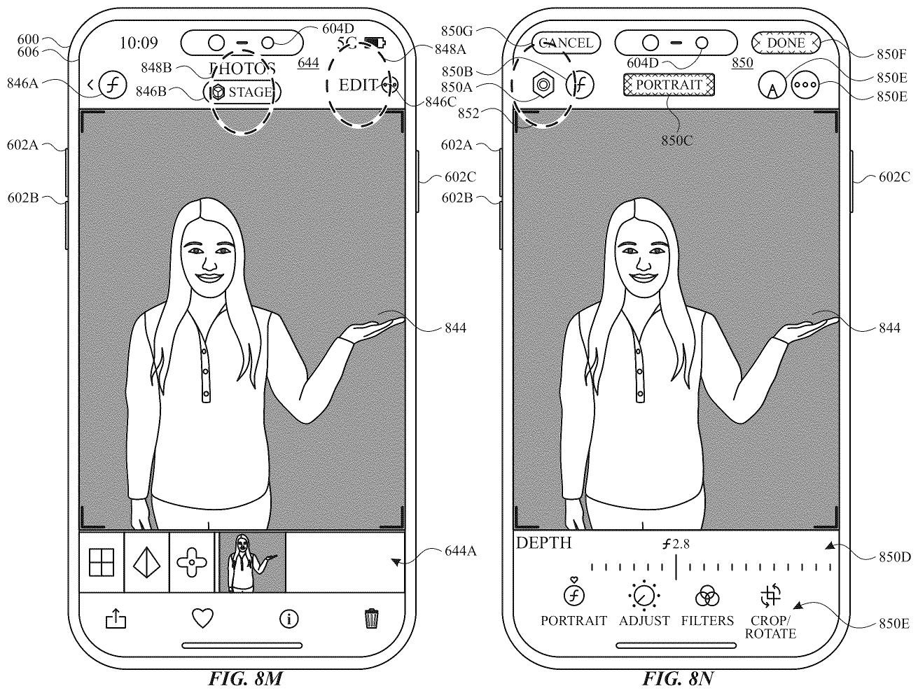

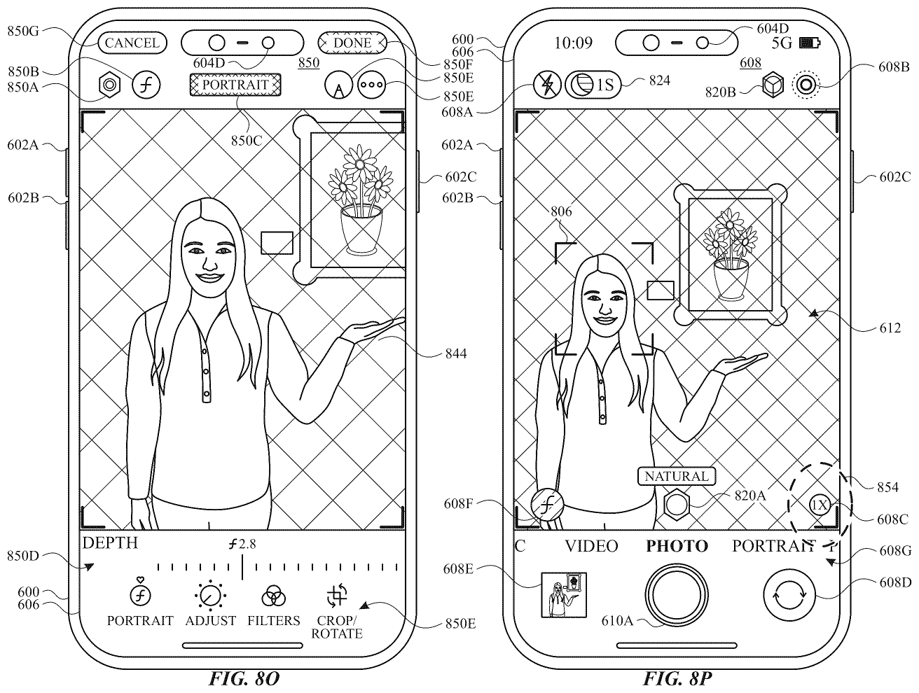

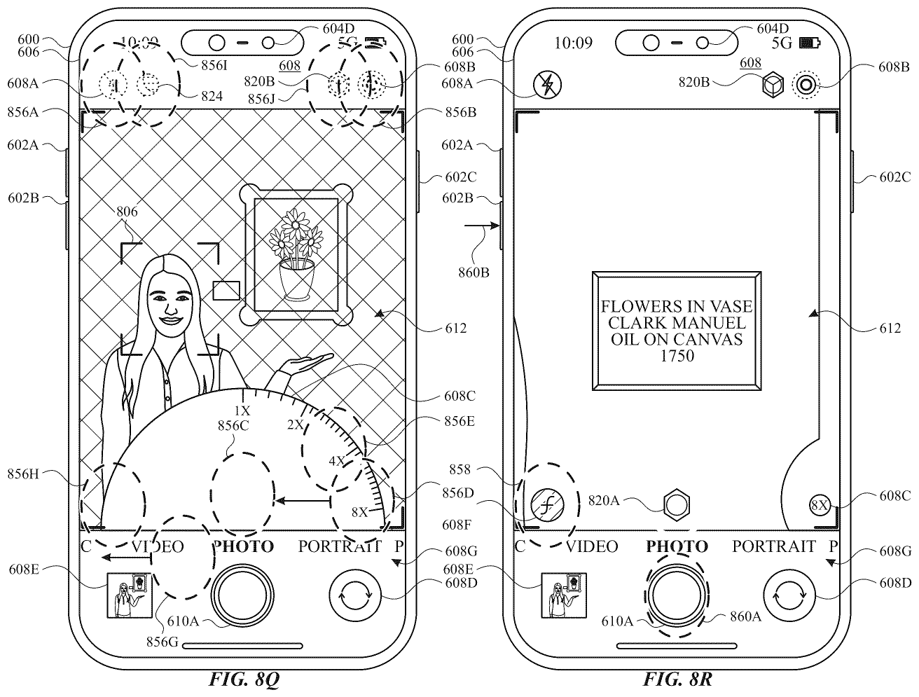

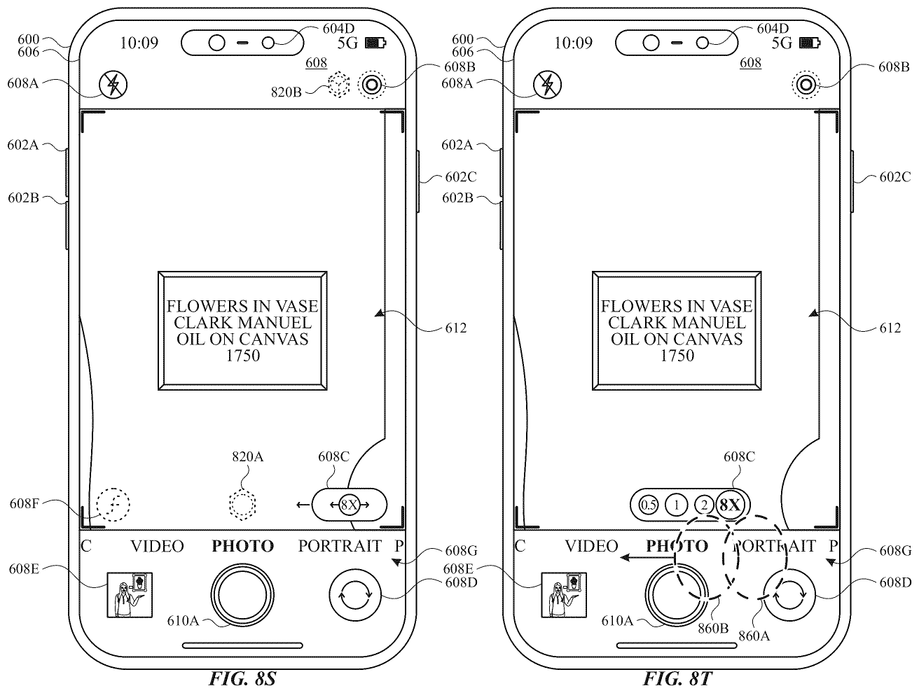

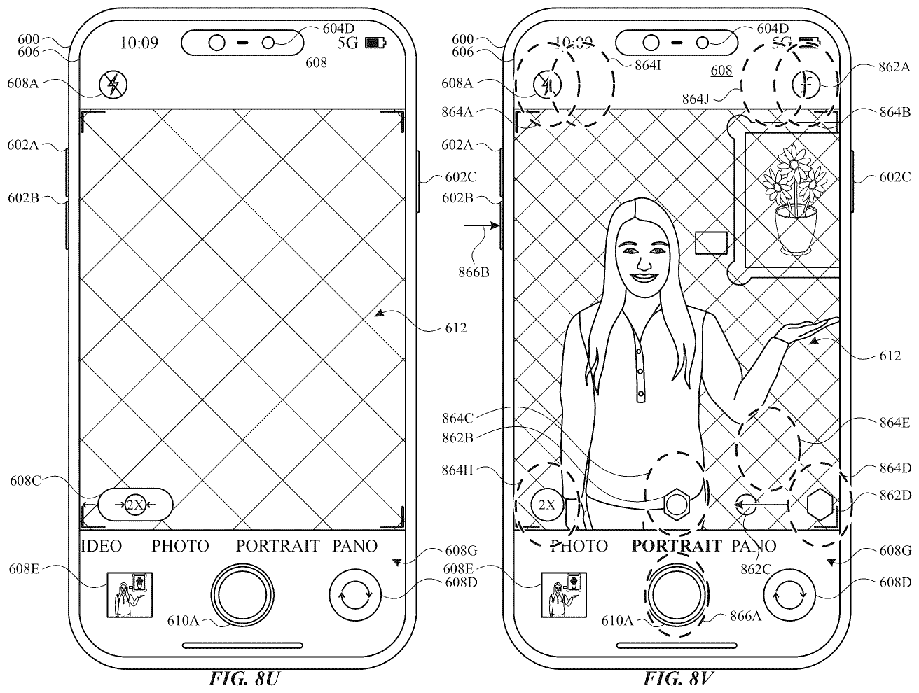

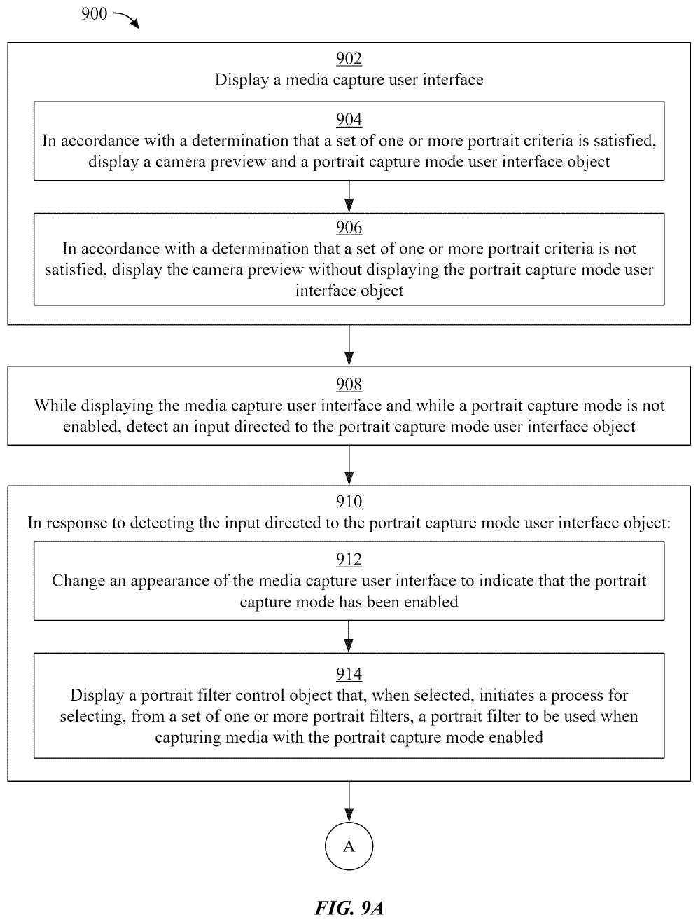

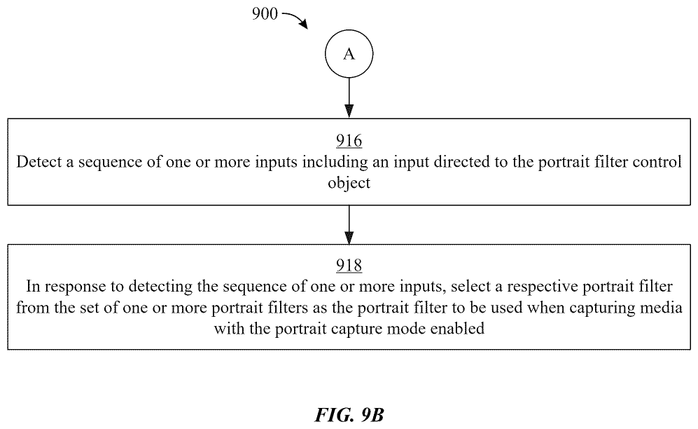

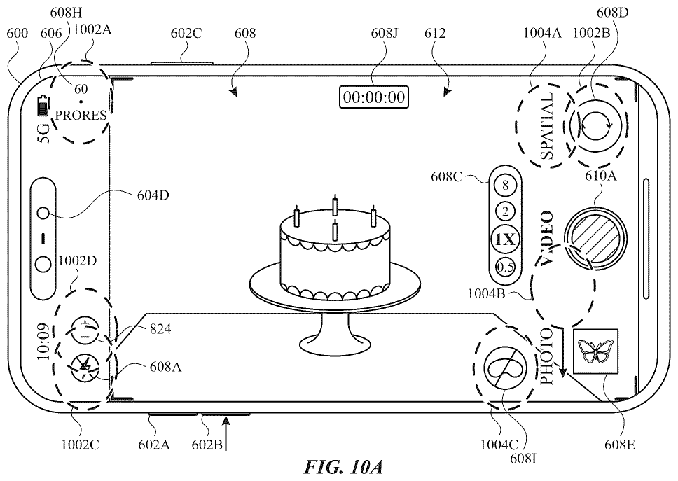

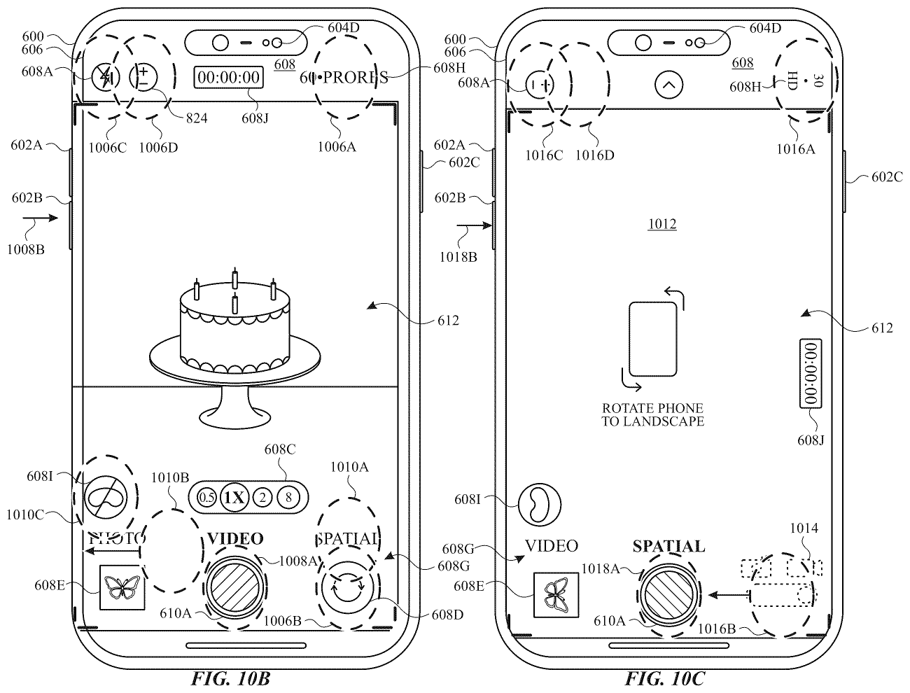

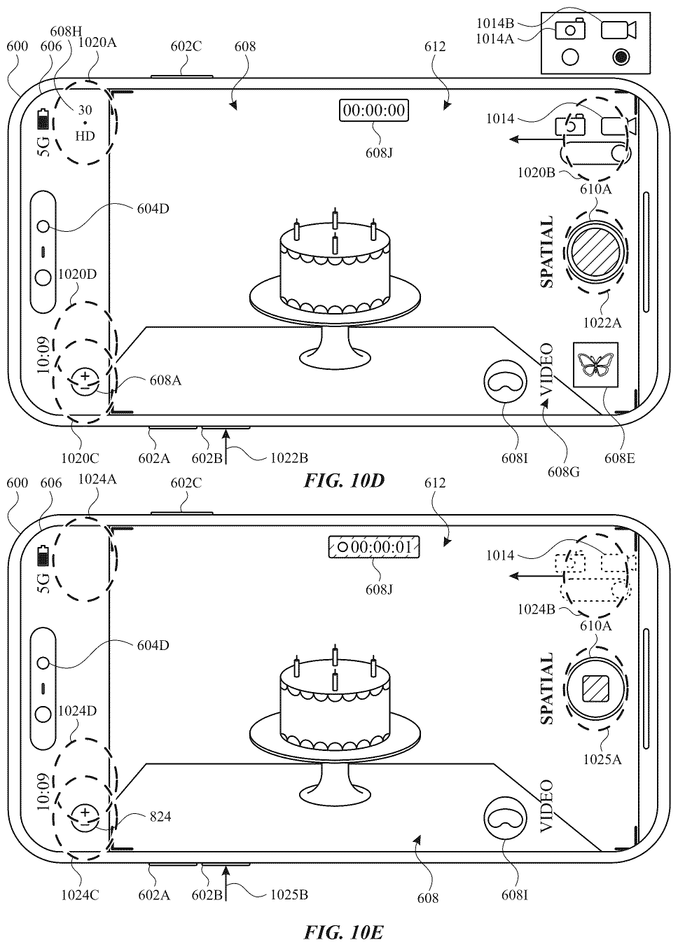

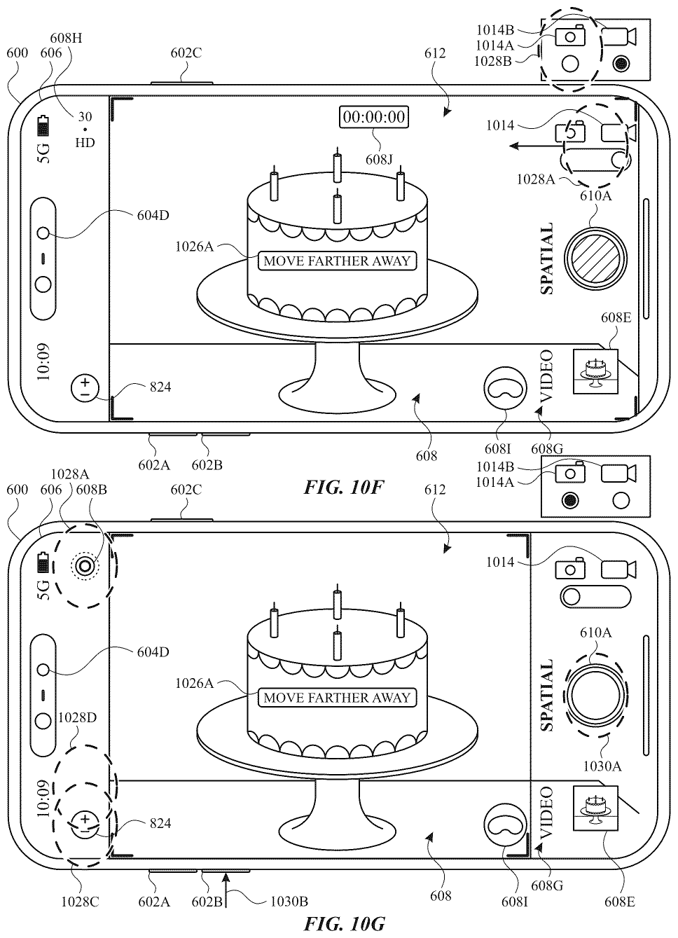

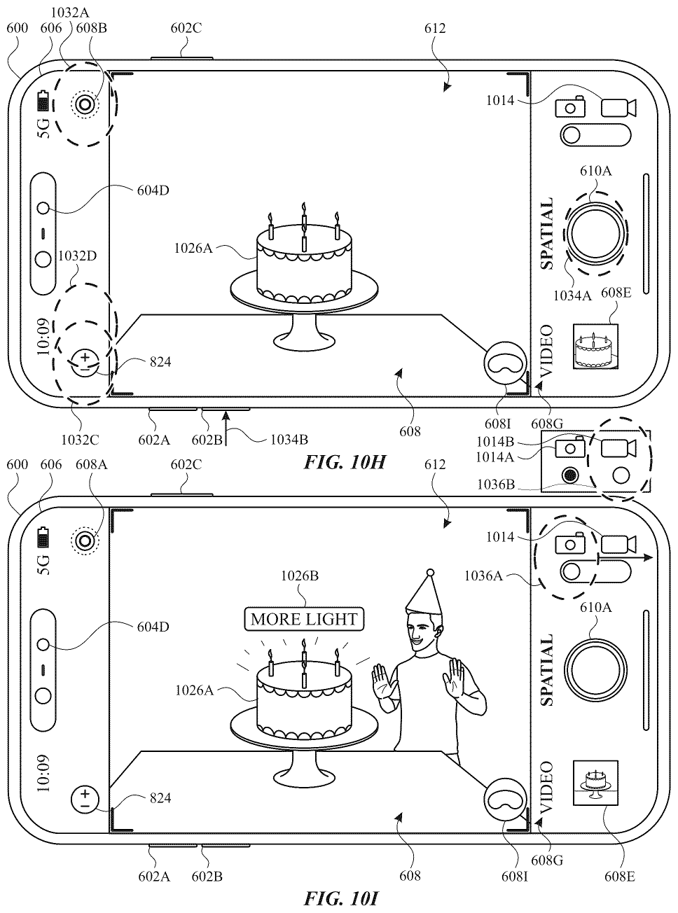

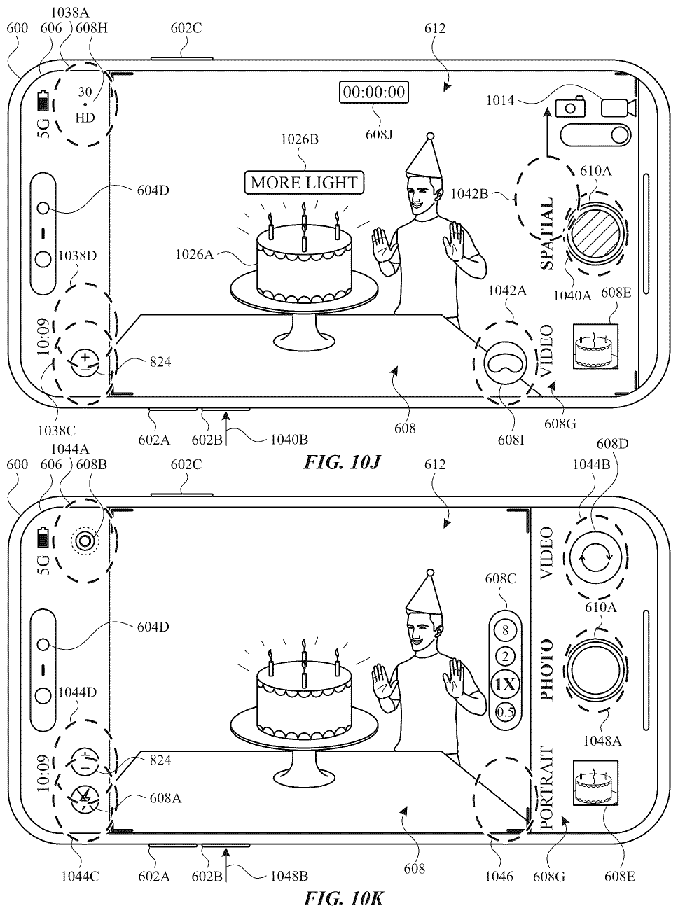

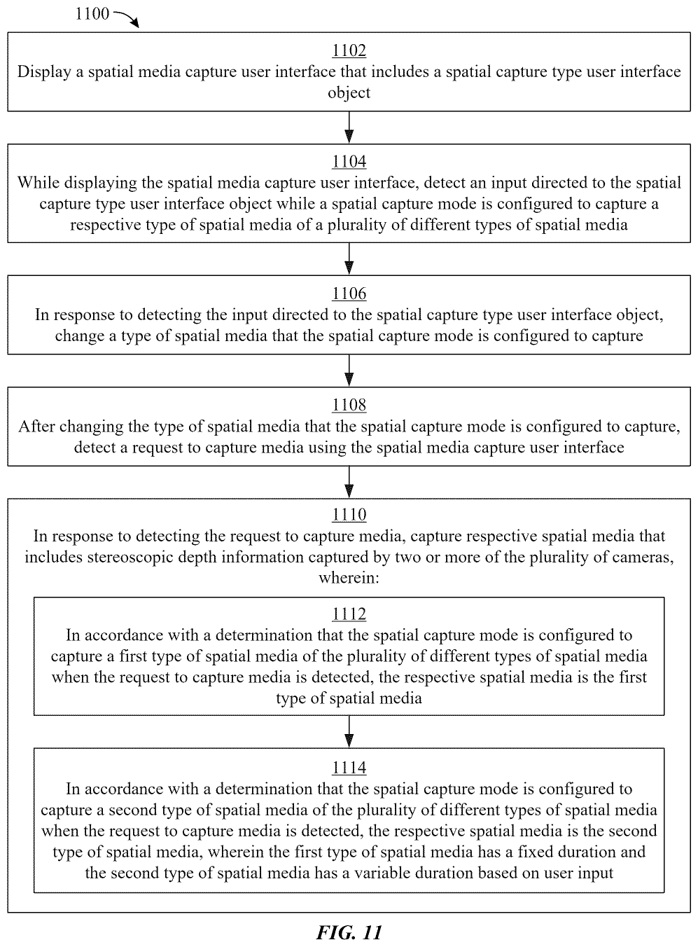

Below, FIGS. 1A-1B, 2, 3A-3G, 4A-4B, and 5A-5D provide a description of exemplary devices for performing the techniques for managing event notifications. FIGS. 6A-6P illustrate exemplary user interfaces for controlling video media capture. FIGS. 7A-7B are a flow diagram illustrating methods of controlling video media capture in accordance with some embodiments. The user interfaces in FIGS. 6A-6P are used to illustrate the processes described below, including the processes in FIGS. 7A-7B. FIGS. 8A-8V illustrate exemplary user interfaces for controlling media capture effects. FIGS. 9A-9B are a flow diagram illustrating methods of controlling media capture effects in accordance with some embodiments. The user interfaces in FIGS. 8A-8V are used to illustrate the processes described below, including the processes in FIG. 9. FIGS. 10A-10K illustrate exemplary user interfaces for controlling spatial media captures. FIG. 11 is a flow diagram illustrating methods of controlling spatial media captures in accordance with some embodiments. The user interfaces in FIGS. 10A-10K are used to illustrate the processes described below, including the processes in FIG. 11.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or reducing the risk that transient media capture opportunities are missed or captured in an unintended manner. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage media), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

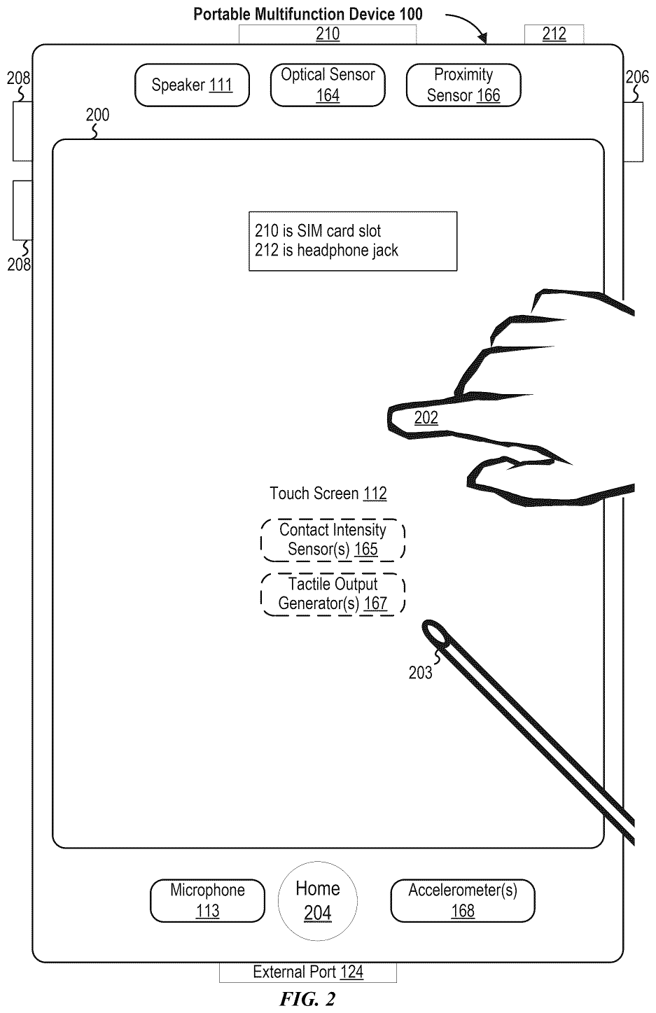

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “O” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

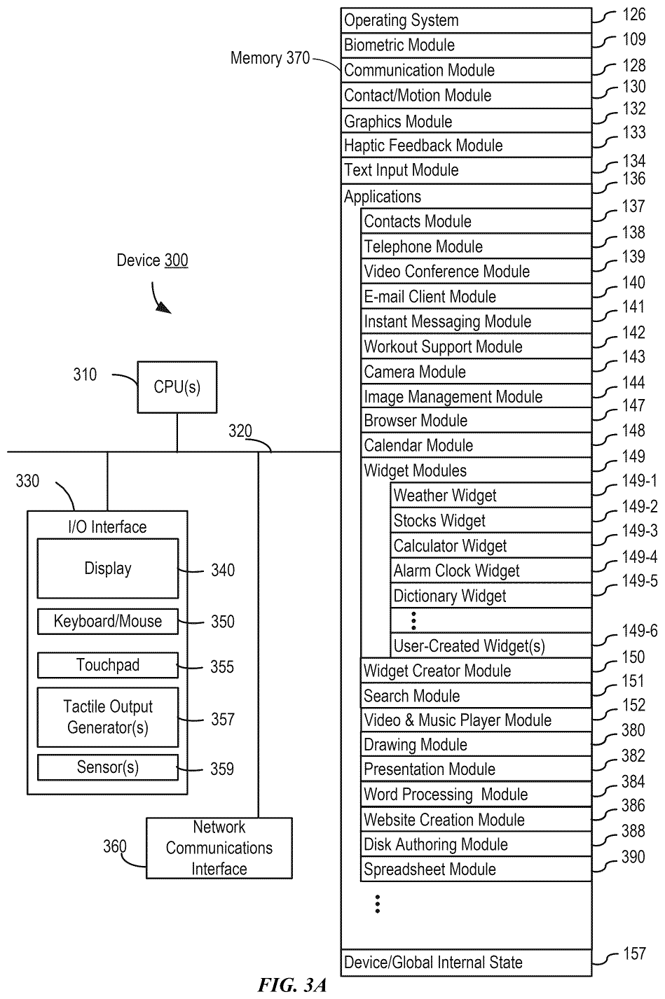

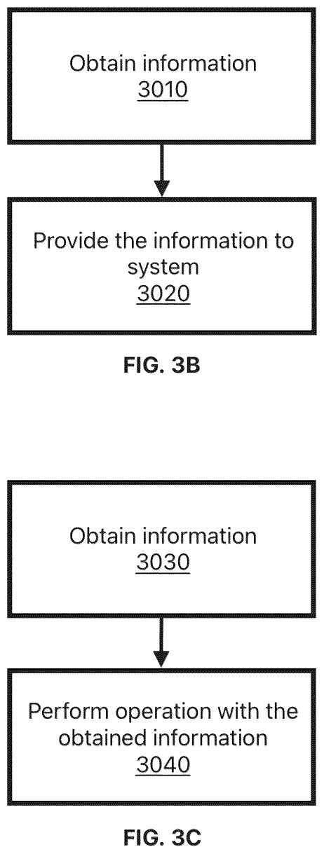

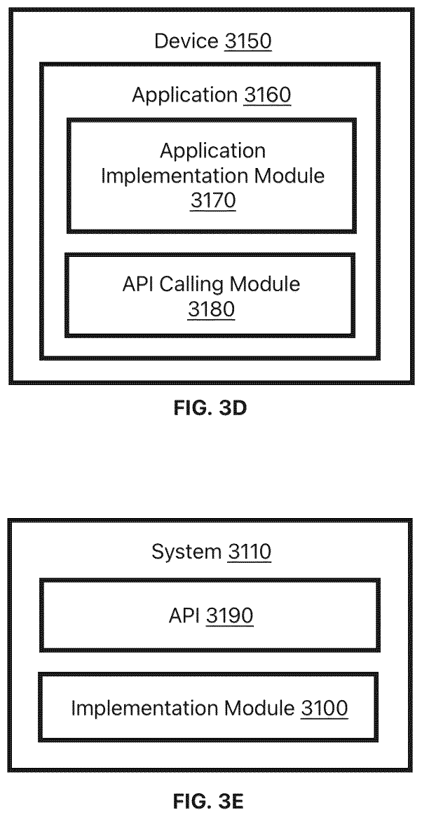

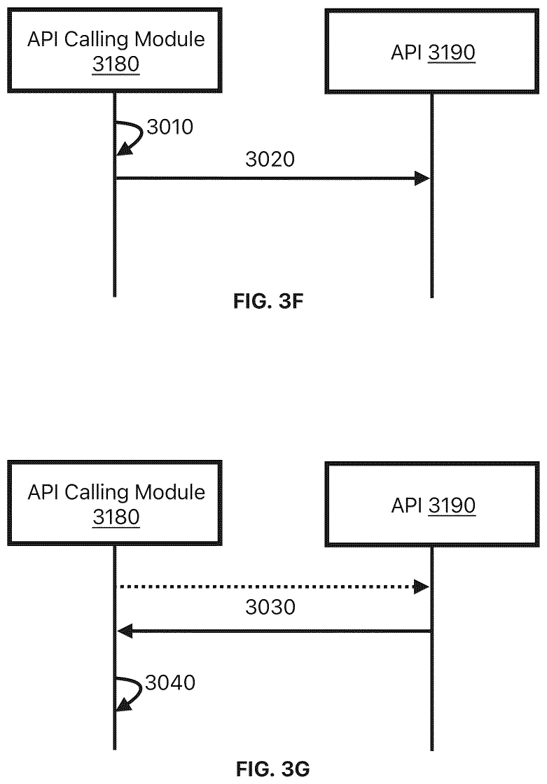

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE®, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript® file. In some embodiments, a widget includes an XML (Extensible Markup Language) file and a JavaScript® file (e.g., Yahoo!® Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In some embodiments, application 3160 is an application that is provided to device 3150 via an operating system update file (e.g., a first party application or a second party application). In some embodiments, application 3160 is an application that is provided via an application store. In some embodiments, the application store can be an application store that is pre-installed on device 3150 at purchase (e.g., a first party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of the device 3150. In some embodiments, at 3010, information is obtained from at least one hardware component external to the device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and operating system (e.g., system 3110 shown in FIG. 3E). Application 3160 includes application implementation module 3170 and API calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API calling module to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is a system (e.g., operating system, and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API calling module 3180. It should also be recognized that API calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform methods 700, 900, and 1100 (FIGS. 7A-7B, 9A-9B, and 11) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API calling module 3180) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

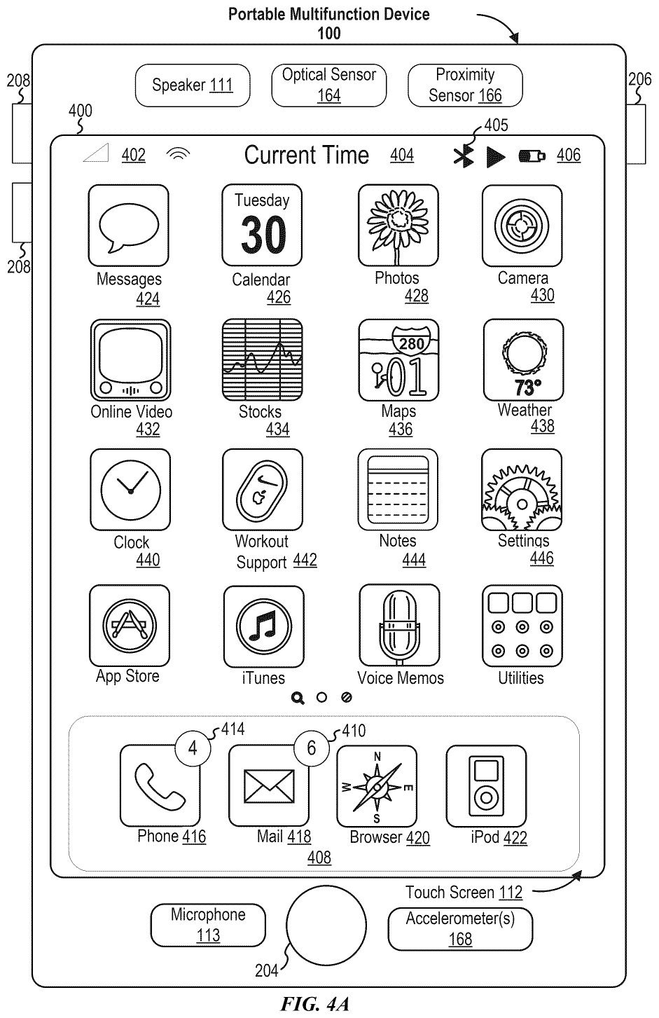

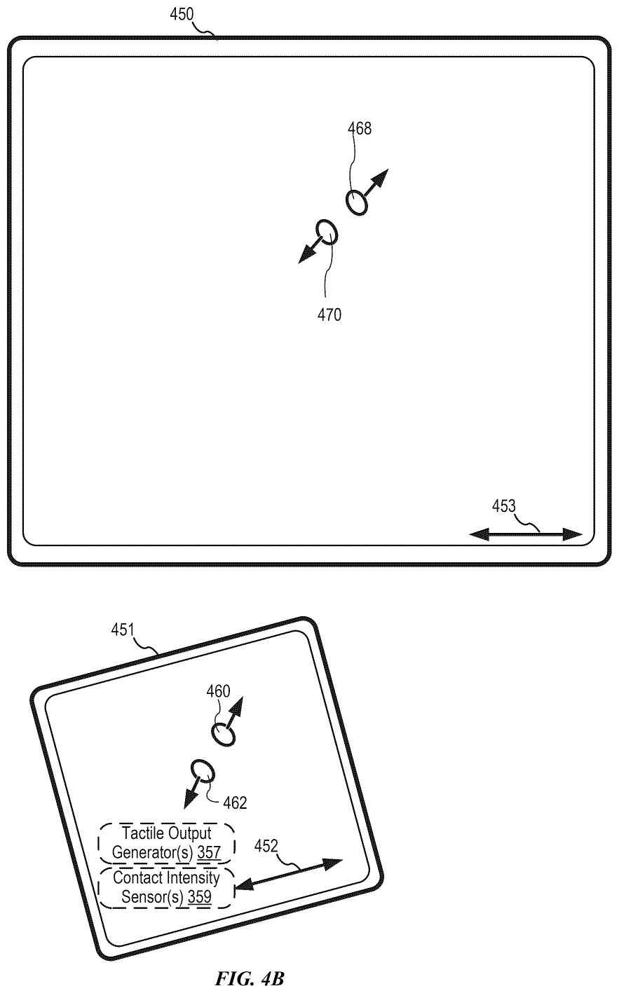

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., touch-sensitive surface 451 in FIG. 4B) has a primary axis (e.g., 452 in FIG. 4B) that corresponds to a primary axis (e.g., 453 in FIG. 4B) on the display (e.g., display 450). In accordance with these embodiments, the device detects contacts (e.g., contact 460 and contact 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., touch-sensitive surface 451 in FIG. 4B) are used by the device to manipulate the user interface on the display (e.g., display 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

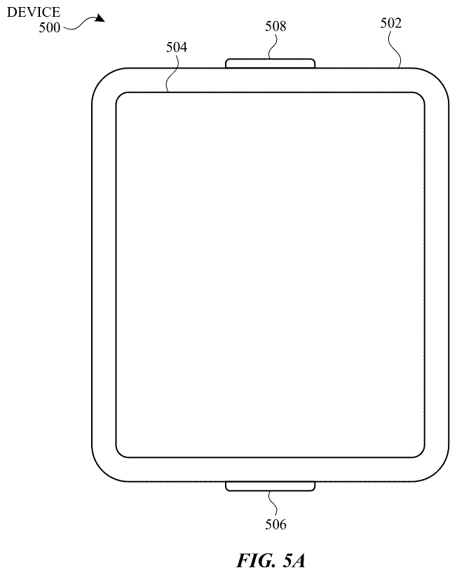

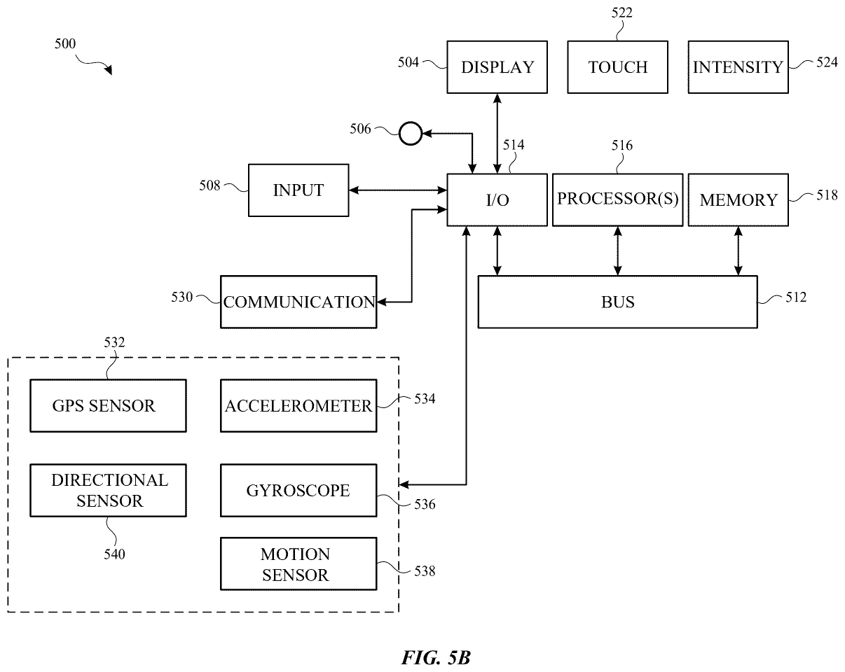

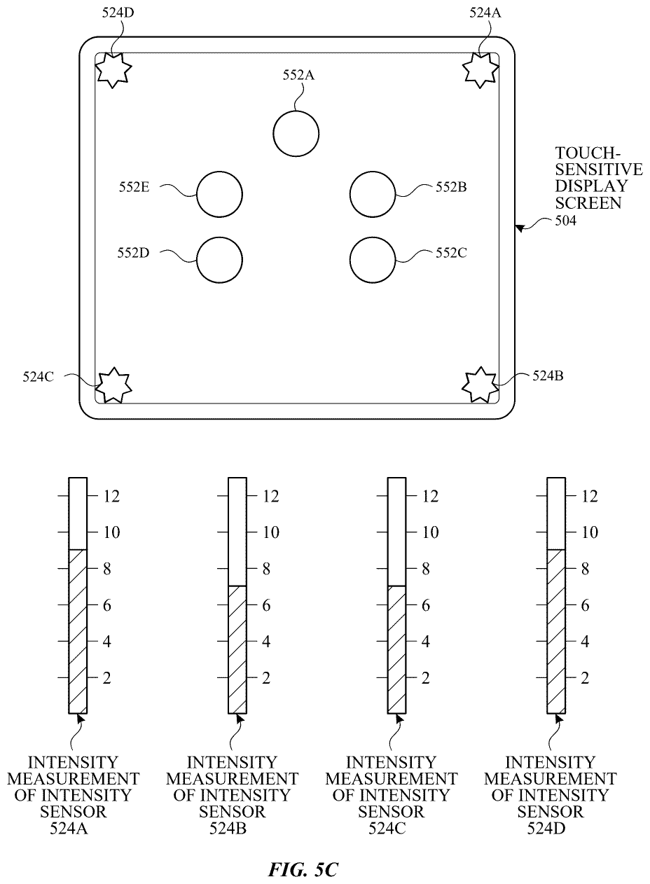

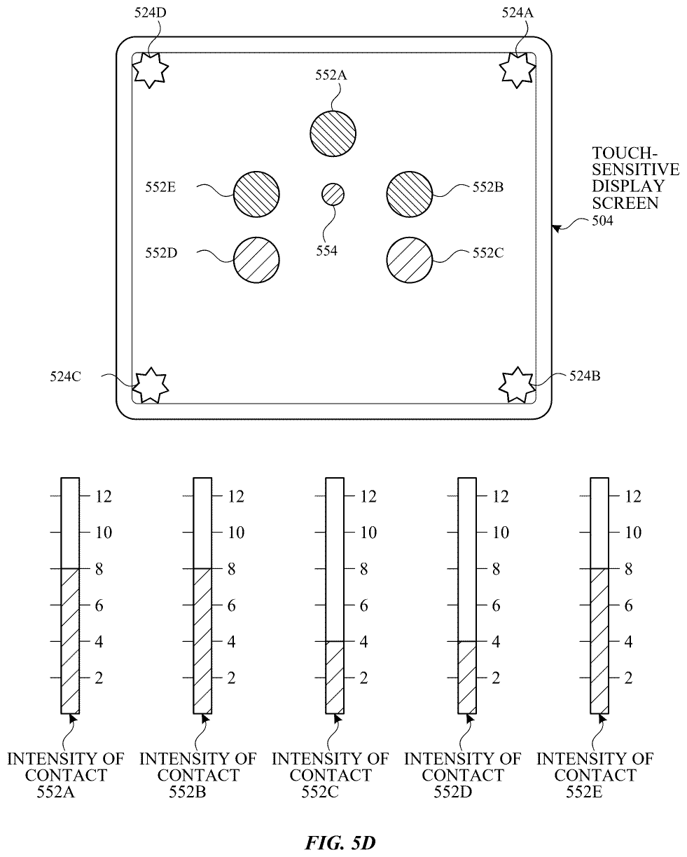

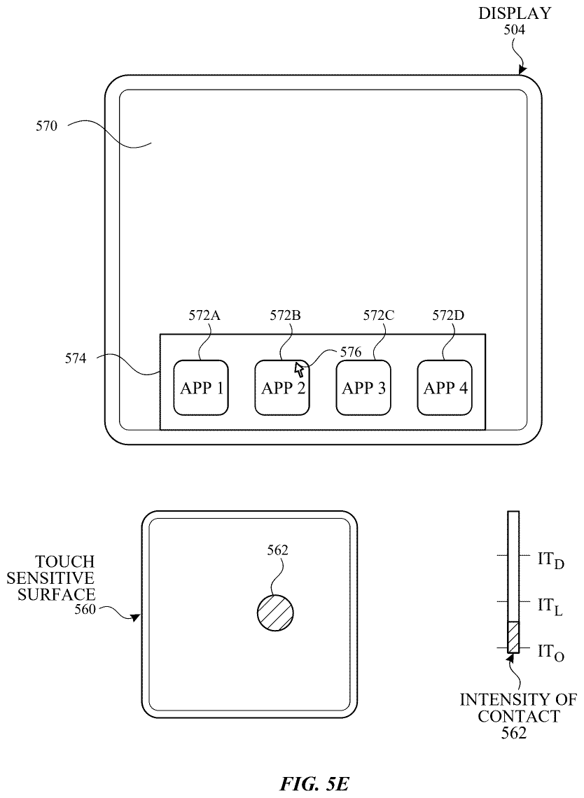

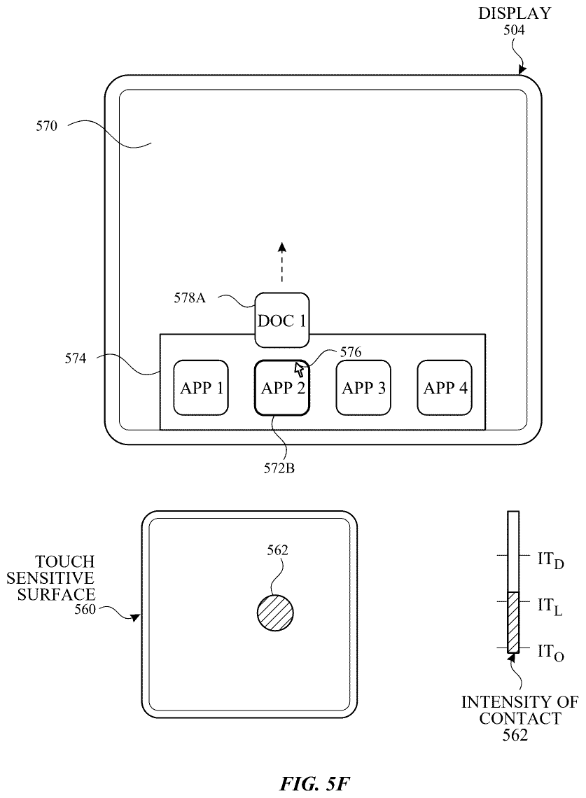

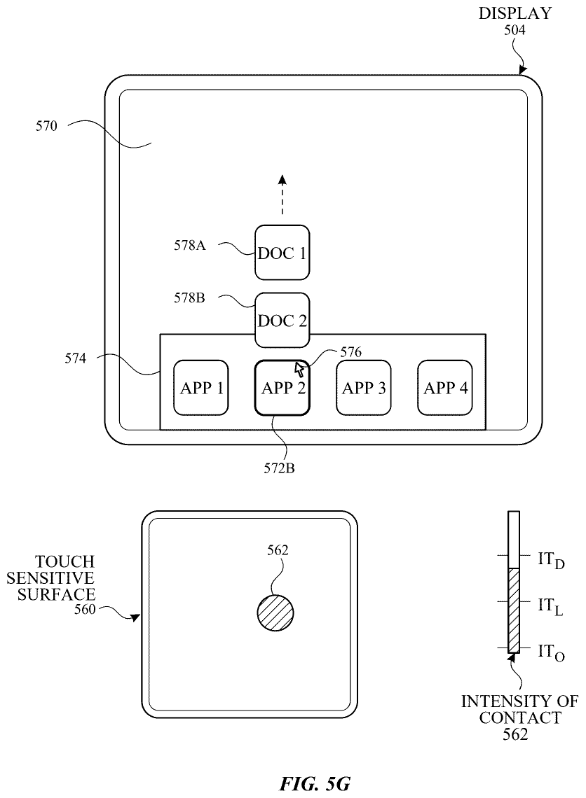

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage media, for storing computer-executable instructions, which, when executed by one or more computer processors 516, for example, can cause the computer processors to perform the techniques described below, including processes 700, 900, and 1100 (FIGS. 7A-7B, 9A-9B, and 11). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray® technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/>Di), where Dj is the distance of the respective contact j to the center of force, and >Di is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display screen 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

FIGS. 6A-6P illustrate exemplary user interfaces for controlling video media capture, in accordance with some embodiments. The user interfaces in these figures are used to illustrate the processes described below, including the processes in FIGS. 7A-7B.

FIGS. 6A and 6B illustrate back (e.g., FIG. 6A) and front (e.g., FIG. 6B) views of computer system 600 (e.g., a mobile phone device) including a set of hardware buttons including first button 602A, second button 602B, and third button 602C; a set of cameras including first camera 604A, second camera 604B, third camera 604C, and fourth camera 604D, and a display 606 including a touch-sensitive surface. In some embodiments, the set of cameras include different numbers of cameras, different arrangements of cameras, and/or different types of cameras. For example, the different types of cameras optionally include one or more wide-angle lenses, one or more telephoto lenses, and/or one or more macro lenses. For example, the different types of cameras optionally vary in geometry (e.g., physical or equivalent focal lengths, such as 5 mm, 13 mm, 22 mm, 24 mm, 28 mm, 50 mm, 77 mm, 100 mm, and/or 300 mm, or f-stops of f/1.2, f/1.78, f/2.2, f/2.8, f/3.4, and/or f/8.4), resolution (e.g., 8 MP, 12 MP, 24 MP, 48 MP, and/or 72 MP), pixel size (e.g., 100 nm, 0.5 μm, 1.0 μm, 2.44 μm, 5 μm), and/or presence of other hardware features (e.g., dual or quad pixels, dual pixel autofocus capabilities, and/or optical image stabilization capabilities). In some embodiments, computer system 600 includes one or more sensors, such as light sensors, depth sensors (e.g., structural light sensors, time-of-flight sensors (e.g., LIDAR and/or ultrasonic sensors), and/or stereoscopic camera sensors), motion sensors, and/or audio sensors. In some embodiments, the methods described herein using computer system 600 are implemented using (e.g., in conjunction with computer system 600) one or more user devices (e.g., mobile phones, tablet computers, laptop computers, and/or wearable electronic devices (e.g., smart watches and/or head-mounted devices)), remote devices (e.g., servers and/or network-connected devices), and/or peripheral devices (e.g., external storage drives, microphones, speakers, and/or hardware input devices). In some embodiments, computer system 600 includes one or more features of devices 100, 300, or 500 (e.g., the set of cameras can include optical sensor 164).

At FIG. 6B, computer system 600 displays camera user interface 608 in a standard photo capture mode. In the standard photo capture mode, camera user interface 608 includes touch controls 608A-608G, capture control 610A, and camera preview 612. In the standard photo capture mode, camera user interface 608 is configured to capture photo media in response to a capture input, such as touch input 616A directed to capture control 610A or press input 616B (e.g., a press of one or more of first button 602A, second button 602B, and third button 602C), such as still photo media (e.g., single-frame photos) and limited-duration photo media, such as photos including content captured before and/or after detecting a capture input such as input 616 (described in further detail below). Camera preview 612 includes a representation of a portion of the field-of-view of cameras 604A, 604B, 604C, and/or 604D (e.g., a live or near-live camera feed) previewing the portion of the field-of-view of the cameras that would currently be captured (e.g., in response to touch input 616A and/or press input 616B). As illustrated in FIG. 6B, computer system 600 displays capture control 610A with a photo capture appearance, for instance, as a solid white circle circumscribed by a white ring (e.g., a “capture photo” appearance).

Touch controls 608A-608G are displayed user interface objects (e.g., software buttons) for navigating, using, assisting with, and/or changing settings of camera user interface 608 via the touch-sensitive surface of display 606 and/or via other input devices (e.g., first button 602A, second button 602B, and/or third button 602C) associated with the camera user interface. For example, inputs described herein as detected by computer system 600 may include one or more touch, tap, press, gesture, and/or air gesture inputs, including inputs with detected movement components (e.g., swipes, flicks, and/or drags) and/or without detected movement components (e.g., discrete or static inputs and/or inputs directed to hardware input devices that do not detect movement).

Flash control 608A is a user interface object for changing a camera flash mode, for instance, turning a camera flash for capturing photos (e.g., using cameras 604A, 604B, 604C, and/or 604D) on, off, or to an automatic mode (e.g., enabling or disabling flash based on current lighting characteristics for the capture) in response to a user input, such as input 614A, a touch input directed to the upper left corner of camera user interface 608. At FIG. 6A, flash control 608A is displayed with a deselected appearance (e.g., a crossed-out camera flash icon), indicating that the camera flash mode is currently off.

Limited-duration photo control 608B is a user interface object for changing a photo duration setting, for instance, toggling from a still photo capture mode (e.g., for capturing single-frame photo media using cameras 604A, 604B, 604C, and/or 604D and/or other sensors of computer system 600) to a limited-duration photo capture mode in response to a user input, such as input 614B, a touch input directed to the upper right corner of camera user interface 608. For example, in the limited-duration photo capture mode, computer system 600 captures content using cameras 604A, 604B, 604C, and/or 604D (e.g., and or other sensors of computer system 600, such as audio sensors/microphones) for a limited duration (e.g., 0.5 s, 1 s, 3 s, and/or 5 s) spanning before and/or after a capture input is detected, which can be played back for a “live” photo effect.

Zoom control 608C is a user interface object for controlling a zoom level, for instance, performing an optical zoom (e.g., switching between different fixed focal-length lenses of different magnifications and/or varying the focal length of a hardware zoom lens) and/or performing a digital zoom (e.g., digitally magnifying camera by resizing, interpolating, and/or combining data captured at one or more optical zoom levels) in response to a user input, such as input 614C, a touch input directed to the lower center region of camera preview 612 where zoom control 608C is displayed. At FIG. 6A, zoom control 608C is displayed as a platter with four control elements corresponding to 0.5× zoom (e.g., a wide-angle shot), 1× zoom, 2× zoom, and 8× zoom, and in response to an input such as 614C, directed to the 2× zoom element, computer system 600 would perform a zoom to 2× magnification, including displaying camera preview 612 with the representation of the field-of-view of the cameras at a 2× zoom level.

Camera selection control 608D is a user interface object for transitioning between capture using a front-facing (e.g., environment-facing) camera (e.g., first camera 604A, second camera 604B, and/or third camera 604C) and using a back-facing (e.g., user-facing) camera (e.g., fourth camera 604D) in response to a touch input, such as input 614D, a touch input directed to the lower right corner of camera user interface 608. Captured media element 608E is a user interface object for previewing captured media and, in response to an input such as input 614E directed to the lower left corner of camera user interface 608, displaying (e.g., in a media viewing user interface and/or application) the captured media.

Portrait mode control 608F is a user interface object for controlling simulated portrait capture effects in the standard photo capture mode in response to a user input, such as input 614F directed to the lower left region of camera preview 612 where portrait mode control 608F is displayed. As further described with respect to FIGS. 8A-8V, in some embodiments, portrait mode control 608F is conditionally displayed, for instance, automatically appearing when certain conditions are detected (e.g., when a particular subject is detected, when the zoom level is set within a particular range, and/or when an input directed to a subject within camera preview 612, such as input 614G, is detected). As further described with respect to FIGS. 8A-8V, in some embodiments, in response to an input such as 614F, computer system 600 configures camera user interface 608 to capture photo media with portrait capture effects applied, such as simulated depth-of-field effects, lighting effects, and/or other post-processing effects. In some embodiments, in response to input 614G, computer system 600 further adjusts capture settings, for instance, setting auto-focusing on or automatically setting an exposure level based on the content included in camera preview 612 (e.g., auto-focusing or auto-exposing the current shot based on detecting the frog in camera preview 612).

Capture mode control 608G is a user interface object (e.g., a sliding menu or toolbar) for selecting between capture modes, such as the standard photo capture mode (e.g., a mode for capturing photo media that are not designated for display with synthetic depth-of-field effects), a portrait capture mode (e.g., a mode for capturing photo media that are designated for display with synthetic depth-of-field effects, lighting effects, and/or other post-processing effects), a panoramic photo capture mode (e.g., a mode for capturing photos from different positions and/or angles that are stitched together to create a single, larger form-factor image), a standard video capture mode (e.g., a mode for capturing video media that are not designated for display with synthetic depth-of-field effects), and/or a cinematic video capture mode (e.g., a mode for capturing video media that are designated for display with synthetic depth-of-field effects, lighting effects, and/or other post-processing effects). As illustrated in FIG. 6B, computer system 600 displays capture mode control 608G with the photo menu item horizontally centered within camera user interface 608, indicating that camera user interface 608 is in the standard photo capture mode. At FIG. 6B, computer system 600 detects an input requesting to switch camera user interface 608 to the standard video capture mode, such as input 614H, a left-to-right swipe across capture mode control 608G; 614I, a tap directed to the “video” menu item in capture mode control 608G; and/or 614J, a left-to-right swipe across camera preview 612.

At FIG. 6C, in response to the input requesting to switch camera user interface 608 to the standard video capture mode (e.g., 614H, 614I, and/or 614J), computer system 600 displays camera user interface 608 in the standard video capture mode. In the standard video capture mode, computer system 600 displays capture mode control 608G with the “video” menu item that is horizontally centered within camera user interface 608, indicating that camera user interface 608 is in the standard video capture mode, and additionally changes the aspect ratio of camera preview 612 to a narrower aspect ratio (e.g., changing from a standard 4:3 photo aspect ratio to a standard 16:9 video aspect ratio). Additionally, in the standard video capture mode, computer system 600 changes the appearance of capture control 610A, for instance, displaying capture control 610A as a solid red circle circumscribed within the white ring (e.g., a “start recording” appearance), indicating that selecting capture control 610A will initiate capturing video media with cameras 604A, 604B, 604C, and/or 604D (e.g., as described with respect to inputs 620A and 620B, below).

As in the standard photo capture mode, at FIG. 6C, camera user interface 608 includes flash control 608A, zoom control 608C, camera selection control 608D, and captured media element 608E. For example, in response to inputs 618A, 618C, 618D, and/or 618E, directed to the same locations as inputs 614A, 614C, 614D, and/or 618E, respectively, computer system 600 controls the flash setting, controls the zoom level, controls the camera selection, and displays captured media as described above. In some embodiments, the flash setting options may change in the standard video mode, for instance, placing the camera flash into a persistent-on state for a video capture rather than triggering a momentary flash for a photo capture.

In contrast to the standard photo capture mode, at FIG. 6C, in the standard video capture mode, camera user interface 608 includes video format control 608H, spatial mode control 608I, and video capture timer 608J (e.g., a timer indicating an elapsed video capture time, which is displayed at “00:00:00” when camera user interface 608 is initially displayed). In some embodiments, in response to input 618B, a touch input directed to video format control 608H (e.g., to substantially the same portion of camera user interface 608 as input 614B), computer system 600 controls one or more video format settings, for instance, changing capture resolution (e.g., standard definition (SD), high definition (HD), and/or ProRes resolution; 12, 24, and/or 48 MP resolution; and/or 5 MB, 10 MB, and/or 20 MB file size), video format or coding (e.g., RAW, HEIC/HEVC, and/or MPEG codecs), and/or capture frame rate (e.g., 30 FPS, 60 FPS, 120 FPS, and/or 240 FPS) (e.g., instead of controlling the limited-duration photo mode). As illustrated at FIG. 6C, video format control 608H indicates that a high-definition resolution and 30 FPS frame rate is currently selected for capturing video using camera user interface 608.

As described further with respect to FIGS. 10A-10K, in some embodiments, in response to input 618F, a touch input directed to spatial mode control 608I (e.g., to substantially the same portion of camera user interface 608 as input 614F), computer system 600 configures camera user interface 608 to capture spatial video media, such video media including depth information captured using two or more of the cameras that can be used to display captured video with a three-dimensional (e.g., spatial) effect. In some embodiments, in response to input 618G, a touch input directed to substantially the same portion of camera preview 612 as input 614G, computer system 600 further adjusts capture settings, for instance, auto-focusing on or automatically setting an exposure level based on the frog visible in camera preview 612 (e.g., as described with respect to FIG. 6B).

At FIG. 6C, computer system 600 detects a capture input, such as touch input 620A directed to capture control 610A or press input 620B (e.g., a press of one or more of first button 602A, second button 602B, and third button 602C). In response to detecting the capture input (e.g., 620A and/or 620B), at FIG. 6D, computer system 600 initiates capturing video media. For example, the capture input (e.g., 620A and/or 620B) begins a video capture session, during which video media (e.g., including video, audio, and/or spatial content) is captured for inclusion in a discrete video media item (e.g., a single video clip and/or file). The video media captured in response to detecting the capture input (e.g., 620A and/or 620B) is captured at a high-definition resolution and a frame rate of 30 FPS, as indicated by video format control 608H prior to initiating capture.

In some embodiments, computer system 600 is outputting audio when the capture input (e.g., 620A and/or 620B) is detected. For example, computer system 600 is playing audio via one or more built-in speakers (e.g., a speaker of the mobile phone device), external speakers (e.g., wireless and/or wired speakers; e.g., a sound system, portable speaker, computer speaker, and/or television speaker), and/or headphones. For example, the computer system 600 plays audio such as audio media (e.g., music, radio, podcasts, and/or audio books), audio communication (e.g., audio from a phone call, video call, teleconference, voicemail, and/or other audible communication), and/or other audio outputs (e.g., alarms, alerts, and/or sound effects, such as a shutter click sound).

In some embodiments, computer system 600 conditionally maintains outputting the audio when the capture input (e.g., 620A and/or 620B) is detected, continuing to play the audio while capturing the video media. In some embodiments, computer system 600 conditionally captures (e.g., records) the audio being output while capturing the video media for inclusion in the discrete video media item. For example, capturing output audio (e.g., audio being output by computer system 600, as opposed to audio merely being detected or recorded by computer system 600 (e.g., ambient/environmental audio)) to include in a video media item is enabled or disabled via a user input to a settings user interface. For example, capturing output audio to include in a video media item is conditionally enabled for certain types of output audio (e.g., audio media) and conditionally disabled for other types of output audio (e.g., audio communications and/or other audio outputs). For example, if a user enables capturing output audio and computer system 600 is playing a song when the capture input (e.g., 620A and/or 620B) is detected, computer system 600 continues to play the song while capturing the video media and includes at least a portion of the song audio in the audio for the captured video media. For example, if a user enables capturing output audio, but computer system 600 is outputting audio from a voice call when the capture input (e.g., 620A and/or 620B) is detected, computer system 600 refrains from including the audio of the voice call in the audio for the captured video media. In some embodiments, computer system 600 processes the portion of the output audio to add to the discrete video media item, for instance, adjusting the levels of the output audio relative to the levels of other captured audio in the video media item.

In response to detecting the capture input (e.g., 620A and/or 620B), computer system 600 updates camera user interface 608 as illustrated in FIGS. 6D-6E and further described below, including changing the appearance of capture control 610A and video capture timer 608J, removing certain controls (e.g., 608A, 608H, 608D, 608E, 608F, and 608G), and displaying new capture controls 610B and 610C. In some embodiments, computer system 600 makes some updates to camera user interface 608 gradually, for instance, animating flash control 608A and video format control 608H fading out and animating capture control 610B and capture control 610C fading in, as illustrated in FIG. 6D.

In particular, at FIGS. 6D-6E, when capturing the video media is initiated, computer system 600 changes the appearance of capture control 610A to a “stop recording” appearance. In particular, as illustrated in FIGS. 6D-6E, computer system 600 changes the appearance of capture control 610A by animating the solid red circle shrinking and morphing into a smaller red square, still circumscribed by the white ring, which, in some embodiments, maintains the same or similar appearance (e.g., shape, size, color, and/or opacity) as prior to initiating capture. Computer system 600 changes the appearance of video capture timer 608J, for instance, displaying the capture timer with an opaque or translucent background (e.g., a white, gray, or black platter) and/or a recording icon (e.g., a pulsing red dot) while updating the elapsed video capture time to reflect the current length of the video recording.

At FIGS. 6D-6E, when capturing the video media is initiated, capture control 610B and capture control 610C are displayed on either side of capture control 610A, which remains displayed in its original position in the lower central portion of camera user interface 608 (e.g., the same position capture control 610A was in both in the photo capture mode and in the video capture mode before initiating capture). For example, capture control 610B and capture control 610C replace captured media element 608E and camera selection control 608D. As illustrated in FIG. 6E, capture control 610B is initially displayed as a pause icon circumscribed within a white ring (e.g., a “pause recording” appearance). While capturing video, capture control 610B is smaller than capture control 610A. Capture control 610C is initially displayed as a solid white circle circumscribed within a white ring (e.g., the same or similar to the appearance of capture control 610A in the standard photo capture mode (e.g., as illustrated in FIG. 6B)). In response to an input directed to capture control 610B, such as input 622E, computer system 600 pauses capturing the video media, as further described with respect to FIGS. 6I-6L. In response to an input directed to capture control 610C, such as input 622D, computer system 600 captures limited-duration media (e.g., a still or live photo) while continuing to capture the video media.

While capturing the video media and displaying camera user interface 608 in the updated state illustrated in FIG. 6E, computer system 600 deactivates control of certain camera functions via camera user interface 608, for instance, indicated by the fading out and/or removal of flash control 608A, video format control 608H, camera selection control 608D, captured media element 608E, capture mode control 608G, and spatial mode control 608I. For example, in response to inputs 622A, 622B, 622D, 622E, and/or 622F, touch inputs directed to substantially the same portions of camera user interface 608 as inputs 618A, 618B, 618D, 618E, and/or 618F, respectively, computer system 600 foregoes changing the camera flash mode, selecting the video format, changing camera direction, displaying captured media, and/or enabling spatial capture. Zoom control 608C, which remains displayed while capturing the video media, can still be controlled, for instance, performing a zoom to 2× magnification in response to an input such as 622C (e.g., a touch input directed to substantially the same portion of camera user interface 608 as inputs 614C and 618C). In some embodiments, in response to an input such as 622F and 622G directed to camera preview 612, computer system performs an auto-focus and/or auto-exposure function based on the selected portion of camera preview 612, such as described with respect to inputs 614G and/or 618G.

At FIG. 6E, computer system 600 detects a stop capture input, such as touch input 624A directed to capture control 610A or press input 624B. In response to detecting the stop capture input (e.g., 624A and/or 624B), at FIG. 6F, computer system 600 stops capturing the video media. When computer system 600 stops capturing the video media, the video capture session initiated by the capture input (e.g., 620A and/or 620B) cannot be resumed. The video captured in between the capture input (e.g., 620A and/or 620B) and the stop capture input (e.g., 624A and/or 624B) is saved (e.g., compiled and/or exported) as a discrete video media item, a thumbnail for which is shown in captured media element 608E in FIG. 6G.

Additionally, in response to detecting the stop capture input (e.g., 624A and/or 624B), computer system 600 updates camera user interface 608 as illustrated in FIGS. 6F-6G, reverting the appearance of camera user interface 608 to the standard video capture mode appearance, e.g., as described with respect to FIG. 6C. In particular, computer system 600 reverts capture control 610A to the start recording appearance (e.g., animating the solid red square expanding back out within the white ring) and displays video capture timer 608J without the background platter and recording icon and with a time of “00:00:00,” indicating that capture has been stopped. Additionally, computer system 600 re-displays flash control 608A, video format control 608H, camera selection control 608D, captured media element 608E, capture mode control 608G, and spatial mode control 608I, and stops displaying capture control 610B and capture control 610C. At FIGS. 6G-6H, in response to input 626 directed to the re-displayed video format control 608H, computer system 600 changes the video format setting for video capture to a ProRes resolution and frame rate of 60 FPS.

At FIG. 6H, computer system 600 detects a capture input, such as touch input 628A directed to capture control 610A or press input 628B. In response to detecting the capture input (e.g., 628A and/or 628B), at FIG. 6I, computer system 600 initiates capturing video media and updates camera user interface 608 as described above with respect to FIGS. 6D-6E. The video capture session initiated by capture inputs 628A and/or 628B is a distinct video capture session from the session initiated in response to capture inputs 620A and/or 620B. For example, at FIG. 6I, computer system 600 is capturing video media for inclusion in a different media item than the one saved following stop capture inputs 624A and/or 624B. The video media captured in response to detecting the capture inputs 628A and/or 628B is captured at a professional (e.g., visually lossless) resolution and a frame rate of 60 FPS, as selected via video format control 608H by input 626 prior to initiating capture.

At FIG. 6I, while capturing the video media, computer system 600 detects pause capture input 630, a touch input directed to capture control 610B. In response to detecting pause capture input 630, at FIG. 6J, computer system 600 temporarily pauses capturing the video media. In contrast to stopping capturing video media as described with respect to FIGS. 6F-6G, when computer system 600 pauses capturing the video media in response to pause capture input 630, the video capture session initiated by capture inputs 628A and/or 628B can be resumed. In some embodiments, computer system 600 does not yet save the video captured in response to capture inputs 628A and/or 628B as a discrete video media item and instead awaits potential subsequent video captures in the same video capture session.

Additionally, in response to detecting pause capture input 630, computer system 600 updates camera user interface 608 as illustrated in FIGS. 6J-6K. At FIGS. 6J-6K, computer system 600 changes the appearance of video capture timer 608J compared to its appearance both while capturing video (e.g., described with respect to FIG. 6E) and before initiating video capture, for instance, displaying video capture timer 608J with an opaque or translucent background in a different color (e.g., a gray, yellow, or orange background) and/or a pause icon. The video capture timer 608J is displayed with the total elapsed capture time of the video capture session, which remains constant (e.g., does not increase) while the capture is paused.

As illustrated in FIGS. 6J-6K, computer system 600 changes the appearance of both capture control 610A and capture control 610B. In particular, computer system 600 displays capture control 610A shrinking in overall size, for instance, contracting the white ring around the solid red square. Although capture control 610A changes overall size, it maintains the “stop recording” appearance with the solid red circle inside the white ring. Computer system 600 displays capture control 610B growing in overall size and changing to a “resume capture” appearance, for instance, animating the white ring expanding as the pause icon inside morphs into a solid red circle. For example, the “resume recording” appearance of capture control 610B appears similar to the appearance of capture control 610A with the “start recording” appearance described with respect to FIG. 6C. As illustrated in FIG. 6K, capture control 610C remains displayed with the same appearance, and capture control 610A, capture control 610B, and capture control 610C all remain displayed at the same positions, as prior to pausing. As illustrated in FIG. 6K, when paused, capture control 610B is larger than capture control 610A.

At FIGS. 6J-6K, computer system 600 re-displays flash control 608A, which had been removed when capturing video was initiated in response to capture inputs 628A and/or 628B. However, computer system 600 does not re-display other control elements of camera user interface 608 when paused, including video format control 608H, camera selection control 608D, captured media element 608E, capture mode control 608G, and spatial mode control 608I. Accordingly, while capturing video is paused, fewer controls for camera user interface 608 are active than before initiating or after stopping capturing video. For example, as illustrated in FIG. 6K, in response to inputs 632B and 632F, touch inputs directed to substantially the same portions of camera user interface 608 as inputs 618B and 618F, respectively, computer system 600 foregoes changing the selecting the video format and/or enabling spatial capture. In some embodiments, in response to an input such as 632F and 632G directed to camera preview 612, computer system performs an auto-focus and/or auto-exposure function based on the selected portion of camera preview 612, such as described above.

At FIG. 6K, while capturing the video media is paused, computer system 600 detects input 632A, a touch input directed to the re-displayed flash control 608A, and input 632C, a touch input directed to the 2× zoom element of zoom control 608C. In response to detecting input 632A, at FIG. 6L, computer system 600 changes the camera flash mode for camera user interface 608, in particular, placing the camera flash in the persistent-on state for video capture. As illustrated in FIG. 6L, in response to detecting input 632A, computer system 600 changes the appearance of flash control 608A to a selected appearance to reflect the persistent-on state, for instance, displaying the camera flash icon without the cross bar. In response to detecting input 632B, computer system 600 performs a zoom to 2× magnification, displaying camera preview 612 at a 2× zoom level at FIG. 6L. As illustrated in FIG. 6L, capturing the video media remains paused while adjusting the flash setting and zoom level (e.g., video is not being captured as part of the initiated video capture session and the time shown video capture timer 608J does not increase). Accordingly, a user can adjust the lighting and framing when changing from the shot of a person in front of a tent shown in FIGS. 6H-6J to the shot of a person sitting at a bonfire shown in FIGS. 6K-6L without ending the video capture session or capturing video during the adjustments.

In some embodiments, limited-duration (e.g., photo) media can be captured using an input directed to capture control 610C while capturing the video media is paused (e.g., as described with respect to FIG. 6E).

At FIG. 6L, while capturing the video media is paused, computer system 600 detects resume capture input such as input 634A, a touch input directed to capture control 610B displayed with its “resume recording” appearance, and/or input 634B, a touch input directed to video capture timer 608J while displayed with the pause icon. In response to detecting resume capture input 634, at FIG. 6M, computer system 600 resumes capturing the video media, and in particular, resumes the video capture session initiated by capture inputs 628A and/or 628B. As illustrated at FIG. 6M, computer system 600 resumes updating the time shown on video capture timer 608J from the time at which pause capture input 630 was detected, reflecting that resumed capture is adding to the overall capture duration of the video capture session initiated by capture inputs 628A and/or 628B. Alternatively, while capturing the video media is paused, in response to a stop capture input, such as touch input 636A directed to capture control 610A (e.g., displayed at the smaller size with its “stop recording” appearance) and/or press input 636B at FIG. 6L, computer system 600 will stop capturing the video media as described with respect to FIG. 6F-6G (e.g., ending the video capture session initiated by capture inputs 628A and/or 628B without first resuming capture, saving the video captured during the session as a discrete video media item, and reverting the appearance of camera user interface 608 to the standard video capture mode appearance).

In response to detecting resume capture input 634A and/or 634B, computer system 600 updates camera user interface 608 as illustrated in FIGS. 6M-6N. In particular, computer system 600 reverts capture control 610B to the “pause recording” appearance (e.g., animating the solid red circle contracting and changing into the pause icon within the white ring) and smaller size, and reverts capture control 610A to the larger size (e.g., while maintaining the “stop recording” appearance). Computer system 600 additionally removes flash control 608A and displays video capture timer 608J with the recording icon and background platter.

At FIG. 6N, after resuming capture in response to capture input 634A and/or 634B, computer system 600 detects stop capture input, such as touch input 638A directed to capture control 610A or press input 638B, computer system 600 stops capturing the video media as described with respect to FIGS. 6F-6G, ending the video capture session initiated by capture inputs 628A and/or 628B, saving the video captured during the session as a discrete video media item (video media item 642, illustrated in FIG. 6P), and reverting the appearance of camera user interface 608 to the standard video capture mode appearance as illustrated in FIG. 6O.

At FIG. 6O, computer system 600 detects input 640 directed to captured media element 608E, which, after stopping the video capture in response to stop capture inputs 638A and/or 638B, includes a thumbnail of video media item (642). In response to input 640, at FIG. 6P, computer system 600 displays video media item 642 in media viewing user interface 644. Media viewing user interface 644 includes media carousel 644A, which shows thumbnails of media items (e.g., from a user's media library), and video scrubber 644B, a representation of a timeline of video media item 642. As illustrated by video scrubber 644B, video media item 642 includes both video segment 642A, the video captured between capture inputs 628A and/or 628B and pause capture input 630, and video segment 642B, the video captured between resume capture inputs 634A and/or 634B and stop capture inputs 638A and/or 638B, and does not include any video content from between pause capture input 630 and resume capture inputs 634A and/or 634B. As illustrated by media carousel 644A, video media item 642 is a separate video media item from video media item 646, the video media captured between capture inputs 620A and/or 620B and stop capture inputs 624A and/or 624B.

FIGS. 7A-7B are a flow diagram illustrating a method for controlling video media capture using a computer system in accordance with some embodiments. Method 700 is performed at a computer system (e.g., 100, 300, 500, and/or 600) that is in communication with one or more display generation components (e.g., 606) (e.g., a display controller(s); a touch-sensitive display system; one or more displays (e.g., integrated and/or connected), a 3D display, one or more transparent displays, one or more projectors, and/or a heads-up display), one or more input devices (e.g., 602A, 602B, 602C, and/or 606) (e.g., one or more hardware buttons and/or surfaces, such as mechanical (e.g., physically depressible), solid-state, intensity-sensitive, and/or touch-sensitive (e.g., capacitive) buttons and/or surfaces; one or more audio input devices, such as microphones or vibration sensors; one or more optical input devices, such as cameras and/or depth sensors), and one or more cameras (e.g., 604A, 604B, 604C, and/or 604D) (e.g., one or more rear (e.g., user-facing) cameras and/or one or more forward (e.g., environment-facing) cameras). In some embodiments, the one or more cameras include a plurality of cameras with different lenses/lens types, such as a standard camera, a telephoto camera, and/or a wide-angle camera. In some embodiments, the one or more cameras include a camera array/stereo camera for spatial capture, where at least a first camera and a second camera are located a distance apart, such that the perspective of the first camera is different from the perspective of the second camera and thus at least a portion of a field of view of the first camera is outside of a field of view of the second camera. In some embodiments, the computer system is optionally configured to communicate with one or more sensors, such as camera sensors, optical sensors, depth sensors, capacitive sensors, intensity sensors, motion sensors, vibration sensors, and/or audio sensors. Some operations in method 700 are, optionally, combined, the orders of some operations are, optionally, changed, and some operations are, optionally, omitted.

As described below, method 700 provides an intuitive way to control video media capture. The method reduces the cognitive burden on a user when controlling video media capture, thereby creating a more efficient human-machine interface. For battery-operated computing devices, enabling a user to control video media capture faster and more efficiently conserves power and increases the time between battery charges.

While displaying, via the one or more display generation components, a media capture user interface (e.g., 608) (e.g., a camera user interface) including a first video recording user interface object (e.g., 610A) (e.g., a record option/button that, when selected, controls capturing video media) displayed with a first appearance (e.g., as illustrated in FIGS. 6C, 6G-6H, and/or 6O) (e.g., a “start recording” appearance) (and, optionally, without displaying a second video recording user interface object with a third appearance), the computer system (e.g., 600) detects (702), via the one or more input devices, a first input (e.g., 620A, 620B, 628A, and/or 628B) directed to (e.g., selecting and/or activating) the first video recording user interface object (e.g., an input requesting the initiation of recording/video media capture). In some embodiments, the media capture user interface is a video capture user interface. In some embodiments, the media capture user interface includes the selectable video recording UI object when the media capture user interface is in a respective mode or state (e.g., a standard and/or cinematic video capture mode). In some embodiments, displaying the first video recording user interface object with the first appearance includes displaying the first video recording user interface object at an initial (overall) size. For example, the first appearance of the first video recording user interface object includes a solid red circle inscribed within a ring of the initial size. In some embodiments, displaying the first video recording user interface object with the first appearance includes displaying the first video recording user interface object at a first location, e.g., within the media capture user interface and/or the display area of the one or more display generation components. In some embodiments, the input directed to the first video recording user interface object includes a touch, tap, press, gesture, and/or air gesture directed to the video recording user interface object in the media capture user interface, for instance, detected via a touch-sensitive display of the one or more display generation components and/or another hardware input device (e.g., a hardware button press corresponding to a request to capture video media).

In response to detecting the first input directed to the first video recording user interface object (704), the computer system (e.g., 600) initiates (706) capturing first video media using the one or more cameras (e.g., as described with respect to FIGS. 6E-6F and/or 6I). In response to detecting the first input directed to the first video recording user interface object (704), the computer system displays (708), via the one or more display generation components, the first video recording user interface object (e.g., 610A) with a second appearance (e.g., a “stop recording” appearance) different from the first appearance (e.g., as illustrated in FIGS. 6E, 6I, and/or 6N). In some embodiments, displaying the first video recording user interface object with the second appearance includes morphing, resizing, moving, changing color of, changing opacity of, ceasing display of, and/or adding one or more elements of the first user interface object. In some embodiments, displaying the first video recording user interface object with the second appearance includes animating the first video recording user interface object changing from the first appearance to the second appearance. In some embodiments, displaying the first video recording user interface object with the second appearance includes displaying the second video recording user interface object at a second (overall) size different from (e.g., smaller or larger than) the initial size (e.g., the size when displayed with the first appearance). For example, the second appearance of the first video recording user interface object includes a solid red square (e.g., smaller than the solid red circle) inscribed within a ring of the second size. In some embodiments, displaying the first video recording user interface object with the second appearance includes maintaining displaying the second video recording user interface object at the first location (e.g., the overall location of the first video recording user interface object does not change when the appearance is changed). In some embodiments, the location of the first video recording user interface object does not change while the first video recording user interface object is displayed.

In response to detecting the first input directed to the first video recording user interface object (704), the computer system (e.g., 600) displays (710), via the one or more display generation components, a second video recording user interface object (e.g., 610B) (e.g., a recording option/button that, when selected, controls capturing video media) with a third appearance (e.g., a “pause recording” appearance) different from the first appearance and different from the second appearance (e.g., as described with respect to FIGS. 6E, 6I, and/or 6N). In some embodiments, displaying the second video recording user interface object with the third appearance includes displaying the second video recording user interface object at a second location different from the first location. In some embodiments, the location of the second video recording user interface object does not change while the second video recording user interface object is displayed.

While capturing the first video media (and, optionally, while displaying the first video recording user interface object with the second appearance and displaying the second video recording user interface object with the third appearance), the computer system (e.g., 600) detects (712), via the one or more input devices, a second input directed to the media capture user interface (e.g., 622A, 622B, 622C, 622D, 622E, 622F, 624A, 624B, 630, 638A, and/or 638B). In some embodiments, the second input includes a touch, tap, press, gesture, and/or air gesture, e.g., directed to the media capture user interface, for instance, detected via a touch-sensitive display of the one or more display generation components and/or another hardware input device.

In response to detecting the second input directed to the media capture user interface (714) and in accordance with a determination that the second input is directed to the first video recording user interface object (e.g., 610A), the computer system (e.g., 600) ceases (716) capturing the first video media using the one or more cameras (e.g., as described with respect to FIGS. 6F-6G and/or 6O) (e.g., ending the first video media capture without maintaining the ability to resume capturing the first video media). For example, ceasing capturing the first video media includes generating (e.g., compiling, encoding, and/or saving) a respective media item (e.g., a single file or group of files) of the first video media. In some embodiments, after ceasing capturing the first video media, subsequent video media captures generate separate media items from the first media items, e.g., the first media item is “finalized” when the capture is stopped.

In response to detecting the second input directed to the media capture user interface (714) and in accordance with a determination that the second input is directed to the second video recording user interface object (e.g., 610B), the computer system (e.g., 600) pauses (718) capturing the first video media, using the one or more cameras, while maintaining ability to resume capturing the first video media (e.g., as described with respect to FIGS. 6J-6L) (e.g., temporarily stopping the first video media capture). In some embodiments, after pausing capturing the first video media, the first media capture can be re-started by selecting the second video recording user interface object. In some embodiments, pausing capturing the first video media does not include generating a respective media item of the first video media, e.g., allowing additional video data to be captured for inclusion in the respective media item prior to finalizing. In some embodiments, pausing capturing the first video media includes generating a respective media item of the portion of the first video media capture that was captured prior to pausing, then appending/merging the respective media item with the portion(s) of the first video media capture that were captured after un-pausing. Visibly transforming a first control object (e.g., software button) for initiating capturing video media into a control object for stopping capturing video media and displaying an additional control object for pausing capturing video media while media capture is ongoing provides improved control of a video media capture user interface by automatically adapting displayed capture controls based on the current capture state, e.g., without cluttering the display or requiring additional user inputs. Doing so assists the user with composing video media captures and reduces the risk that transient media capture opportunities are missed or captured in an unintended manner by helping the user to provide proper inputs and reduce user mistakes while capturing video, which makes the video media capture user interface more efficient (e.g., reducing power usage and/or improving battery life of the system by enabling the user to capture media more quickly and efficiently). For example, using a single control object to start and stop video capture provides efficient and ergonomic control of video capture (e.g., for single-shot video media), while displaying a new control object to pause video capture when the capture is ongoing alerts the user to additional control options, e.g., for capturing multi-shot video media.

In some embodiments, while capture of the first video media is paused (e.g., as described with respect to FIGS. 6J-6L) (e.g., without having stopped or resumed capturing the first video media; e.g., in response to detecting the second input and in accordance with the determination that the second input is directed to the second video recording user interface object), the computer system (e.g., 600) detects, via the one or more input devices, a respective input (e.g., 634A) directed to the second video recording user interface object (e.g., 610B). In some embodiments, the computer system maintains displaying the second video recording user interface object while pausing the first video media item. In some embodiments, while pausing capturing the first video media, the computer system displays the second video recording user interface object with a changed appearance (e.g., a “resume recording” appearance different from the third appearance, e.g., the fourth appearance as discussed below). In some embodiments, the respective input directed to the second video recording user interface object includes a touch, tap, press, gesture, and/or air gesture directed to the second video recording user interface object in the media capture user interface (e.g., and not directed to the first video recording user interface object), for instance, detected via a touch-sensitive display of the one or more display generation components and/or another hardware input device (e.g., a hardware button press corresponding to a request to resume capturing video media). In some embodiments, in response to detecting the respective input directed to the second video recording user interface object, the computer system (e.g., 600) resumes capturing the first video media using the one or more cameras (e.g., as described with respect to FIGS. 6L-6M). In some embodiments, the first video media item includes (e.g., is generated with; In some embodiments, once capture is stopped) both video captured between the first and second input and video captured after the respective input (e.g., resuming capturing the first video media initiates capturing additional video media to be included in the same media item being captured prior to pausing). Resuming capturing video media via the second control object after pausing capturing the video media via the second control object provides improved control of a video media capture user interface. Doing so assists the user with composing video media captures and reduces the risk that transient media capture opportunities are missed or captured in an unintended manner by helping the user to provide proper inputs and reduce user mistakes while capturing video, which makes the video media capture user interface more efficient (e.g., reducing power usage and/or improving battery life of the system by enabling the user to capture media more quickly and efficiently). For example, using a single control object to pause and resume an ongoing video capture provides efficient and ergonomic control of video capture for multi-shot video media. Doing so also provides improved control of video media capture by reducing the time, number of inputs, and power used to create multi-shot video media (e.g., reducing power usage and/or improving battery life of the system by enabling the user to capture media more quickly and efficiently), for instance, allowing the user to capture multiple shots without unnecessarily generating multiple video media items and/or needing the user to manually edit the multiple video media items together.

In some embodiments, while capture of the first video media is paused (e.g., as described with respect to FIGS. 6J-6L), the computer system (e.g., 600) maintains displaying, via the one or more display generation components, the first video recording user interface object (e.g., 610A) (e.g., the record button used to initiate capturing the first video media is not removed from the media capture user interface while the video capture is paused.). In some embodiments, while pausing capturing the first video media, in response to detecting, via the one or more input devices, an input directed to the first video recording user interface, the computer system ceases capturing the first video media (e.g., the video media capture can also be stopped both while the capture is ongoing and when the capture is paused). Continuing to display the control object for stopping capturing video media that was displayed while a video capture was ongoing while the video capture is paused (e.g., while the ability to resume the video capture is maintained) provides improved control of a video media capture user interface by reducing the time, number of inputs, and power used to complete a video capture from the paused state. For example, if a user pauses a video capture, then decides to complete the video capture without capturing additional video footage (e.g., without resuming capturing), the user can stop the video capture directly from the paused state.

In some embodiments, displaying the first video recording user interface object (e.g., 610A) with the second appearance (e.g., the “stop recording” appearance) includes displaying the first video recording user interface object at a first size (e.g., as illustrated in FIGS. 6E, 6I, and/or 6N) (e.g., with respect to the media capture user interface and/or the display area of the display generation component(s)). In some embodiments, displaying the first video recording user interface object with the first appearance includes displaying the first video recording user interface object at the first size (e.g., the first video recording user interface object does not change size when visually transforming from the start capture button into the stop capture button) or at a different size than the first size (e.g., visually transforming the start capture button into the stop capture button includes changing the size). In some embodiments, in response to detecting the second input directed to the media capture user interface and in accordance with the determination that the second input is directed to the second video recording user interface object (e.g., 610B) (e.g., upon pausing capturing the first video media), the computer system reduces a size of the first video recording user interface object (e.g., 610A) to a second size that is smaller than the first size (e.g., as described with respect to FIGS. 6J-6K) (e.g., the first recording option/button shrinks when recording is paused). In some embodiments, while displaying the first video recording user interface object at the second size, the first video recording object remains displayed with the second appearance (e.g., the “stop recording” appearance). In some embodiments, while displaying the first video recording user interface object at the second size, in response to a user input directed to (e.g., selecting) the first video recording user interface object, the computer system ceases capturing the first video media (e.g., without first resuming capturing the first video media), e.g., the first video recording user interface object remains a stop button while paused. Reducing the size of the control object for stopping capturing video media while an ongoing media capture is paused provides improved control of a video media capture user interface by automatically adjusting the visual prominence of the displayed controls based on the current capture state. Doing so assists the user with composing video media captures and reduces the risk that transient media capture opportunities are missed or captured in an unintended manner by helping the user to provide proper inputs and reduce user mistakes while capturing video, which makes the video media capture user interface more efficient (e.g., reducing power usage and/or improving battery life of the system by enabling the user to capture media more quickly and efficiently). For example, when the user has paused the video capture, shrinking the stop button decreases the stop button's prominence, which reduces the risk that the user will inadvertently stop the capture (e.g., by selecting the stop button) when the user wants to maintain the ability to resume recording, while still maintaining the option to stop the capture if desired (e.g., if the user changes their mind and no longer wishes to resume recording).

In some embodiments, reducing the size of the first video recording user interface object includes displaying, via the one or more display generation components, an animation of the first video recording user interface object shrinking (In some embodiments, gradually shrinking) from the first size to the second size (e.g., as described with respect to FIGS. 6J-6K). Displaying an animation of the control object for stopping capturing video media shrinking when an ongoing video capture is paused provides users with improved visual feedback about a state of the computer system without cluttering the display, which assists the user with control of the computer system via the media capture user interface. For example, animating the control object for stopping capturing video media shrinking intuitively indicates to the user that the ongoing video capture is being paused and reduces the risk that the user will inadvertently stop the capture (e.g., by selecting the stop button) when the user wants to maintain the ability to resume recording.

In some embodiments, in response to detecting the second input directed to the media capture user interface and in accordance with the determination that the second input is directed to the second video recording user interface object (e.g., 610B) (e.g., upon pausing capturing the first video media), the computer system (e.g., 600) displays, via the one or more display generation components, the second video recording user interface object with a fourth appearance (e.g., a “resume recording” appearance) different from the third appearance (e.g., as described with respect to FIGS. 6K-6L) (e.g., the “pause recording” appearance with which the second button is displayed while capturing the first video media). In some embodiments, the fourth appearance of the second video recording user interface object is the same as or similar to the first appearance of the first video recording user interface object (e.g., the “start recording” appearance). In some embodiments, in response to detecting a respective input directed to the second video recording user interface object while the second video recording user interface object is displayed with the fourth appearance, the computer system resumes capturing the first video media using the one or more cameras. Visibly transforming the control object for pausing capturing video media into a control object for resuming capturing video media while an ongoing video capture is paused provides users with improved visual feedback about a state of the computer system without cluttering the display, which assists the user with control of the computer system via the media capture user interface. For example, changing the appearance of the control object used to pause an ongoing video capture intuitively indicates to the user that the ongoing video capture is being paused and that the control object can now be used to resume the ongoing video capture.

In some embodiments, a size of the second video recording user interface object with the fourth appearance (e.g., as illustrated in FIGS. 6K-6L) is larger than a size of the second video recording user interface object with the third appearance (e.g., as illustrated in FIGS. 6E, 6I, and/or 6N). In some embodiments, in the third appearance, the size of the second video recording user interface object is smaller than the first size, e.g., the pause button is smaller than the stop button while recording is ongoing. In some embodiments, in the fourth appearance, the size of the second video recording user interface object is larger than the second size, e.g., the resume button is larger than the stop button while recording is paused. In some embodiments, in response to detecting the second input directed to the media capture user interface and in accordance with the determination that the second input is directed to the second video recording user interface object (e.g., upon pausing capturing the first video media), the computer system displays an animation of the second video recording user interface object growing (In some embodiments, gradually growing) as it updates from the third appearance to the fourth appearance. Increasing the size of the control object for resuming capturing video media while an ongoing media capture is paused provides improved control of a video media capture user interface by automatically adjusting the visual prominence of the displayed controls based on the current capture state. Doing so assists the user with composing video media captures and reduces the risk that transient media capture opportunities are missed or captured in an unintended manner by helping the user to provide proper inputs and reduce user mistakes while capturing video, which makes the video media capture user interface more efficient (e.g., reducing power usage and/or improving battery life of the system by enabling the user to capture media more quickly and efficiently). For example, when the user has paused the video capture, expanding the resume button increases the resume button's prominence, which reduces the risk that the user will inadvertently stop the capture (e.g., by selecting the stop button) when the user wants to resume recording.

In some embodiments, in response to detecting the second input directed to the media capture user interface and in accordance with the determination that the second input is directed to the second video recording user interface object (e.g., 610B) (e.g., upon pausing capturing the first video media), the computer system (e.g., 600) displays, via the one or more display generation components, an animation of the second video recording user interface object changing (In some embodiments, gradually transforming) from the third appearance (e.g., the “pause recording” appearance) to the fourth appearance (e.g., the “resume recording” appearance), wherein changing from the third appearance to the fourth appearance includes increasing a size of the second video recording user interface object (e.g., as described with respect to FIG. 6J) (e.g., from the third size to the fourth size). Displaying an animation of the control object for pausing capturing video media expanding and transforming into a control object for resuming capturing video media when an ongoing video capture is paused provides users with improved visual feedback about a state of the computer system without cluttering the display, which assists the user with control of the computer system via the media capture user interface. For example, animating the control object for pausing capturing video media visually transforming and expanding intuitively indicates to the user that the ongoing video capture is being paused and draws the user's attention to the control object for resuming capturing video, reducing the risk that the user will inadvertently stop the capture (e.g., by selecting the stop button) when the user wants to resume recording.

In some embodiments, while displaying the first video recording user interface object (e.g., 610A) with the second appearance (e.g., as described with respect to FIGS. 6E, 6I, and/or 6N) (e.g., the “stop recording” appearance) (e.g., while capturing the first video media and/or pausing capturing the first video media), the computer system (e.g., 600) detects, via the one or more input devices, a respective input directed to the first video recording user interface object (e.g., 624A, 624B, 638A, and/or 638B). In some embodiments, the respective input includes the second input directed to the media capture user interface. In some embodiments, in response to detecting the respective input directed to the first video recording user interface object, the computer system ceases displaying the second video recording user interface object (e.g., as described with respect to FIGS. 6F-6G and/or 6O). In some embodiments, in response to detecting the respective input directed to the first video recording user interface object, the computer system ceases capturing the first video media using the one or more cameras. Ceasing displaying the control object for pausing capturing video media when an ongoing capture is stopped provides users with improved visual feedback about a state of the computer system without cluttering the display, which assists the user with control of the computer system via the media capture user interface, for example, intuitively indicating to the user that the recording has been stopped (e.g., and cannot be resumed).

In some embodiments, in response to detecting the first input (e.g., 620A, 620B, 628A, and/or 628B) directed to the first video recording user interface object (e.g., 610A) (e.g., upon initiating capturing the first video media), the computer system (e.g., 600) displays (e.g., concurrently with displaying the first video recording user interface object with the second appearance and displaying the second video recording user interface object with the third appearance), via the one or more display generation components, a photo capture user interface object (e.g., 610C). In some embodiments, the photo capture user interface object is displayed at a different location than the first and second video recording user interface objects. In some embodiments, the photo capture user interface object is displayed with a different appearance than at least the second appearance and the third appearance (e.g., the photo capture user interface object appears different from the stop button and pause button) and, in some embodiments, a different appearance than the first and/or fourth appearance (e.g., the photo capture user interface object appears different from the start button and resume button). In some embodiments, the computer system detects, via the one or more input devices, a respective input directed to the photo capture user interface object (e.g., 622D). In some embodiments, the respective input directed to the photo capture user interface object includes a touch, tap, press, gesture, and/or air gesture directed to the photo capture user interface object in the media capture user interface (e.g., and not directed to the first or second video recording user interface objects), for instance, detected via a touch-sensitive display of the one or more display generation components and/or another hardware input device (e.g., a hardware button press corresponding to a request to capture a photo during an ongoing video capture). In some embodiments, in response to detecting the respective input directed to the photo capture user interface object, the computer system captures first photo media using the one or more cameras (e.g., as described with respect to FIG. 6E). In some embodiments, the first photo media includes stiill (e.g., single-frame) photo media. In some embodiments, the first photo media includes photo media with a limited (e.g., 0.5 s, 1 s, 3 s, and/or 5 s) duration, such as a multi-frame capture that includes content (e.g., frames) from before and/or after a capture input is detected, creating a “live” effect. In some embodiments, the first photo media includes one or more images (e.g., frames) that are displayed in sequence, such as a media item that saved in the graphical interface file format. In some embodiments, the computer system maintains displaying the photo capture user interface object (e.g., concurrently with displaying the first video recording user interface object the second video recording user interface object) while pausing capturing the first video media. In some embodiments, if the respective input is detected while capturing the first video media, the computer system captures the first photo media while continuing capturing the first video media using the one or more cameras. In some embodiments, if the respective input is detected while pausing capturing the first video media, the computer system captures the first photo media while continuing to pause capturing the first video media (e.g., while maintaining the ability to resume capturing the first video media after capturing the first photo media). In some embodiments, in response to detecting an input stopping capturing the first video media (e.g., an input directed to the first video recording user interface object while displaying the first video recording user interface object with the second appearance), the computer system ceases displaying the photo capture user interface object. Automatically displaying a control object for capturing photo media while capturing video media provides improved control of a video media capture user interface by automatically adapting capture controls based on the current capture state without cluttering the display. Doing so assists the user with composing video media captures and reduces the risk that transient media capture opportunities are missed or captured in an unintended manner by helping the user to provide proper inputs and reduce user mistakes while capturing video, which makes the video media capture user interface more efficient (e.g., reducing power usage and/or improving battery life of the system by enabling the user to capture media more quickly and efficiently). For example, the control object for capturing photo media is not displayed before initiating video capture, reducing the risk that a user will inadvertently capture media of an unintended type, and the control object for capturing photo media is displayed once video capture has been initiated, providing the user with additional capture options without needing to stop the video capture.

In some embodiments, while capturing the first video media (e.g., as described with respect to FIGS. 6E, 6I, and/or 6N) (e.g., initially or after resuming) (e.g., while displaying the first video recording user interface object with the second (stop recording) appearance and displaying the second video recording user interface object with the third (pause recording) appearance), a size of the first video recording user interface object (e.g., 610A) is larger than a size of the second video recording user interface object (e.g., 610B). For example, while capture is ongoing, the stop button is larger than the pause button. In some embodiments, while capture of the first video media is paused (e.g., as described with respect to FIGS. 6K-6L) (e.g., while displaying the first video recording user interface object with the second (stop recording) appearance and/or displaying the second video recording user interface object with the fourth (resume recording) appearance), the size of the first video recording user interface object is smaller than the size of the second video recording user interface object. For example, while capture is paused, the stop button is smaller than the resume button. In some embodiments, in response to an input pausing capturing the first video media (e.g., via the second video recording user interface object), the computer system displays an animation of the first video recording user interface object shrinking and/or an animation of the second video recording user interface object growing. In some embodiments, in response to an input resuming capturing the first video media (e.g., via the second video recording user interface object, after capture has been paused), the computer system displays an animation of the first video recording user interface object growing and/or an animation of the second video recording user interface object shrinking. Changing the relative sizing of the control object for stopping capturing video media and the control object for pausing/resuming video media such that the stop button is larger while capturing media and smaller while the media capture is paused provides improved control of a video media capture user interface by automatically adjusting the visual prominence of the displayed controls based on the current capture state. Doing so assists the user with composing video media captures and reduces the risk that transient media capture opportunities are missed or captured in an unintended manner by helping the user to provide proper inputs and reduce user mistakes while capturing video, which makes the video media capture user interface more efficient (e.g., reducing power usage and/or improving battery life of the system by enabling the user to capture media more quickly and efficiently). For example, when the user has paused the video capture, shrinking the stop button decreases the stop button's relative visual prominence compared to the resume button, which reduces the risk that the user will inadvertently stop the capture (e.g., by selecting the stop button) when the user wants to maintain the ability to resume recording, while still maintaining the option to stop the capture if desired (e.g., if the user changes their mind and no longer wishes to resume recording).

In some embodiments, displaying the first video recording user interface object (e.g., 610A) with the first appearance (e.g., as described with respect to FIGS. 6C, 6G-6H, and/or 6O) (e.g., the “start recording” appearance) includes displaying the first video recording user interface object at a respective size. In some embodiments, while capturing the first video media (e.g., as described with respect to FIGS. 6E, 6I, and/or 6N), the size of the second video recording user interface object (e.g., 610B) is smaller than the respective size. For example, the pause button is smaller than the start recording button. In some embodiments, the respective size is the same size as the first size (e.g., while capturing the first video media and displaying the first video recording user interface object with the second, “stop recording” appearance, the first video recording user interface object is displayed at the respective size, e.g., the first video recording user interface object is not resized when capture is initiated). Displaying the second video recording user interface object at a smaller size than the first video recording user interface object provides the user with visual feedback about the relevance and operations of the objects, thereby providing improved visual feedback and enabling the user to differentiate between the two objects based on size.

In some embodiments, displaying the first video recording user interface object (e.g., 610A) with the first appearance (e.g., as described with respect to FIGS. 6C, 6G-6H, and/or 6O) (e.g., the “start recording” appearance) includes displaying the first video recording user interface object at a respective size, and, while capture of the first video media is paused, the size of the first video recording user interface object is smaller than the respective size (e.g., as described with respect to FIGS. 6K-6L). For example, when recording is paused, the stop button is smaller than the start recording button. In some embodiments, the respective size is the same size as the first size (e.g., while capturing the first video media and displaying the first video recording user interface object with the second, “stop recording” appearance, the first video recording user interface object is displayed at the respective size, e.g., the first video recording user interface object shrinks when capture is paused). Displaying the first video recording user interface object different sizes provides the user with visual feedback about the state of the computer system (e.g., recording, paused, and/or stopped), thereby providing improved visual feedback.

In some embodiments, while capture of the first video media is paused, the computer system displays, via the one or more display generation components, the second video recording user interface object (e.g., 610B) with a respective appearance different from the second appearance (e.g., as described with respect to FIGS. 6K-6L). In some embodiments, the respective appearance is the fourth appearance (e.g., the “resume recording” appearance). In some embodiments, while capture of the first video media is paused, the computer system detects, via the one or more input devices, a respective input directed to the second video recording user interface object (e.g., 634A). In some embodiments, the respective input directed to the second video recording user interface object includes a touch, tap, press, gesture, and/or air gesture directed to the second video recording user interface object in the media capture user interface (e.g., and not directed to the first video recording user interface object), for instance, detected via a touch-sensitive display of the one or more display generation components and/or another hardware input device (e.g., a hardware button press corresponding to a request to pause capturing ongoing video capture). In some embodiments, in response to detecting the respective input directed to the second video recording user interface object (e.g., 634A), the computer system resumes capturing the first video media using the one or more cameras and displays, via the one or more display generation components, the second video recording user interface object with the third appearance (e.g., as described with respect to FIG. 6N) (e.g., the “pause recording” appearance). For example, the second video recording user interface object is re-displayed as a pause button when recording is resumed. Visibly transforming a control object for pausing capturing video media into a control object for resuming capturing video media while the capture is paused, and then back to a control object for pausing capturing video media when the capture is resumed provides improved control of a video media capture user interface by automatically adapting displayed capture controls based on the current capture state and by providing users with improved visual feedback about a state of the computer system without cluttering the display. Doing so assists the user with composing video media captures and reduces the risk that transient media capture opportunities are missed or captured in an unintended manner by helping the user to provide proper inputs and reduce user mistakes while capturing video, which makes the video media capture user interface more efficient (e.g., reducing power usage and/or improving battery life of the system by enabling the user to capture media more quickly and efficiently). For example, using a single control object to pause and resume video capture provides efficient and ergonomic control of video capture (e.g., for multi-shot video media), and the visible transformation back to the “pause recording” appearance intuitively indicates to the user that capture can be re-paused.

In some embodiments, displaying the first video recording user interface object (e.g., 610A) with the first appearance (e.g., the “start recording” appearance) includes displaying the first video recording user interface object at a respective size (e.g., as illustrated in FIGS. 6C, 6G-6H, and/or 6O) (e.g., an initial size). In some embodiments, displaying the second video recording user interface object (e.g., 610B) with the third appearance (e.g., the “pause recording” appearance) includes displaying the second video recording user interface object at a smaller size than the respective size (e.g., as illustrated in FIGS. 6E, 6I, and/or 6N). Displaying the second video recording user interface object with the third appearance at a smaller size than the first video recording user interface object with the first appearance provides the user with visual feedback about the relevance and operations of the objects, thereby providing improved visual feedback and enabling the user to differentiate between the two objects based on size.

In some embodiments, while capture of the first video media is paused, the computer system displays, via the one or more display generation components, the first video recording user interface object (e.g., 610A) at a second respective size (e.g., as illustrated in FIGS. 6K-6L) (In some embodiments, the second respective size is the second size). In some embodiments, in response to detecting the respective input directed to the second video recording user interface object (e.g., 634A), the computer system (e.g., 600) displays, via the one or more display generation components, the first video recording user interface object at larger size than the second respective size (e.g., as illustrated in FIG. 6N) (e.g., the first size). For example, the stop button shrinks when an ongoing capture is paused and grows when the capture is resumed. Increasing the size of the first video recording user interface object in response to detecting the respective input directed to the second video recording user interface object provides the user with visual feedback that the input was received and/or the state of the computer system (e.g., recording vs. stopped), thereby providing improved visual feedback.

In some embodiments, while capturing the first video media (e.g., in response to detecting the input directed to the first video recording user interface object and/or in response to an input resuming capturing the first video media after pausing), the computer system (e.g., 600) displays, via the one or more display generation components, a video timer user interface object (e.g., 608J) (e.g., a capture timer indicator the current duration of the first video media) with a first timer appearance (e.g., as illustrated in FIGS. 6D-6E, 6I, and/or 6M-6N). For example, the video timer user interface object includes text indicating the current elapsed time of the capture superimposed over a background element (e.g., platter). In some embodiments, the video timer user interface object is displayed within the media capture user interface, e.g., overlaying the capture preview region. In some embodiments, while capture of the first video media is paused, the computer system updates displaying the video timer user interface object from the first timer appearance to a second timer appearance different from the first timer appearance (e.g., as illustrated in FIGS. 6J-6L). In some embodiments, changing the video timer user interface object from the first timer appearance to the second appearance includes changing the opacity, pattern, border, shape, size, and/or animation of one or more elements of the video timer. For example, while capturing the first video media, the capture timer includes a recording icon (e.g., a blinking red dot), and while the capture is paused, the recording icon transforms into a pause icon (e.g., a static, yellow pause symbol). In some embodiments, in response to ceasing capturing the first video media (e.g., in response to an input directed to the first video recording user interface object), the computer system ceases displaying the video timer user interface object. Displaying a capture timer while capturing video media and changing the capture timer's appearance while the capture is paused provides users with improved visual feedback about a state of the computer system without cluttering the display, which assists the user with control of the computer system via the media capture user interface. For example, the change in the capture timer's appearance indicates to the user that the video capture has been paused, while still allowing the user to view the current elapsed time of the captured video.

In some embodiments, displaying the video timer user interface object with the first timer appearance includes displaying a background element of the video timer user interface object with a first color (e.g., as described with respect to FIGS. 6D-6E, 6I, and/or 6M-6N) (e.g., red, white, and/or black), and displaying the video timer user interface object with the second timer appearance includes displaying the background element of the video timer user interface object with a second color different from the first color (e.g., as described with respect to FIGS. 6J-6L) (e.g., yellow, orange, and/or gray). In some embodiments, changing the video timer user interface object from the first timer appearance to the second appearance includes changing the opacity, pattern, border, shape, and/or size of the background element. Displaying the background of the video timer user interface object with different colors provides the user with visual feedback about the state of the computer system (e.g., that recording is paused or being performed), thereby providing improved visual feedback.

In some embodiments, the video timer user interface object (e.g., 608J) includes an indication (e.g., a visual indication) of a duration of the first video media. In some embodiments, the indication of the duration of the first video media includes a textual timer readout (e.g., a “digital” timer readout). In some embodiments, while capturing the first video media, the computer system visually updates the indication of the duration of the first video media (e.g., advancing the timer readout) at a regular interval (e.g., as illustrated in FIGS. 6D-6E, 6I, and/or 6M-6N) (e.g., 100 times per second, ten times per second, once per second, once per minute and/or once per hour). In some embodiments, while capture of the first video media is paused, the computer system foregoes visually updating the indication of the duration of the first video media (e.g., as illustrated in FIGS. 6J-6L) (e.g., ceasing advancing the timer readout). For example, while capturing media, the video timer user interface object regularly increments to indicate the increasing capture duration, and while pausing capturing media, the video timer user interface stops incrementing (e.g., statically indicating the capture duration at the time the capture was paused). Forgoing visually updating the indication of the duration of the first video media provides the user with visual feedback that recording is paused, thereby providing improved visual feedback.

In some embodiments, while capture of the first video media is paused, the computer system detects, via the one or more input devices, an input of a respective type (e.g., 632A) (e.g., an input that can be used for adjusting a media capture flash setting). In some embodiments, the input of the respective type includes an input directed to a location of a flash user interface object (e.g., software button) of the media capture user interface. In some embodiments, the flash user interface object is displayed while the computer system is not capturing video media using the one or more cameras (e.g., prior to initiating capture, while paused, and after ceasing capture). In some embodiments, while capturing video media (e.g., initially and/or after resuming capturing), the computer system foregoes displaying the flash user interface object. In some embodiments, the flash user interface object is displayed with an “active” appearance (e.g., relatively high in visual prominence) while the computer system is not capturing video media and displayed with an “inactive” appearance (e.g., faded, grayed out, crossed out, or otherwise reduced in visual prominence). In some embodiments, the input of the respective type includes a touch, tap, press, gesture, and/or air gesture directed to the flash user interface object in the media capture user interface and/or directed to/detected by a hardware button associated with the flash setting (e.g., tapping one or more times to select, toggle, and/or cycle between flash settings). In some embodiments, the input of the respective type includes a movement component, such as a swipe, drag, and/or flick gesture, for instance, detected via a touch-sensitive display of the one or more display generation components and/or the hardware button associated with the flash setting (e.g., swiping across a user interface element or the surface of the hardware button to switch, toggle, and/or cycle forward or backwards between flash settings). In some embodiments, in response to detecting the input of the respective type, the computer system changes (e.g., adjusting) a flash setting for capturing media (e.g., as described with respect to FIGS. 6K-6L) (e.g., turning a lighting device on or off for video capture, enabling or disabling flash for photo capture, and/or adjusting a characteristic of the light being emitted). For example, while an ongoing capture is paused, the flash setting can be changed such that when the capture is resumed, it is performed with a different flash setting than before the capture was paused. Enabling control of a flash setting for media capture while an ongoing video capture is paused provides improved control of a video media capture user interface by automatically adapting capture controls based on the current capture state. Doing so assists the user with composing video media captures and reduces the risk that transient media capture opportunities are missed or captured in an unintended manner by helping the user to provide proper inputs and reduce user mistakes while capturing video, which makes the video media capture user interface more efficient (e.g., reducing power usage and/or improving battery life of the system by enabling the user to capture media more quickly and efficiently). For example, when composing multi-shot video media by pausing via the second video recording user interface object, the user is able to adjust the flash setting between shots (e.g., when paused) without needing to cease capturing.

In some embodiments, while capturing the first video media, detecting, via the one or more input devices, a second input of the respective type (e.g., 622A) (e.g., an input directed to the location of a flash user interface object and/or a particular hardware button input). In some embodiments, the second input is detected while the flash user interface object is not displayed and/or displayed with the “inactive” appearance. In some embodiments, the input of the respective type includes a touch, tap, press, gesture, air gesture, and/or movement input directed to the flash user interface object in the media capture user interface and/or directed to/detected by a hardware button associated with the flash setting. For example, the second input of the respective type includes tapping or swiping at the region of the media capture user interface where the flash user interface object is (or was) displayed, and/or providing inputs of the respective type via the hardware button associated with the flash setting. In some embodiments, in response to detecting the input of the respective type, the computer system foregoes changing the flash setting for capturing media (e.g., as described with respect to FIG. 6E). For example, while a video capture is ongoing, the flash setting remains in the same state it was when the video capture was started (e.g., initiated and/or resumed). Disabling control of a flash setting for media capture while capturing video (e.g., actively) provides improved control of a video media capture user interface by automatically adapting capture controls based on the current capture state. Doing so assists the user with composing video media captures and reduces the risk that transient media capture opportunities are missed or captured in an unintended manner by helping the user to provide proper inputs and reduce user mistakes while capturing video, which makes the video media capture user interface more efficient (e.g., reducing power usage and/or improving battery life of the system by enabling the user to capture media more quickly and efficiently). For example, disabling control of the flash setting reduces the risk of unintentionally changing the lighting during an ongoing capture.

In some embodiments, prior to initiating capturing the first video media, the computer system detects, via the one or more input devices, a first input of a respective type (e.g., 626) (e.g., an input that can be used for adjusting a media capture formatting setting) (e.g., as described with respect to FIG. 6G). In some embodiments, the input of the respective type includes an input directed to a location of a media format user interface object (e.g., software button) of the media capture user interface, e.g., one or more control objects for selecting a format/codec, resolution, aspect ratio, and/or frame rate for capturing media. In some embodiments, the media format user interface object is displayed while the computer system is not capturing video media using the one or more cameras (e.g., prior to initiating capture, while paused, and after ceasing capture). In some embodiments, while capturing video media (e.g., initially and/or after resuming capturing), the computer system foregoes displaying the media format user interface object. In some embodiments, the media format user interface object is displayed with an “active” appearance (e.g., relatively high in visual prominence) while the computer system is not capturing video media and displayed with an “inactive” appearance (e.g., faded, grayed out, crossed out, or otherwise reduced in visual prominence). In some embodiments, the input of the respective type includes a particular input directed to a hardware button. In some embodiments, in response to detecting the first input of the respective type (e.g., 626), the computer system changes (e.g., adjusting) a media format setting for capturing media (e.g., as described with respect to FIGS. 6G-6H) (e.g., changing a format/codec, resolution, aspect ratio, and/or frame rate for capturing media). In some embodiments, capturing the first video media includes capturing the first video media according to the media format setting(s) selected via the first input. In some embodiments, while pausing capturing the first video media (e.g., while maintaining the ability to resume capturing the first video media), the computer system detects, via the one or more input devices, a second input of the respective type (e.g., 632B) (e.g., another input directed to the location of a media format user interface object and/or a particular hardware button input) (e.g., as described with respect to FIG. 6K). In some embodiments, the second input is detected while the media format user interface object is not displayed and/or displayed with the “inactive” appearance. In some embodiments, in response to detecting the first input of the respective type, the computer system foregoes changing the media format setting for capturing media (e.g., as described with respect to FIGS. 6K-6L). For example, for a particular video capture, the media format setting remains in the same state it was from when the video capture is initiated until the video capture is ceased (e.g., stopped). For example, the format/codec, resolution, aspect ratio, and/or frame rate for the first video media cannot be changed while the capture is paused. In some embodiments, in response to an input of the respective type detected while capturing the first video media, the computer system foregoes changing the media format setting, e.g., the media format setting cannot be changed once capture is initiated, whether while capturing or while paused. Allowing media format settings to be changed prior to initiating video capture and disabling changing media format settings while pausing provides improved control of a video media capture user interface by automatically adapting capture controls based on the current capture state.

In some embodiments, audio is playing (e.g., being output) at the computer system when the first input directed to the first video recording user interface object (e.g., 620A, 620B, 628A, and/or 628B) is detected. In some embodiments, the audio is playing via one or more speakers and/or other audio input devices in communication with the computer system, such as built-in speakers, external speakers, and/or headphones. In some embodiments, capturing first video media using the one or more cameras includes adding at least a portion of the audio that is playing at the computer system to the first video media (e.g., as described with respect to FIGS. 6C-6D) (e.g., to a video media item that includes the first video media captured using the one or more cameras). In some embodiments, the capture of audio while capturing video is independent of pausing and/or resuming video recording. In some embodiments, the computer system continues outputting the audio at the computer system while capturing the first video media using the one or more cameras.

In some embodiments, audio is playing (e.g., being output) at the computer system when the first input directed to the first video recording user interface object (e.g., 620A, 620B, 628A, and/or 628B) is detected. In some embodiments, the audio is playing via one or more speakers and/or other audio input devices in communication with the computer system, such as built-in speakers, external speakers, and/or headphones. In some embodiments, capturing first video media using the one or more cameras includes, in accordance with a determination that a respective setting enabling computer system audio to be recorded as part of video is enabled, adding at least a portion of the audio that is playing at the computer system to the first video media (e.g., to a video media item that includes the first video media captured using the one or more cameras). In some embodiments, the computer system continues outputting the audio at the computer system while capturing the first video media using the one or more cameras. In some embodiments, capturing first video media using the one or more cameras includes, in accordance with a determination that a respective setting enabling computer system audio to be recorded as part of video is disabled, forgoing adding the audio that is playing at the computer system to the first video media. (e.g., pausing the audio, stopping the audio, and/or forgoing recording the audio while playing the audio). In some embodiments, the conditional capture of audio while capturing video is independent of pausing and/or resuming video recording. In some embodiments, the respective setting enabling computer system audio to be recorded as part of video is configured (e.g., enabled or disabled) via a user input, such as a user input, received via the one or more input device, such as an input directed to a settings user interface (e.g., a system settings user interface and/or a camera or audio settings UI). In some embodiments, the respective setting enabling computer system audio to be recorded as part of video is enabled by default, and can be disabled and/or re-enabled via an input directed to a settings user interface.

In some embodiments, audio is playing (e.g., being output) at the computer system when the first input directed to the first video recording user interface object (e.g., 620A, 620B, 628A, and/or 628B) is detected. In some embodiments, capturing first video media using the one or more cameras includes, in accordance with a determination that the audio is a first type of audio (e.g., music, radio, an audio book, or podcast and/or audio that is being output via a communal audio output device such as a device speaker or a wireless or wired external speaker), adding at least a portion of the audio that is playing at the computer system to the first video media (e.g., to a video media item that includes the first video media captured using the one or more cameras). In some embodiments, the computer system continues outputting the audio at the computer system while capturing the first video media using the one or more cameras. In some embodiments, capturing first video media using the one or more cameras includes, in accordance with a determination that the audio is a second type of audio that is different from the first type of audio (e.g., audio from a phone call, video call, or other real-time communication session and/or audio that is being output via personal audio output device such as headphones or earbuds), forgoing adding the audio that is playing at the computer system to the first video media. (e.g., pausing the audio, stopping the audio, and/or forgoing recording the audio while playing the audio). In some embodiments, the conditional capture of audio while capturing video is independent of pausing and/or resuming video recording.

Note that details of the processes described above with respect to method 700 (e.g., FIGS. 7A-7B) are also applicable in an analogous manner to the methods described below. For example, methods 900 and 1100 optionally include one or more of the characteristics of the various methods described above with reference to method 700. For example, the capture controls for stopping and pausing a video recording described with respect to method 700 are integrated into camera user interfaces that also integrate portrait capture controls as described with respect to method 900. For example, the capture controls for stopping and pausing a video recording described with respect to method 700 are used while capturing spatial media of a variable duration (e.g., spatial video media) as described with respect to method 1100. For brevity, these details are not repeated below.

FIGS. 8A-8V illustrate exemplary user interfaces for controlling media capture effects, in accordance with some embodiments. The user interfaces in these figures are used to illustrate the processes described below, including the processes in FIG. 9.

At FIG. 8A, computer system 600 displays camera user interface 608 in the standard photo capture mode (e.g., as described with respect to FIG. 6B) with the photo menu item horizontally centered within camera user interface 608, indicating that camera user interface 608 is in the standard photo capture mode. Camera user interface 608 includes flash control 608A, limited-duration photo control 608B, zoom control 608C, camera selection control 608D, captured media element 608E, and capture mode control 608G, which can be interacted with as described with respect to FIG. 6B. For example, in response to inputs 802A, 802B, and 802C, respectively directed to flash control 608A, limited-duration photo control 608B, and zoom control 608C, computer system 600 would change the flash setting, limited-duration photo mode, and zoom level (e.g., to 1× zoom) as described with respect to inputs 614A, 614B, and 614C in FIG. 6B. For example, in response to input 802D, swiping right-to-left across camera preview 612, and/or input 802F, swiping right-to-left across capture mode control 608G, computer system 600 would change the photo mode to the portrait capture mode (e.g., as described further with respect to FIGS. 8T-8V). For example, in response to input 802E, 802G, and/or 802H directed to camera preview 612, computer system 600 may adjust capture settings, for instance, auto-focusing on or automatically setting an exposure level based on the content selected included in camera preview 612. In response to inputs 802I and 802J, directed to the portions of camera user interface 608 outside of camera preview 612 next to flash control 608A and limited-duration photo control 608B, computer system 600 foregoes performing media capture operations (e.g., as no touch controls are displayed at the location of inputs 802I and 802J).

In response to a capture input such as touch input 804A, directed to capture control 610A, and/or press input 804B, computer system 600 would capture limited-duration photo media including of portion of the field-of-view of the cameras shown in camera preview 612 using the settings indicated in camera user interface 608 in FIG. 8A, for instance, capturing multi-frame photo media at 0.5× zoom, without flash, and without portrait mode effects applied.

At FIG. 8A, computer system 600 does not display portrait mode control 608F, the user interface object for controlling simulated portrait capture effects in the standard photo capture mode, and accordingly, input 802H, directed to the lower left corner of camera preview 612 (e.g., to substantially the same location as input 614F described above) does not result in controlling simulated portrait capture effects. For example, computer system 600 automatically displays portrait mode control 608F when capturing depth information (e.g., using cameras 604A, 604B, 604C, and/or 604D and/or one or more other sensors, such as depth sensors) for use in applying the simulated capture effects (e.g., as described in further detail below). In some embodiments, computer system 600 automatically captures depth information and/or displays portrait mode control 608F when the zoom setting is set to a zoom level in a compatible zoom range (e.g., 1× to 5× zoom, and/or another zoom level range based on the hardware and software capabilities of computer system 600) and/or a particular subject (e.g., a face, person, pet, animal, and/or other particular subject matter) is detected in camera preview 612. In some embodiments, the particular subject must be within a particular distance range (e.g., 2-8 feet from computer system 600) and/or must be a particular size within camera preview 612 (e.g., occupying between 10%, 20%, or 25% and 75%, 80%, or 90% of the field-of-view). Alternatively, in some embodiments, computer system 600 captures depth information and/or displays portrait mode control 608F in response to an input directed to a candidate subject in camera preview 612 (e.g., a subject other than a face, person, and/or pet within the particular distance range of computer system 600).

At FIG. 8A, the zoom setting is set to 0.5× zoom and camera preview 612 does not include a face (e.g., a person pictured in camera preview 612 is facing away from the cameras), so computer system 600 does not display portrait mode control 608F. In some embodiments, at FIG. 8B, in response to detecting a face in camera preview 612 (e.g., the person turning to face the camera), as indicated by subject frame 806, computer system 600 displays portrait mode control 608F (e.g., despite remaining at 0.5× zoom). Alternatively, in some embodiments, in response to input 802G, directed to the person facing away from the cameras in camera preview 612, computer system 600 identifies the person as a subject (e.g., displaying subject frame 806) and displays portrait mode control 608F at FIG. 8B. Accordingly, in some embodiments, computer system 600 provides portrait mode control 608F within the standard photo mode of camera user interface 608, despite the current zoom level (0.5×) not being within the accepted range for portrait capture.

Alternatively, in some embodiments, computer system 600 does not display portrait mode control 608F when the current zoom level is not within the accepted range, as illustrated in FIG. 8C, despite detecting the face of the person as a subject (e.g., as indicated by subject frame 806). At FIG. 8C, computer system 600 detects input 812, a tap input directed to the 1× element in zoom control 608C. In response to input 812 directed to zoom control 608C, computer system 600 performs a zoom to 1× magnification, as illustrated in FIG. 8D. At FIG. 8D, because the zoom level has been adjusted to within the accepted range and the face of the person is detected within camera preview 612, computer system 600 displays portrait mode control 608F.

As illustrated in FIGS. 8B and 8D, portrait mode control 608F is initially displayed with a deselected appearance, for instance, indicating that portrait capture effects are not currently enabled/applied, but are available and/or that camera user interface 608 is configured to capture depth information for media captures. Accordingly, in response to capture inputs such as 810A, 810B, 814A, and/or 814B, computer system 600 captures limited-duration photo media without designating the captured media for display with portrait capture effects.

While displaying portrait mode control 608F in the standard photo capture mode as illustrated in FIGS. 8B and 8D, in response to an input directed to portrait mode control 608F, such as input 808 and/or input 818, at FIGS. 8E-8F, computer system 600 enables simulated portrait capture effects (e.g., configures camera user interface 600 to capture media designated for display with simulated portrait capture effects) within the standard photo capture mode. In some embodiments, in response to input 808 selecting portrait mode control 608F while the zoom level is outside of the accepted zoom range, enabling the simulated portrait capture effects includes performing a zoom to 1× magnification, as illustrated at FIG. 8E.

The simulated portrait capture effects include simulated depth-of-field effects, simulating capture with a particular depth-of-field based on obtained depth information about the physical environment, causing the physical environment to appear less in focus (e.g., blurrier) the farther it is from a selected plane of focus and to appear more in focus (e.g., sharper) the closer it is to the selected plane of focus in the captured media. As illustrated in FIGS. 8E-8F, while simulated portrait capture effects are enabled, computer system 600 displays camera preview 612 with the simulated portrait capture effects applied, providing a preview of how the simulated portrait capture effects will appear in limited-duration photo media captured in response to capture inputs such as input 826A and/or input 826B. At FIGS. 8E-8F, the selected plane of focus includes the detected person indicated by subject frame 806, and the simulated blurring (depicted by crosshatching in FIGS. 8E-8F) is applied to the background region outside of the person in camera preview 612.

In addition to displaying camera preview 612 with the simulated portrait capture effects applied, in response to the input directed to portrait mode control 608F (e.g., 808 and/or 818), computer system 600 updates camera user interface 608 as illustrated in FIGS. 8E-8F. Computer system 600 continues to display portrait mode control 608F at the same location but updates portrait mode control 608F to a selected appearance, for instance, changing the color, opacity, and/or otherwise increasing the visual prominence of portrait mode control 608F compared to its appearance in FIGS. 8B and 8D.

At FIGS. 8E-8F, computer system 600 updates zoom control 608C to a compact appearance, a platter including only one element (e.g., with text indicating the current zoom level) instead of the four elements (e.g., 0.5×, 1×, 2×, and 8×) previously included. Additionally, computer system 600 moves zoom control 608C from the lower center of camera preview 612 to the lower right corner of camera preview 612 (e.g., the side opposite portrait mode control 608F). As illustrated in FIGS. 8E-8F, computer system 600 animates zoom control 608C collapsing into the compact appearance as it moves into the lower right corner of camera preview 612.

Computer system 600 displays additional controls for the simulated portrait capture effects, including lighting effect control 820A and lighting adjustment control 820B, appearing as illustrated in FIGS. 8E-8F. Lighting effect control 820A is displayed in the lower center of camera preview 612, for instance, at the location previously occupied by zoom control 608C. As illustrated in FIG. 8F, lighting effect control 820A indicates the simulated portrait capture effects currently being applied to camera preview 612. For example, at FIG. 8F, lighting effect control 820A includes a first icon and a text banner reading “Natural,” indicating that the simulated depth-of-field effects are being applied without additional simulated lighting effects (e.g., the default simulated portrait capture effect when effects are initially enabled). Lighting adjustment control 820B is displayed next to limited-duration photo control 608B.

In some embodiments, when the simulated portrait capture effects are enabled, computer system 600 conditionally enables dynamic exposure adjustment and/or displays low-light capture control 824 based on the current zoom level and the current environmental lighting conditions (e.g., the lighting conditions detected via cameras 604A, 604B, 604C, 604D, and/or other sensors of computer system 600). For example, if the current zoom level is within a compatible range for long-exposure (e.g., night mode) capture (e.g., 1× to 1.9× zoom), and the detected environmental lighting conditions indicate low light conditions, computer system 600 automatically selects a longer exposure setting of 1 second, indicated by the display of low-light capture control 824 (e.g., with the text “1S”) next to flash control 608A.

As illustrated in FIG. 8F, flash control 608A, limited-duration photo control 608B, camera selection control 608D, captured media element 608E, and capture mode control 608G remain displayed as they were prior to enabling the simulated portrait capture effects in the standard photo capture mode. Accordingly, the result of inputs such as 822A, 822B, 822E, and/or 822G (e.g., directed to substantially the same portions of camera user interface 608 as inputs 802A, 802B, 802E, and 802G, respectively) does not change. However, the results of inputs such as 822D, 822H, 822I, and 822J (e.g., inputs directed to substantially the same locations as 802D, 802H, 808, 818, 802I, and 802J, as illustrated) changes. For example, lighting adjustment control 820B can be selected to adjust the applied simulated lighting effects, for instance, adjusting an intensity of the applied effects (e.g., the degree to which the field-of-view of the cameras is modified when applying the effects). For example, exposure control can be selected to manually control exposure settings for media capture (e.g., disabling the dynamic exposure adjustment and/or manually adjusting the exposure length). In response to an input such as 822H (e.g., directed to substantially the same location as 802H, 808, and/or 818), computer system 600 would disable the simulated portrait capture effects, as further described with respect to FIGS. 8R-8T. In response to an input such as 822D, computer system 600 would expand zoom control 608C, as further described with respect to FIGS. 8R-8Q.

At FIG. 8F, computer system 600 detects input 822C (e.g., an input directed to substantially the same location as 802C) directed to lighting effect control 820A. In response to input 822C, at FIG. 8G, computer system 600 expands lighting effect control 820A. As illustrated at FIG. 8G, when expanded, lighting effect control 820A includes a plurality of icons, each representing different available portrait lighting effects, arranged in a dial (e.g., wheel) user interface element that partially overlays camera preview 612. The first icon, representing the natural (e.g., default) portrait lighting effect currently being applied to camera preview 612, is displayed at the top center of expanded lighting effect control 820A, and the text banner continues to read “natural.” For example, the other icons represent a studio light effect, a contour light effect, a stage light effect, and/or a stage light mono effect.

At FIG. 8G, while displaying the expanded lighting effect control 820A, computer system 600 removes portrait mode control 608F and zoom control 608C, and deemphasizes other portions of camera user interface 608, for instance, fading out flash control 608A, low-light capture control 824, lighting adjustment control 820B, and limited-duration photo control 608B outside of camera preview 612. Accordingly, inputs such as 828A, 828B, 828I, and 828J do not result in changing media capture settings via the faded-out controls, and inputs such as 828C, 828D, 828E, and 828H interact with expanded lighting effect control 820A (as described below) as opposed to portrait mode control 608F and zoom control 608C. For example, in response to inputs 828C and 828H, directed to portions of expanded lighting effect control 820A without icons representing portrait lighting effects, or 828A, 828B, 828I, and 828J, directed to portions of camera user interface 608 outside of lighting effect control 820A, computer system 600 may take no action or may collapse lighting effect control 820A (e.g., back to the appearance it had in FIG. 8F).

At FIG. 8G, while displaying expanded lighting effect control 820A, computer system 600 detects a selection input, such as tap input 828E, directed to an icon representing a simulated stage lighting effect, or swipe input 828D, swiping right to left across expanded lighting effect control 820A to “rotate” the dial to the icon representing the simulated stage lighting effect. In response to the selection input, at FIG. 8H, computer system 600 changes a simulated lighting effect of the simulated portrait capture effects, applying the simulated stage lighting effect to camera preview 612. For example, applying the simulated stage lighting effect includes simulating a background (e.g., a black studio background) behind the detected subject, simulating one or more light sources (e.g., stage-style directional lighting), and/or desaturating camera preview 612 (e.g., to create a black-and-white/grayscale effect).

As illustrated at FIG. 8H, in response to the selection input (e.g., 828E and/or 828D), computer system 600 displays expanded lighting effect control 820A with the icon representing the simulated stage lighting effect displayed at the top center of expanded lighting effect control 820A and the text banner with the label “stage.” In some embodiments, computer system 600 continues displaying lighting effect control 820A in its expanded state for a period of time (e.g., 0.5 s, 1 s, or 2 s) after changing the simulated lighting effect, allowing the user to continue to interact with expanded lighting effect control 820A (e.g., tap and swipe inputs such as 828D and 828E). After the period of time, if no further selection inputs have been received, computer system 600 collapses lighting effect control 820A as illustrated in FIG. 8I. Alternatively, computer system 600 may collapse lighting effect control 820A as illustrated in FIG. 8I in response to the selection input (e.g., automatically collapsing lighting effect control 820A when the lighting effect is changed), in response to an input directed to an inactive region of lighting effect control 820A and/or outside of lighting effect control 820A, and/or in response to a capture input (e.g., 830A and/or 830B).

As illustrated in FIG. 8I, lighting effect control 820A is updated to a compact appearance displayed at the same size and location illustrated in FIG. 8F, but with the icon representing the simulated stage lighting effect and the text banner reading “stage.” Additionally, computer system 600 re-displays portrait mode control 608F and zoom control 608C, and re-emphasizes the de-emphasized portions of camera user interface 608 (e.g., flash control 608A, low-light capture control 824, lighting adjustment control 820B, and limited-duration photo control 608B). Accordingly, at FIG. 8I, inputs such as 832A-832J interact with camera user interface 608 as described with respect to inputs 822A-822J in FIG. 8F. For example, input 832C, directed to lighting effect control 820A, would re-expand lighting effect control 820A, allowing a user to select a different simulated lighting effect, and input 832J, directed to lighting adjustment control 820B, would allow the user to adjust the simulated stage lighting effect (e.g., changing the intensity and/or other characteristics of the simulated effect). In response to capture inputs such as 834A and 834B, computer system 600 would capture limited-duration photo media with the current settings, including a 1× zoom level, and designated for display with the simulated stage lighting effect applied.

At FIG. 8I, computer system 600 detects input 832D directed to the current zoom element of zoom control 608C while zoom control 608C is displayed with the compact appearance in the lower right corner of camera preview 612. For example, input 832D is a tap or short press directed to the current zoom element of zoom control 608C, and/or a short swipe across zoom control 608C. In response to detecting input 832D, at FIG. 8J, computer system 600 updates the appearance of zoom control 608C by expanding the platter to include three elements, corresponding to 1×, 2×, and 5× magnification, without yet performing a zoom to a particular level. As illustrated in FIG. 8J, while zoom control 608C is displayed with the expanded platter, computer system 600 continues to display portrait mode control 608F and lighting effect control 820A, but deemphasizes flash control 608A, low-light capture control 824, lighting adjustment control 820B, and limited-duration photo control 608B outside of camera preview 612 (e.g., deactivating the faded controls, as described with respect to FIG. 8G).

At FIG. 8J, computer system 600 detects input 636 directed to the 2× zoom element of zoom control 608C, and in response, performs a zoom to 2× magnification as illustrated in FIG. 8K. In some embodiments, as described with respect to lighting effect control 820A, zoom control 608C remains expanded, as illustrated in FIG. 8J, for a period of time without further inputs before collapsing to the compact appearance illustrated in FIG. 8K, or zoom control 608C returns to the compact appearance in response to input 636 and/or another input (e.g., an input directed to a location outside of zoom control 608C and/or a capture input).

As illustrated in FIG. 8K, when zoom control 608C is updated to the compact appearance, computer system 600 re-emphasizes flash control 608A, lighting adjustment control 820B, and limited-duration photo control 608B (e.g., activating those controls for interactions via inputs such as 838A, 838J, and 838B). However, because the current zoom level has been changed to a level outside of the compatible range for long-exposure capture, computer system 600 removes low-light capture control 824 (e.g., deactivating the control for interaction via input 838I).

At FIG. 8K, computer system 600 detects a capture input, such as touch input 840A directed to capture control 810A and/or press input 840B. In response to detecting the capture input, computer system 600 performs a photo capture, generating a limited-duration photo (844, illustrated in FIG. 8M) designated for display with the simulated portrait capture effects, including the simulated stage lighting effect, applied. As illustrated in FIG. 8L, the thumbnail of limited-duration photo 844 displayed in captured media element 608E previews the appearance of the captured media with the simulated stage lighting effects.

In response to input 842 directed to captured media element 608E, at FIG. 8M, computer system 600 displays limited-duration photo 844 in media viewing user interface 644. As illustrated in FIG. 8M, limited-duration photo 844 is displayed with the simulated portrait capture effects, including the simulated stage lighting effect (e.g., simulating a black background, stage lighting, and/or grayscale capture) selected via lighting effect control 820A. While viewing limited-duration photo 844 in media viewing user interface 644, computer system 600 displays portrait indicators 846A and 846B. For example, portrait indicator 846A indicates that limited-duration photo 844 was captured with depth information (e.g., depth information used to simulate the depth-of-field and lighting effects), and portrait indicator 846B indicates that limited-duration photo 844 currently has the simulated stage lighting effects applied. In some embodiments, the simulated portrait capture effects are applied differently to limited-duration photo 844 than they were to camera preview 612.

At FIG. 8M, computer system 600 detects an input requesting to edit the simulated portrait capture effects, such as input 848A directed to portrait indicator 846B and/or input 848B directed to edit control 846C. In response to detecting the input requesting to edit the simulated portrait capture effects, at FIG. 8N, computer system 600 displays limited-duration photo 844 in media editing user interface 850, which includes editing control 850A-850. Alternatively, in some embodiments, in response to detecting input 848A directed to portrait indicator 846B, computer system 600 toggles the application of the simulated stage lighting effect off and may display limited-duration photo 844 as described with respect to FIG. 8O without opening media editing user interface 850.

As illustrated in FIG. 8N, media editing user interface 850 includes lighting control 850A, depth control 850B, portrait effect indicator 850C, f-stop control 850D, additional editing controls 850E, save control 850F (e.g., a “done” button for committing edits made to the media and exiting media editing user interface 850), and cancel control 850G (e.g., for cancelling edits made to the media and exiting media editing user interface 850). In response to input 852 directed to lighting control 850A, at FIG. 8O, computer system 600 toggles the application of the simulated stage lighting effect off, displaying limited-duration photo 844 without simulating the black studio background, simulating stage lighting, and/or desaturating the image content to appear grayscale (e.g., while remaining displayed with the simulated depth-of-field portrait effects). In addition to toggling the application of the simulated stage lighting effect on or off, media editing user interface 850 can be used to modify other aspects of the simulated portrait capture effects applied to limited-duration photo 844, for instance, changing the simulated depth-of-field (e.g., via depth control 850B and/or f-stop control 850D) and/or selecting a different simulated lighting effect to apply.

At FIG. 8P, computer system 600 displays camera user interface 608 in the standard photo capture mode with the simulated portrait capture effects enabled, the natural lighting effect selected, and the zoom level set to 1× zoom. At FIG. 8P, computer system 600 detects input 854 directed to zoom control 608C while zoom control 608C is displayed with the compact appearance in the lower right corner of camera preview 612. In response to detecting input 854, at FIG. 8Q, computer system 600 updates the appearance of zoom control 608C by expanding zoom control 608C into a dial user interface element that partially overlays camera preview 612. As described with respect to expanded lighting effect control 820A in FIG. 8G, while displaying the expanded zoom control 608C, computer system 600 removes portrait mode control 608F and lighting effect control 820A, and deemphasizes other portions of camera user interface 608, for instance, fading out flash control 608A, low-light capture control 824, lighting adjustment control 820B, and limited-duration photo control 608B outside of camera preview 612. Accordingly, inputs such as 856A, 856B, 856I, and 856J do not result in changing media capture settings via the faded-out controls, and inputs such as 856C, 856D, 856E, and 856H interact with expanded zoom control 608C (as described below) as opposed to portrait mode control 608F and lighting effect control 820A.

In some embodiments, input 854 is a different type of input than input 832D described with respect to FIG. 8I (e.g., the input expanding zoom control 608C into the expanded, three-element platter). For example, computer system 600 expands zoom control 608C into the larger dial shown in FIG. 8Q in response to long presses of zoom control 608C in the compact appearance, and expands zoom control 608C into the three-element platter in response to short taps or swipes of zoom control 608C in the compact appearance. In some embodiments, computer system 600 expands zoom control 608C into the larger dial in response to long presses of zoom control 608C when zoom control 608C is displayed as the three-element platter.

While displaying expanded zoom control 608C, computer system 600 detects a selection input, such as tap input 856E, directed to a representation of a particular zoom level (e.g., a tick mark) on the zoom dial, or swipe input 856D, swiping right to left across expanded zoom control 608C to “rotate” the zoom dial to the representation of a particular zoom level. In response to the selection input, at FIG. 8R, computer system 600 performs a zoom based on the selection input. As illustrated in FIG. 8R, in response to swipe input 856D (e.g., a swipe starting at the location of an 8× tick mark on the zoom dial and swiping to the center), computer system 600 performs a zoom to 8× magnification. For example, computer system 600 displays the zoom dial rotating to center the 8× tick mark, increasing the magnification of camera preview 612 as the zoom level increases. Accordingly, in some embodiments, computer system 600 provides a greater overall number or overall range of zoom levels when zoom control 608C is fully expanded than when zoom control 608C is expanded into the three-element platter. However, as illustrated in FIG. 8Q, the zoom range is still limited. For example, 0.5× zoom is not represented on the zoom dial, and a zoom to 0.5× magnification cannot be performed while simulated portrait capture effects are enabled in the standard photo capture mode (e.g., whether zoom control 608C is displayed as the zoom dial, three-element platter, or compact element).

As described with respect to the expanded lighting effect control 820A at FIG. 8H, in some embodiments, computer system 600 continues displaying zoom control 608C in its expanded state for a period of time (e.g., 0.5 s, 1 s, or 2 s) after changing the zoom level, allowing the user to continue to adjust the zoom via the zoom dial. In some embodiments, computer system 600 automatically collapses zoom control 608C as illustrated in FIG. 8R if no further inputs are received within the period of time. Alternatively, computer system 600 may collapse zoom control 608C as illustrated in FIG. 8R in response to the selection input (e.g., 856D and/or 856E), in response to an input directed to an inactive region of zoom control 608C (e.g., 856C and/or 856H), in response to an input directed outside of lighting effect control 820A, and/or in response to a capture input.

After performing the zoom to 8× magnification via expanded zoom control 608C, the simulated portrait capture effects remain enabled within the standard photo capture mode of camera user interface 608. As illustrated in FIG. 8R, lighting effect control 820A is re-displayed, lighting adjustment control 820B (e.g., and flash control 608A and limited-duration photo control 608B) is re-emphasized, portrait mode control 608F is re-displayed with its selected appearance, and zoom control 608C returns to its compact appearance. As illustrated in FIG. 6R, in some embodiments, because the current zoom level of 8× zoom is outside of the accepted range for portrait capture (e.g., 1× to 5× zoom), computer system 600 does not apply the simulated portrait capture effects (including the simulated depth-of-field effects and/or any selected simulated lighting effects) to camera preview 612, and in response to a capture input (e.g., 860A and/or 860B), computer system 600 would capture limited-duration photo media that is not designated for display with the simulated portrait capture effects.

At FIG. 8R, computer system 600 detects input 858H directed to portrait mode control 608F. In response to input 858H, at FIGS. 8S-8T, computer system 600 disables the simulated portrait capture effects (e.g., configures camera user interface 600 to capture media without designating it for display simulated portrait capture effects) within the standard photo capture mode. Additionally, computer system 600 updates camera user interface 608, for instance, reverting some of the changes made when the simulated portrait capture effects were enabled in FIGS. 8E-8F. As illustrated in FIGS. 8S-8T, computer system 600 updates zoom control 608C to the expanded platter including four elements and moves zoom control 608C back to the lower center of camera preview 612.

Additionally, computer system removes portrait mode control 608F, lighting effect control 820A, and lighting adjustment control 820B. For example, at FIGS. 8S-8T, computer system 600 removes portrait mode control 608F because the zoom level of 8× magnification is outside of the accepted zoom range for automatically capturing depth information and displaying portrait mode control 608F. In some embodiments, if the simulated portrait capture effects were disabled while the zoom level is within the accepted zoom range, computer system 600 would continue to display portrait mode control 608F at the same location in the lower left corner of camera preview 612, but would update the appearance of portrait mode control 608F to the deselected appearance described with respect to FIGS. 8B and 8D.

At FIG. 8T, computer system 600 detects an input requesting to change from the standard photo capture mode to a portrait photo capture mode, such as input 860A, a tap directed to the “portrait” element in capture mode control 608G and/or input 860B, a swipe from right to left across capture mode control 608G to select the “portrait” element. In response to the input requesting to change to the portrait photo capture mode (e.g., 860A and/or 860B), at FIGS. 8U-8V, computer system 600 updates camera user interface 608 to the portrait photo capture mode.

In particular, when transitioning to the portrait photo capture mode via capture mode control 608G, at FIG. 8U, computer system 600 temporarily obscures camera preview 612 (e.g., blanking out, blurring, and/or pausing the live or near-live camera feed), displays capture mode control 608G sliding right to left (e.g., to center the “portrait” item), and displays zoom control 608C collapsing to a compact appearance (e.g., a platter including only one element) while moving from the lower center of camera preview 612 to the lower left corner of camera preview 612.

At FIG. 8V, computer system 600 displays camera user interface 608 in the portrait photo capture mode. In the portrait photo capture mode, computer system 600 displays camera preview 612 with a live preview of simulated portrait capture effects and, in response to a capture input such as 866A and/or 866B, computer system 600 would capture photo media designated for display with the simulated portrait capture effects.

In contrast to displaying camera user interface 608 in the standard photo capture mode with simulated portrait capture effects enabled (e.g., as illustrated in FIG. 8F), in the portrait photo capture mode, computer system 600 displays depth control 862A in the upper right corner of camera user interface 608 and displays a plurality of lighting effect controls 862B-862D along the lower center and right of camera preview 612. For example, depth control 862A can be selected (e.g., via input 864B) to control the simulated depth-of-field portrait effects (e.g., adjusting a simulated f-stop value), and lighting effect controls 862B-862D can be interacted with (e.g., via tap input 864C and/or swipe input 864D) to select from a respective plurality of simulated lighting effects (e.g., a natural light effect, a studio light effect, a contour light effect, a stage light effect, and/or a stage light mono effect). Additionally, zoom control 608C is displayed with its compact appearance in the lower left of camera preview 612. As illustrated in FIG. 8V, in response to the input requesting to change to the portrait photo capture mode (e.g., 860A and/or 860B), computer system 600 performs a zoom to 2× magnification (e.g., a predetermined portrait capture zoom level) from the 8× zoom level selected in the standard photo capture mode.

FIGS. 9A-9B are a flow diagram illustrating a method for controlling media capture effects using a computer system in accordance with some embodiments. Method 900 is performed at a computer system (e.g., 100, 300, 500, and/or 600) that is in communication with one or more display generation components (e.g., 606) (e.g., one or more display controllers; a touch-sensitive display system; one or more displays (e.g., integrated and/or connected), one or more 3D displays, one or more transparent displays, one or more projectors, and/or a heads-up display), one or more input devices (e.g., 602A, 602B, 602C, and/or 606) (e.g., one or more hardware buttons and/or surfaces, such as mechanical (e.g., physically depressible), solid-state, intensity-sensitive, and/or touch-sensitive (e.g., capacitive) buttons and/or surfaces; one or more audio input devices, such as microphones or vibration sensors; one or more optical input devices, such as cameras and/or depth sensors), and one or more cameras (e.g., 604A, 604B, 604C, and/or 604D) (e.g., one or more rear (e.g., user-facing) cameras and/or one or more forward (e.g., environment-facing) cameras). In some embodiments, the one or more cameras include a plurality of cameras with different lenses/lens types, such as a standard camera, a telephoto camera, and/or a wide-angle camera. In some embodiments, the one or more cameras include a camera array/stereo camera for spatial capture, where at least a first camera and a second camera are located a distance apart, such that the perspective of the first camera is different from the perspective of the second camera and thus at least a portion of a field of view of the first camera is outside of a field of view of the second camera. In some embodiments, the computer system is optionally configured to communicate with one or more sensors, such as camera sensors, optical sensors, depth sensors, capacitive sensors, intensity sensors, motion sensors, vibration sensors, and/or audio sensors. Some operations in method 900 are, optionally, combined, the orders of some operations are, optionally, changed, and some operations are, optionally, omitted.

As described below, method 900 provides an intuitive way of controlling media capture effects. The method reduces the cognitive burden on a user when controlling media capture effects, thereby creating a more efficient human-machine interface. For battery-operated computing devices, enabling a user to control media capture effects faster and more efficiently conserves power and increases the time between battery charges.

The computer system (e.g., 600) displays (902), via the one or more display generation components (e.g., 606), a media capture user interface (e.g., 608) (e.g., a camera user interface). Displaying (902) the media capture user interface includes, in accordance with a determination that a set of one or more portrait criteria is satisfied, displaying (904) (e.g., concurrently) a camera preview (e.g., 612) (e.g., a representation of a field-of-view of an environment of the one or more cameras, a displayed camera feed, and/or a live or near-live viewfinder) and a portrait capture mode user interface object (e.g., 608F) (e.g., an option that, when selected, enables or disables a portrait capture mode of the media capture user interface) (e.g., as described with respect to FIGS. 6B, 8B and/or 8D). Displaying (902) the media capture user interface includes, in accordance with a determination that the set of one or more portrait criteria is not satisfied, displaying (906) the camera preview without displaying the portrait capture mode user interface object (e.g., as described with respect to FIGS. 8A, 8C and/or 8T).

While displaying the media capture user interface and while a portrait capture mode (e.g., of the media capture user interface and/or of the computer system) is not enabled, the computer system detects (908), via the one or more input devices, an input (e.g., 808 and/or 818) directed to (e.g., selecting and/or activating) the portrait capture mode user interface object (e.g., as described with respect to FIGS. 8B and/or 8D). In some embodiments, the portrait capture mode user interface object is displayed conditionally, e.g., based on whether one or more conditions, such as a selected zoom level of 1× or above, a detected subject of a particular type (e.g., a person, animal, or other recognized object), a detected subject within a particular distance range (e.g., between 2-8 feet away, over 3 feet away, and/or under 10 feet away), and/or a detected input selecting a subject in the camera preview, are present. In some embodiments, while displaying the media capture user interface with the portrait capture mode user interface object (e.g., while the set of one or more portrait criteria is satisfied), the computer system captures depth information (e.g., depth information about the environment included in the field-of-view of the one or more cameras). In some embodiments, the portrait capture mode user interface object is initially (e.g., upon the set of one or more portrait criteria being met) displayed with a first, unselected appearance (e.g., an appearance with relatively less visual prominence, for instance, lighter line weights, greater transparency, smaller size, and/or lower contrast with surrounding visual elements, and/or with visual elements indicating an off/disabled state, such as a slash or “x” through an icon), and in response to a selection of the portrait capture mode user interface object, the computer system enables the portrait capture mode and displays the portrait capture mode user interface object with a second, selected appearance (e.g., an appearance with relatively more visual prominence, for instance, bolder line weights, greater opacity, larger size, and/or higher contrast with surrounding visual elements, and/or with visual elements indicating an on/enabled state, such as removing the slash or “x” through the icon).

In response to detecting the input directed to the portrait capture mode user interface object (910), the computer system (e.g., 600) changes an appearance of the media capture user interface (e.g., 608) to indicate that the portrait capture mode has been enabled (e.g., as described with respect to FIGS. 8E-8F) (e.g., of the media capture user interface and/or of the computer system). In some embodiments, enabling the portrait capture mode includes displaying the camera preview with simulated depth-of-field effects. In some embodiments, while the portrait capture mode is enabled, media captured via the media capture user interface is designated for display with the simulated depth-of-field effects applied, e.g., effects simulating capture with a particular focal length (f-stop) by selectively blurring portions of a media capture that would not be in focus (e.g., would be outside of the depth-of-field) when captured using a lens with the particular focal length. In some embodiments, enabling the portrait capture mode includes capturing depth information. In some embodiments, enabling the portrait capture mode in response to an input other than a selection the portrait capture mode user interface object (e.g., via a mode selection user interface object that is not conditionally displayed) includes modifying a first region (e.g., the region outside of the camera preview) of the media capture user interface (e.g., changing the controls displayed in the region and/or changing the appearance of the region) and/or temporarily deemphasizing (e.g., pausing the camera feed, removing, and/or blurring) the camera preview, while enabling the portrait capture mode in response to an input selecting the portrait capture mode user interface object does not include modifying the first region of the media capture user interface and/or deemphasizing the camera preview. In some embodiments, changing the appearance of the media capture user interface includes changing an appearance of the portrait capture mode user interface object, e.g., displaying the portrait capture mode user interface object with increased visual prominence and/or different visual characteristics than when the portrait capture mode user interface object is initially displayed (e.g., when the portrait criteria are satisfied).

In response to detecting the input directed to the portrait capture mode user interface object (910), the computer system (e.g., 600) displays (914), via the one or more display generation components, a portrait filter control object (e.g., 820A) (In some embodiments, a set of one or more portrait filter control objects; e.g., one or more software buttons, menus, sliders, dials, and/or other user interface objects that, when selected, initiate a process for selecting a portrait filter effect to be used when capturing media) that, when selected, initiates a process for selecting, from a set of one or more portrait filters, a portrait filter to be used when capturing media with the portrait capture mode enabled. In some embodiments, the process for selecting a portrait filter includes displaying a plurality of different lighting control objects, for example, a first lighting control object that, when selected, initiates a process for displaying the camera preview with a first type of simulated lighting effect, and a second lighting control object that, when selected, initiates a process for displaying the camera preview with a second type of simulated lighting effect that is different from the first type of simulated lighting effect. In some embodiments, applying simulated lighting effects (e.g., natural light, studio light, contour light, stage light, and/or stage light mono effects) includes simulation of one or more light sources (e.g., directional, ambient, and/or point) at different locations in space and/or at different intensities. In some embodiments, applying simulated lighting effects includes blurring one or more image portions, e.g., to create a bokeh effect. In some embodiments, applying simulated lighting effects includes simulating a background portion of an image, e.g., displaying subjects in the camera preview/captured media with a single-color background or other simulated backdrop. In some embodiments, applying simulated lighting effects includes modifying the hue, saturation, brightness, and/or contrast of the camera data. In some embodiments, the simulated lighting effects are simulated based on depth map information associated with the camera/image data and/or detected facial features.

The computer system detects (916), via the one or more input devices, a sequence of one or more inputs (e.g., 822C, 828D, and/or 828E) including an input directed to the portrait filter control object (e.g., 822C). In some embodiments, the sequence of one or more inputs includes an input directed to a respective portrait filter control object corresponding to the respective portrait filter. In response to detecting the sequence of one or more inputs, the computer system (e.g., 600) selects (918) a respective portrait filter from the set of one or more portrait filters as the portrait filter to be used when capturing media with the portrait capture mode enabled (e.g., as described with respect to FIGS. 8G-8H). In some embodiments, selecting the respective portrait filter to be used when capturing media with the portrait capture mode enabled includes applying the respective portrait filter to a representation of the field-of-view of the one or more cameras included in the camera preview (e.g., displaying a live preview of the portrait filter). In some embodiments, in response to detecting a request to capture media while the portrait capture mode is enabled and the respective portrait filter is selected, the computer system captures respective media, wherein the captured media is designated for display with the respective portrait filter applied. In some embodiments, while capturing the respective media, the computer system applies the respective portrait filter to the representation of the field-of-view of the one or more cameras included in the camera preview (e.g., the live preview of the portrait filter is applied or maintained during the media capture). Automatically displaying controls for simulated lighting effects when a portrait capture mode is enabled via a conditionally-displayed portrait mode control (e.g., a portrait mode control automatically displayed in certain conditions) provides additional control options for media capture without cluttering the user interface with additional displayed controls or requiring further user input. Doing so assists the user with composing media captures and reduces the risk that transient media capture opportunities are missed or captured in an unintended manner by helping the user to provide proper inputs and reduce user mistakes while capturing media, which makes the media capture user interface more efficient (e.g., reducing power usage and/or improving battery life of the system by enabling the user to capture media more quickly and efficiently). For example, automatically displaying the portrait mode control when particular conditions (e.g., favorable conditions or appropriate contexts for capturing media with portrait characteristics) are met alerts users to the availability of the portrait capture mode and assists the user with efficiently enabling the portrait capture mode, and displaying the lighting effect controls when the portrait mode control is used to enable the portrait capture mode assists the user with efficiently using the portrait capture mode.

In some embodiments, the set of one or more portrait criteria includes a subject criterion that is satisfied when a respective subject (e.g., a candidate portrait subject) is detected in a field-of-view of the one or more cameras represented in the camera preview (e.g., as described with respect to FIGS. 8A-8B) (e.g., in the portion of the environment shown in the camera feed/viewfinder of the media capture user interface). For example, the respective subject is a candidate portrait subject, such as subject of a particular type (e.g., a face, a person, and/or a pet) and/or with particular characteristics (e.g., occupying more than a threshold amount of the field-of-view, occupying less than another threshold amount of the field-of-view, and/or falling within a threshold distance range from the one or more cameras). In some embodiments, the respective subject is detected in the field-of-view of the one or more cameras using image processing techniques, e.g., processing the image data captured using the one or more cameras to detect a candidate portrait subject. In some embodiments, the respective subject is detected in the field-of-view of the one or more cameras using one or more depth sensors. Automatically displaying the portrait mode control (e.g., for enabling the portrait capture mode) when a set of conditions, including detecting a particular subject in the camera preview, has been met provides additional control options without cluttering the user interface with additional displayed controls and without requiring further user input. Doing so assists the user with composing media captures and reduces the risk that transient media capture opportunities are missed or captured in an unintended manner by helping the user to provide proper inputs and reduce user mistakes while capturing media, which makes the media capture user interface more efficient (e.g., reducing power usage and/or improving battery life of the system by enabling the user to capture media more quickly and efficiently). For example, automatically displaying the portrait mode control alerts users to the availability of the portrait capture mode and assists the user with efficiently enabling the portrait capture mode when a subject appropriate for a portrait media capture is detected.

In some embodiments, the set of one or more portrait criteria includes a focus criterion that is satisfied when an input directed to the camera preview is detected (e.g., 802G) and the input directed to the camera preview is an input of a respective type (e.g., as described with respect to FIG. 8A). For example, the input directed to the camera preview is an input selecting a focus point and/or subject in the camera preview. In some embodiments, the input of the respective type includes an input directed to a displayed representation of a subject detected within the field-of-view of the one or more cameras, such as a subject detected using image processing techniques and/or depth sensors. In some embodiments, the input of the respective type includes a tap, press, and/or gesture input. In some embodiments, the set of portrait criteria can be satisfied by meeting either the subject criterion or the focus criterion. For example, the portrait capture mode user interface object is displayed when a user selects a subject in the camera preview, even if the subject does not satisfy the subject criterion, and/or the portrait capture mode user interface object is displayed when a subject satisfies the subject criterion, even if the subject is not selected in the camera preview to satisfy the focus criterion. In some embodiments, the set of portrait criteria is satisfied by the input of the respective type directed to the camera preview only if one or more other portrait criteria are also met (e.g., the zoom level must be set within an accepted zoom range in order for the portrait capture mode user interface object to be displayed in response to an input selecting a focus point and/or subject in the camera preview). Automatically displaying the portrait mode control (e.g., for enabling the portrait capture mode) when a set of conditions, including detecting an input selecting a focus subject in the camera preview, has been met provides additional control options without cluttering the user interface with additional displayed controls. Doing so assists the user with composing media captures and reduces the risk that transient media capture opportunities are missed or captured in an unintended manner by helping the user to provide proper inputs and reduce user mistakes while capturing media, which makes the media capture user interface more efficient (e.g., reducing power usage and/or improving battery life of the system by enabling the user to capture media more quickly and efficiently). For example, automatically displaying the portrait mode control when a user taps (e.g., or otherwise selects) a candidate portrait subject in the camera preview alerts users to the availability of the portrait capture mode for the selected subject and assists the user with efficiently enabling the portrait capture mode.

In some embodiments, while the portrait capture mode is enabled (e.g., as described with respect to FIGS. 8F-8L and/or 8P-8T) (e.g., enabled in response to detecting the input directed to the portrait capture mode user interface object), the computer system (e.g., 600) detects, via the one or more input devices, a respective input requesting to capture media (e.g., 826A, 826B, 830A, 830B, 834A, 834B, 840A, and/or 840B). For example, the respective input includes a touch, tap, press, gesture, speech, and/or air gesture input. In some embodiments, the respective input is directed to a location of a media capture user interface object displayed within the media capture user interface (e.g., a software shutter button). In some embodiments, the respective input is directed to a hardware button of the one or more input devices (e.g., a hardware button associated with a media capture operation). In some embodiments, in response to detecting the respective input requesting to capture media, the computer system captures, via the one or more cameras, respective media (e.g., 844) that includes a representation of a field-of-view of the one or more cameras (e.g., as described with respect to FIG. 8K), wherein capturing the respective media includes, in accordance with a determination that the respective portrait filter is selected (e.g., selected to be used when capturing media with the portrait capture mode enabled) when the input requesting to capture media is detected, designating the respective media for display with the respective portrait filter applied based on a respective subject detected in the field-of-view of the one or more cameras (e.g., based on three-dimensional characteristics of the respective subject and/or other portions of the field-of-view). In some embodiments, the respective media is captured and/or stored with depth information for the field-of-view of the one or more cameras, and the respective portrait filter is applied based on the depth information for the respective subject (e.g., the depth information includes a depth map for at least the respective subject). In some embodiments, the computer system (e.g., 600) displays, via the one or more display generation components, the respective media (e.g., 844), including, in accordance with a determination that the respective media is designated for display with the respective portrait filter applied, applying the respective portrait filter to the representation of the field of view of the one or more cameras based on the respective subject detected in the field-of-view of the one or more cameras (e.g., as illustrated in FIGS. 8L-8N) (e.g., displaying the respective media with a modified appearance, where the modified appearance is a result of applying the respective portrait filter). In some embodiments, in accordance with a determination that the respective media is designated for display with another portrait filter of the set of one or more portrait filters applied, the computer system applies the other portrait filter to the representation of the field of view of the one or more cameras based on the respective subject detected in the field-of-view of the one or more cameras. In some embodiments, in accordance with a determination that the respective media is not designated for display with a portrait filter of the set of one or more portrait filters applied, the computer system foregoes applying a portrait filter to the representation of the field of view of the one or more cameras (e.g., the representation of the field of view of the one or more cameras is displayed without modifying the appearance using a portrait filter). In some embodiments, applying the respective portrait filter includes modifying an appearance of a first portion of the representation of the field-of-view of the one or more cameras in a first manner, wherein the first portion of the representation of the field-of-view of the one or more cameras includes a representation of the respective subject (e.g., the portion representing the respective subject's face, head, torso, and/or body), and modifying an appearance of a second portion of the representation of the field-of-view of the one or more cameras, different from the first portion of the representation of the field-of-view of the one or more cameras (e.g., the portion representing the background, subjects other than the respective subject, and/or portions of the respective subject other than the face/head/torso), in a second manner different from the first manner (e.g., as described with respect to FIGS. 8H and/or 8L-8N). In some embodiments, applying the respective portrait filter includes simulating light sources such that at least part of the respective subject is illuminated (e.g., simulating lighting of a subject's face, head, torso, and/or body) in contrast to other portions of the field-of-view. In some embodiments, applying the respective portrait filter includes simulating an optical depth-of-field such that at least part of the respective subject is in focus and other portions of the field-of-view are out of focus. In some embodiments, applying the respective portrait filter includes modifying the appearance of at least part of the respective subject to increase visual prominence and modifying the appearance of other portions of the field-of-view to reduce visual prominence. Applying a portrait filter to a media item based on a detected subject assists the user with creating media items by performing an operation when a set of conditions has been met without requiring further user input, e.g., automatically applying the portrait filter based on the characteristics of the detected subject without requiring user inputs to manually apply the filter effects, which, additionally, reduces power usage and improves battery life of the device by enabling the user to use the device more quickly and efficiently.

In some embodiments, applying the respective portrait filter to the representation of the field of view of the one or more cameras includes modifying an appearance of the representation of the field of view of the one or more cameras to simulate (e.g., model) a first set of lighting conditions (e.g., as described with respect to FIGS. 8H and/or 8L-8N). In some embodiments, displaying the respective media includes, in accordance with a determination that the respective media is designated for display with a second respective portrait filter applied, wherein the second respective portrait filter is different from the respective portrait filter (e.g., the respective media was captured with the second respective portrait filter selected and/or the second respective portrait filter was selected for the respective media after capturing), applying the second respective portrait filter to the representation of the field of view of the one or more cameras based on the respective subject detected in the field-of-view of the one or more cameras, wherein applying the second respective portrait filter to the representation of the field of view of the one or more cameras includes modifying the appearance of the representation of the field of view of the one or more cameras to simulate a second set of lighting conditions different from the first set of lighting conditions (e.g., as illustrated in FIG. 8O). In some embodiments, different portrait filters include simulating different numbers of light sources, simulating light sources at different positions with respect to the respective subject, different types of light sources (e.g., soft, hard, warm, cold, colorful, bright, and/or dim), different types of photo sensors (e.g., different film, lens, and/or camera types), and/or different studio conditions (e.g., backdrops). For example, a studio portrait filter includes modelling of multiple discrete point-of-light sources (e.g., lights within a photography studio) positioned uniformly around the respective subject (e.g. creates a bright fill lighting effect). A contour portrait filter includes modelling of multiple discrete point-of-light sources positioned along a circumference of a subject. A stage light portrait effect includes modelling of a single discrete point-light-source positioned above the subject (e.g., creates a spotlight effect). The stage light mono portrait effect includes modelling in black and white of a single discrete point light source positioned above the subject (e.g., creates a spotlight effect in a black and white). In some embodiments, applying the second respective portrait filter includes modifying the appearance of the first portion of the representation of the field of view of the one or more cameras in a third manner and modifying the appearance of the second portion of the representation of the field of view of the one or more cameras in a fourth manner, wherein at least one of the third and fourth manner is different from at least one of the first and second manner. Applying different lighting effects to a detected subject in a media item based on the selected portrait filter effect for the media assists the user with creating media items by performing an operation when a set of conditions has been met without requiring further user input, e.g., automatically simulating the appearance of different lighting conditions based on the characteristics of the detected subject without requiring user inputs to manually apply the lighting effects, which, additionally, reduces power usage and improves battery life of the device by enabling the user to use the device more quickly and efficiently.

In some embodiments, applying the respective portrait filter to the first portion of the representation of the field-of-view of the one or more cameras in the first manner includes modifying an appearance of the representation of the field of view of the one or more cameras based on depth information associated with the representation of the respective subject (e.g., as described with respect to FIGS. 8H and/or 8L-8N) (e.g., a depth map of the respective subject). In some embodiments, the depth information associated with the representation of the respective subject includes depth information detected when capturing the respective media, e.g., using one or more depth sensors and/or the one or more cameras. In some embodiments, the depth information associated with the representation of the respective subject includes depth information determined based on the representation of the respective subject, e.g., depth information inferred from captured image data using image processing techniques. For example, the depth information is used to model simulated light hitting the respective subject in a realistic way, e.g., such that the three-dimensional features of the respective subject appear to reflect, absorb, and/or block the simulated light in a realistic manner. Applying a portrait filter to a media item based on depth information for a detected subject assists the user with creating media items by performing an operation when a set of conditions has been met without requiring further user input, e.g., automatically applying the portrait filter to the detected subject in a realistic manner without requiring user inputs to manually apply the filter effects, which, additionally, reduces power usage and improves battery life of the device by enabling the user to use the device more quickly and efficiently.

In some embodiments, while the portrait capture mode is not enabled (e.g., as described with respect to FIGS. 8A-8D), the computer system detects, via the one or more input devices, a second respective input requesting to capture media (e.g., 814A, 814B, 826A, and/or 826B). For example, the second respective input includes a touch, tap, press, gesture, speech, and/or air gesture input. In some embodiments, the second respective input is directed to a location of a media capture user interface object displayed within the media capture user interface (e.g., a software shutter button). In some embodiments, the second respective input is directed to a hardware button of the one or more input devices (e.g., a hardware button associated with a media capture operation). In some embodiments, the second respective input is an input of the same type as the respective input. In some embodiments, in response to detecting the second respective input requesting to capture media (e.g., 814A, 814B, 826A, and/or 826B), the computer system captures, via the one or more cameras, second respective media that includes a second representation of a field-of-view of the one or more cameras, wherein capturing the second respective media includes foregoing designating the second respective media for display with a portrait filter of the set of one or more portrait filters applied (e.g., as described with respect to FIGS. 8B and/or 8D). Foregoing designating the second respective media for display with the portrait filter of the set of one or more portrait filters applied provides the user with visual feedback that the portrait capture mode is not enabled, thereby providing improved visual feedback.

In some embodiments, in response to detecting the sequence of one or more inputs (e.g., 822C, 828D, and/or 828E), the computer system applies the respective portrait filter to the camera preview (e.g., 612) (e.g., displaying the camera preview with a live preview of the portrait filter effects), wherein applying the respective portrait filter to the camera preview includes modifying an appearance of a representation of a field-of-view of the one or more cameras displayed in the camera preview in a respective manner (e.g., as described with respect to FIGS. 8F-8L and/or 8P-8Q). In some embodiments, modifying the appearance in the respective manner includes modifying a portion of the camera preview that includes a detected subject in one manner and modifying a different portion of the camera preview in a different manner. In some embodiments, the computer system applies modifies the appearance of captured media in a different manner than the respective manner (e.g., the respective portrait filter effects appear differently in the camera preview than in captured media). Applying a portrait filter to a live camera preview provides users with improved visual feedback about a state of the computer system without cluttering the display, which assists the user with control of the computer system via the media capture user interface. Doing so assists the user with composing media captures and reduces the risk that transient media capture opportunities are missed or captured in an unintended manner by helping the user to provide proper inputs and reduce user mistakes while capturing media, which makes the media capture user interface more efficient (e.g., reducing power usage and/or improving battery life of the system by enabling the user to capture media more quickly and efficiently).

In some embodiments, while displaying the media capture user interface and while a portrait capture mode is not enabled (e.g., as described with respect to FIGS. 8A-8D and/or 8T), the computer system (e.g., 600) displays, via the one or more display generation components, a respective zoom control object (e.g., 608C) (e.g., a software button, set of buttons, menu, slider, dial, and/or other user interface object that, when selected, initiates a process for selecting a zoom level to be used when capturing media) at a first location within the media capture user interface (e.g., as illustrated in FIGS. 8A-8D and/or 8T). In some embodiments, in response to detecting the input (e.g., 808 and/or 818) directed to the portrait capture mode user interface object (e.g., 608F) (e.g., the input enabling the portrait capture mode), the computer system ceases displaying the respective zoom control object (e.g., 608C) at the first location within the media capture user interface, wherein displaying the portrait filter control object (e.g., 820A) includes displaying (e.g., at least partially) the portrait filter control object at the first location within the media capture user interface (e.g., as illustrated in FIGS. 8F, 8I-8L, 8P, and/or 8R) (e.g., the set of one or more portrait filter control objects replaces the zoom control object). In some embodiments, ceasing displaying the zoom control object at the first location includes moving the zoom control object to a different location within the media capture user interface (e.g., animating movement of the zoom control object to a new location and/or redisplaying the zoom control object at the new location). Displaying the portrait filter control at the location occupied by a zoom control when the portrait capture mode is not enabled provides additional control options for media capture and provides user with improved visual feedback about a state of the computer system without cluttering the user interface with additional displayed controls. For example, replacing the zoom control with the portrait filter control intuitively indicates to the user that the portrait capture mode is enabled and draws the user's attention to the portrait mode-specific control object.

In some embodiments, while displaying the portrait filter control object (e.g., 820A) (e.g., while the portrait capture mode is enabled), the computer system displays, via the one or more display generation components, a respective zoom control object (e.g., 608C) (e.g., one or more software buttons, menus, sliders, dials, and/or other user interface objects). For example, the respective zoom control object is a user interface object that, when selected, initiates a process for selecting a zoom level to be used when capturing media. For example, while the portrait capture mode is enabled, the portrait filter control object and the zoom control object are displayed concurrently. In some embodiments, while displaying the respective zoom control object, the computer system detects, via the one or more input devices, a respective input (e.g., 802C, 812, 822D, 832D, 836, 854, 856D, and/or 856E) directed to the respective zoom control object. In some embodiments, in response to detecting the respective input directed to the respective zoom control object, the computer system initiates a process for selecting a zoom level (e.g., as described with respect to FIGS. 8A-8D, 8I-8K, and/or 8P-8R). In some embodiments, the process for selecting the zoom level includes displaying an expanded zoom control object (e.g., an expanded platter with a plurality of selectable elements corresponding to different zoom levels, a slider, and/or a dial), receiving one or more additional inputs directed to the expanded zoom control object, and selecting (e.g., changing) the zoom level based on the one or more additional inputs. In some embodiments, the process for selecting the zoom level includes performing an optical zoom (e.g., switching between different fixed focal-length lenses of different magnifications and/or varying the focal length of a hardware zoom lens) and/or performing a digital zoom (e.g., digitally magnifying camera by resizing, interpolating, and/or combining data captured at one or more optical zoom levels). In some embodiments, the process for selecting the zoom level includes displaying the camera preview with the currently-selected zoom level (e.g., providing a live preview of the zoom operation). Displaying a portrait filter control and a zoom control concurrently when the portrait capture mode is enabled provides additional control options for media capture without cluttering the user interface with additional displayed controls. Doing so assists the user with composing media captures and reduces the risk that transient media capture opportunities are missed or captured in an unintended manner by helping the user to provide proper inputs and reduce user mistakes while capturing media, which makes the media capture user interface more efficient (e.g., reducing power usage and/or improving battery life of the system by enabling the user to capture media more quickly and efficiently). For example, in the portrait capture mode, the user can both adjust the portrait filter settings (e.g., select a filter to be used when capturing media) and adjust the zoom level to compose media captures.

In some embodiments, in response to detecting the input directed to the portrait capture mode user interface object (e.g., 808 and/or 818) (e.g., the input enabling the portrait capture mode), the computer system changes a location of the respective zoom control object (e.g., 608C) from an initial location within the media capture user interface to a respective location within the media capture user interface that was not occupied by the zoom control object when the input directed to the portrait capture mode user interface object was detected (e.g., as described with respect to FIGS. 6E-6F) (e.g., displaying the zoom control object at a different location within the media capture user interface than the concurrently-displayed portrait filter control object). In some embodiments, the portrait filter control object is displayed (e.g., at least partially) at the initial location within the media capture user interface. Changing the location of a zoom control in response to enabling the portrait capture mode provides additional control options for media capture and provides user with improved visual feedback about a state of the computer system without cluttering the user interface with additional displayed controls. For example, shifting the location of zoom control intuitively indicates to the user that the portrait capture mode is enabled and reduces the likelihood of unintended inputs (e.g., inadvertently changing the zoom level instead of initiating the process for selecting and applying lighting filter effects).

In some embodiments, changing the location of the respective zoom control object (e.g., 608C) from the initial location within the media capture user interface to the respective location within the media capture user interface includes displaying, via the one or more display generation components, an animation of the respective zoom control object moving from the initial location to the respective location (e.g., as described with respect to FIGS. 6E-6F). For example, the animation shows the respective zoom control shifting to a new location. In some embodiments, the animation includes changing one or more visual characteristics (e.g., in addition to the location) of the respective zoom control object, e.g., animating the zoom object changing shape, size, color, opacity, and/or contents. Displaying an animation of the zoom control shifting location in response to enabling the portrait capture mode provides additional control options for media capture and provides user with improved visual feedback about a state of the computer system without cluttering the user interface with additional displayed controls. For example, shifting the location of zoom control intuitively indicates to the user that the portrait capture mode is enabled and reduces the likelihood of unintended inputs (e.g., inadvertently changing the zoom level instead of initiating the process for selecting and applying lighting filter effects).

In some embodiments, while displaying the media capture user interface and while the portrait capture mode is enabled (e.g., as described with respect to FIGS. 8F-8L and/or 8P-8R), the computer system detects, via the one or more input devices, a second input (e.g., 822H, 832H, and/or 858) directed to (e.g., selecting and/or activating) the portrait capture mode user interface object (e.g., 608F). In some embodiments, in response to detecting the second input directed to the portrait capture mode user interface object, the computer system changes the appearance of the media capture user interface (e.g., 608) to indicate that the portrait capture mode has been disabled (e.g., as described with respect to FIGS. 8S-8T). In some embodiments, reversing the changes made to the appearance of the media capture user interface when the portrait capture mode was enabled. In some embodiments, the computer system disables the portrait capture mode. In some embodiments, in response to detecting the second input directed to the portrait capture mode user interface object and in accordance with a determination that the set of one or more portrait criteria is not satisfied, changing the appearance of the media capture user interface includes ceasing displaying the portrait capture mode user interface object. In some embodiments, in response to detecting the second input directed to the portrait capture mode user interface object and in accordance with a determination that the set of one or more portrait criteria is satisfied, changing the appearance of the media capture user interface includes changing the appearance of the portrait capture mode user interface object (e.g., back to its original appearance). In some embodiments, in response to detecting the second input directed to the portrait capture mode user interface object, the computer system changes the location of the respective zoom control object (e.g., 608C) from the respective location within the media capture user interface to the initial location within the media capture user interface (e.g., as described with respect to FIGS. 8S-8T). In some embodiments, changing the location of the respective zoom control object includes displaying an animation of the respective zoom control shifting back (e.g., reversing the changes made when entering the portrait capture mode). In some embodiments, in response to detecting the second input directed to the portrait capture mode user interface object, the computer system ceases displaying the portrait filter control object (e.g., the zoom affordance replaces the portrait filter control object at its original location). Reversing the change to the location of a zoom control in response to disabling the portrait capture mode provides a user with improved visual feedback about a state of the computer system without cluttering the user interface with additional displayed controls. For example, shifting the location of zoom control intuitively indicates to the user that the portrait capture mode is disabled.

In some embodiments, while displaying the media capture user interface and while a portrait capture mode is not enabled (e.g., as described with respect to FIGS. 8A-8D and/or 8T), the computer system (e.g., 600) displays, via the one or more display generation components, a respective zoom control object (e.g., 608C) including a first set of one or more zoom control objects corresponding to a plurality of zoom levels (e.g., as illustrated in FIGS. 8A-8D and/or 8T). In some embodiments, the respective zoom control object is a user interface object for adjusting a zoom setting for media capture. In some embodiments, modifying a zoom level media capture setting includes performing an optical zoom (e.g., switching between different fixed focal-length lenses of different magnifications and/or varying the focal length of a hardware zoom lens) and/or performing a digital zoom (e.g., digitally magnifying camera by resizing, interpolating, and/or combining data captured at one or more optical zoom levels). In some embodiments, changing the zoom setting includes updating display of a media capture preview (e.g., a camera viewfinder) according to the current zoom level, allowing the user to preview capture at the current zoom level. In some embodiments, the first set of one or more zoom control objects include one or more software buttons, menus, sliders, dials, and/or other user interface objects. For example, while the portrait capture mode is not enabled, the computer system displays a zoom control platter including zoom buttons each corresponding to one of the plurality of zoom levels (e.g., 0.5× zoom, 1× zoom, 2× zoom, and 8× zoom buttons). For example, while the portrait capture mode is not enabled, the computer system displays a zoom dial or slider (e.g., a movable user interface object) with a range of motion corresponding to the range of zoom levels in the plurality of zoom levels (e.g., a dial for selecting zoom levels between 0.5× and 12× zoom in increments of 0.1×). In some embodiments, in response to detecting the input directed to the portrait capture mode user interface object (e.g., 808 and/or 818) (e.g., the input enabling the portrait capture mode), the computer system (e.g., 600) displays, via the one or more display generation components, the respective zoom object including a second set of one or more zoom control objects corresponding to a set of one or more zoom levels, wherein the set of one or more zoom levels includes fewer zoom levels than the plurality of zoom levels (e.g., as described with respect to FIGS. 8F, 8I-8L, and/or 8P-8R) (e.g., the computer system displays fewer zoom level options when the portrait capture mode is enabled). In some embodiments, the first set of one or more zoom control objects include one or more software buttons, menus, sliders, dials, and/or other user interface objects. For example, while the portrait capture mode is enabled, the computer system displays the zoom control platter with only a single button (e.g., a 1× and/or current zoom button) or with a smaller plurality of zoom levels (e.g., 1× zoom, 2× zoom, and 5× zoom buttons). In some embodiments, the set of one or more zoom levels represents a smaller range of zoom levels than the plurality of zoom levels (e.g., the least-magnified zoom level provided in the portrait mode is more magnified than the least-magnified zoom level outside of the portrait mode and/or the most-magnified zoom level provided in the portrait mode is less magnified than the most-magnified zoom level outside of the portrait mode). For example, while the portrait capture mode is enabled, the computer system displays a zoom dial or slider (e.g., a movable user interface object) with a range of motion corresponding to a smaller range of zoom levels than in the plurality of zoom levels (e.g., a dial for selecting zoom levels between 1× and 8× zoom in increments of 0.1×). Reducing the amount of zoom controls provided when the portrait capture mode is enabled provides additional control options without cluttering the user interface with additional displayed controls. Doing so assists the user with composing media captures and reduces the risk that transient media capture opportunities are missed or captured in an unintended manner by helping the user to provide proper inputs and reduce user mistakes while capturing media, which makes the media capture user interface more efficient (e.g., reducing power usage and/or improving battery life of the system by enabling the user to capture media more quickly and efficiently). For example, reducing the zoom control options in the portrait mode reduces the risk of inadvertently changing the zoom level and/or changing the zoom level to a level that reduces the quality of capture in the portrait capture mode (e.g., a zoom level that is too high or low for simulated depth and/or lighting effects to be applied effectively and/or a zoom level that uses a lens of the one or more cameras that is incompatible with portrait captures) while still providing the user with the ability to adjust magnification for capture.

In some embodiments, both the first set of one or more zoom control objects corresponding to the plurality of zoom levels and the second set of one or more zoom control objects corresponding to the set of one or more zoom levels include a first zoom control object (e.g., the 1× and/or current zoom level element of 608C). For example, the set of zoom controls has at least one persistent control that remains displayed when portrait mode is enabled and disabled. For example, the first zoom control object may be a 1× zoom button and/or a current zoom level button (e.g., a zoom button indicating the current zoom level). In some embodiments, while displaying the respective zoom object, the computer system detects, via the one or more input devices, an input (e.g., 802C, 812, 822D, 832D, and/or 854) directed to the first zoom control object. In some embodiments, the input includes a touch, tap, press, gesture, and/or air gesture directed to the first zoom control object in the media capture user interface and/or directed to/detected by a hardware button associated with the zoom setting (e.g., tapping one or more times to select, toggle, and/or cycle between zoom levels). In some embodiments, the input includes a movement component, such as a swipe, drag, and/or flick gesture, for instance, detected via a touch-sensitive display of the one or more display generation components and/or the hardware button associated with the zoom setting (e.g., swiping across a user interface element or the surface of the hardware button to increase and/or decrease the zoom level, e.g., based on a direction of the movement input). In some embodiments, in response to detecting the input directed to the first zoom control object and in accordance with a determination that a first set of one or more criteria is satisfied, the computer system initiates a first process for selecting a zoom level to be used when capturing media (e.g., as described with respect to FIGS. 8C-8D), wherein the first set of one or more criteria includes a criterion that is satisfied when the input directed to the first zoom control object is detected while the portrait capture mode is not enabled. In some embodiments, the first process includes selecting a first zoom level (e.g., a zoom level corresponding to the first zoom button) as the zoom level to be used when capturing media. For example, the computer system sets the zoom level to 1× zoom in response to detecting the input. In some embodiments, selecting the first zoom level includes displaying the camera preview at the first zoom level (e.g., zooming the representation of the field of view of the one or more cameras in or out to 1× magnification). In some embodiments, the first set of criteria includes a criterion that is satisfied when the selected zoom level (e.g., for use when capturing media) is not already at the first zoom level when the input is detected. In some embodiments, the first set of criteria includes a criterion that is satisfied when the input is a particular type of input (e.g., a tap or other input of limited duration, e.g., as opposed to a held input). In some embodiments, in response to detecting the input directed to the first zoom control object and in accordance with a determination that a second set of one or more criteria, different from the first set of one or more criteria, is satisfied, the computer system (e.g., 600) initiates a second process, different from the first process, for selecting the zoom level to be used when capturing media (e.g., as described with respect to FIGS. 8I-8K and/or 8P-8R), wherein the second set of one or more criteria includes a criterion that is satisfied when the input directed to the first zoom control object is detected while the portrait capture mode is enabled. In some embodiments, the second process includes displaying an expanded zoom control, wherein the expanded zoom control includes a third set of zoom control objects corresponding to a second plurality of zoom levels that includes more zoom levels than the set of one or more zoom levels (and, in some embodiments, fewer zoom levels than the plurality of zoom levels available outside of the portrait capture mode). Automatically changing the zoom function provided by a particular zoom control improves the capture of media using the media capture user interface by performing an operation when a set of conditions has been met without requiring further user input. Doing so assists the user with composing media captures and reduces the risk that transient media capture opportunities are missed or captured in an unintended manner by helping the user to provide proper inputs and reduce user mistakes while capturing media, which makes the media capture user interface more efficient (e.g., reducing power usage and/or improving battery life of the system by enabling the user to capture media more quickly and efficiently). For example, reducing the zoom control options in the portrait mode reduces the risk of inadvertently changing the zoom level and/or changing the zoom level to a level that reduces the quality of capture in the portrait capture mode while still providing the user with the ability to adjust magnification for capture.

In some embodiments, the first set of one or more zoom control objects corresponding to the plurality of zoom levels includes a second zoom control object corresponding to a respective zoom level of the plurality of zoom levels (e.g., the 0.5× and/or 8× elements of 608C illustrated in FIGS. 8A-8D and/or 8T). In some embodiments, the second zoom control object corresponds to a lower (e.g., less zoomed-in) zoom level of the one or more cameras. In some embodiments, the second zoom control object corresponds to a higher (e.g., more zoomed-in) zoom level of the one or more cameras. For example, when the portrait capture mode is not enabled, the zoom control includes 0.5× and 8× zoom buttons. In some embodiments, the second set of one or more zoom control objects corresponding to the set of one or more zoom levels does not include a zoom control object corresponding to the respective zoom level of the plurality of zoom levels (e.g., as illustrated in FIGS. 8F, 8I-8L, and/or 8P-8R) (e.g., the computer system ceases displaying the second zoom control object when the portrait capture mode is enabled). In some embodiments, the expanded zoom control for the portrait mode includes a zoom object corresponding to the respective zoom level (e.g., the user can zoom to the respective zoom level in the portrait capture mode using the expanded control, but an option for the respective zoom level is not initially provided). In some embodiments, if the expanded zoom control for the portrait mode includes the zoom object corresponding to the respective zoom level, when the computer system performs a zoom to the respective zoom level, the computer system ceases applying portrait filters while at the respective zoom level. In some embodiments, the expanded zoom control for the portrait mode does not include a zoom object corresponding to the respective zoom level (e.g., the user cannot zoom to the respective zoom level in the portrait capture mode, even using the expanded control). For example, when the portrait capture mode is enabled, the zoom control does not include 0.5× and 8× zoom buttons. Removing a zoom control for a particular zoom level when the portrait capture mode is enabled improves the capture of media using the media capture user interface by performing an operation when a set of conditions has been met without cluttering the user interface with additional displayed controls. Doing so assists the user with composing media captures and reduces the risk that transient media capture opportunities are missed or captured in an unintended manner by helping the user to provide proper inputs and reduce user mistakes while capturing media, which makes the media capture user interface more efficient (e.g., reducing power usage and/or improving battery life of the system by enabling the user to capture media more quickly and efficiently). For example, removing the option for a particular zoom level (e.g., a zoom level that may reduce capture quality in portrait mode captures) in the portrait mode reduces the risk of inadvertently changing the zoom level to a level that reduces the quality of capture in the portrait capture mode.

In some embodiments, while displaying the respective zoom control object (e.g., 608C), the computer system (e.g., 600) detects, via the one or more input devices, one or more inputs directed to the respective zoom control object (e.g., 802C, 812, 822D, 832D, 836, 854, 856D, and/or 856E). In some embodiments, the input includes a touch, tap, press, gesture, and/or air gesture directed to the first zoom control object in the media capture user interface and/or directed to/detected by a hardware button associated with the zoom setting (e.g., tapping one or more times to select, toggle, and/or cycle between zoom levels). In some embodiments, the input includes a movement component, such as a swipe, drag, and/or flick gesture, for instance, detected via a touch-sensitive display of the one or more display generation components and/or the hardware button associated with the zoom setting (e.g., swiping across a user interface element or the surface of the hardware button to increase and/or decrease the zoom level, e.g., based on a direction of the movement input). In some embodiments, in response to detecting the one or more inputs directed to the respective zoom control object and in accordance with a determination that a third set of one or more criteria is satisfied, the computer system initiates a third process for selecting a zoom level from a first zoom range (e.g., selecting a zoom level from a particular set of zoom levels spanning the first zoom range) to be used when capturing media (e.g., as described with respect to FIGS. 8C-8D), wherein the third set of one or more criteria includes a criterion that is satisfied when the input directed to the respective zoom control object is detected while the portrait capture mode is not enabled. For example, when the portrait capture mode is not enabled, the zoom control object can be used to select a zoom level from a wide range of available zoom levels, e.g., a set of zoom levels including 0.5×, 1×, 2×, 5×, and 8× and/or a set of zoom levels ranging from 0.5× to 12× in 0.1× intervals. In some embodiments, in response to detecting the one or more inputs directed to the respective zoom control object and in accordance with a determination that a fourth set of one or more criteria, different from the third set of one or more criteria, is satisfied, the computer system (e.g., 600) initiates a fourth process, different from the third process, for selecting the zoom level from a second zoom range to be used when capturing media (e.g., as described with respect to FIGS. 8I-8K and/or 8P-8R). In some embodiments, the second set of one or more criteria includes a criterion that is satisfied when the input directed to the respective zoom control object is detected while the portrait capture mode is enabled, and the second zoom range is narrower than the first zoom range (e.g., as described with respect to FIGS. 8I-8K and/or 8P-8R) (e.g., the least-magnified zoom level available in the portrait mode is more magnified than the least-magnified zoom level available outside of the portrait mode and/or the most-magnified zoom level available in the portrait mode is less magnified than the most-magnified zoom level available outside of the portrait mode). In some embodiments, in accordance with the determination that the fourth set of one or more criteria is satisfied, the computer system foregoes performing the third process, e.g., a zoom level from the wider range of zoom levels cannot be selected in the portrait mode. For example, when the portrait capture mode is enabled, the zoom control object can only be used to select a zoom level from a narrowed range of available zoom levels, e.g., a set of zoom levels including 1×, 2×, and 5×, and/or a set of zoom levels ranging from 1× to 8× in 0.1× intervals. In some embodiments, the third and/or fourth processes for selecting the zoom level include displaying an expanded zoom control object (e.g., an expanded platter with a plurality of selectable elements corresponding to different zoom levels, a slider, and/or a dial) corresponding to the respective zoom range (e.g., the first and second zoom range, respectively), receiving one or more additional inputs directed to the expanded zoom control object, and selecting (e.g., changing) the zoom level from the respective zoom range based on the one or more additional inputs. In some embodiments, the third and/or fourth processes for selecting the zoom level include performing an optical zoom (e.g., switching between different fixed focal-length lenses of different magnifications and/or varying the focal length of a hardware zoom lens) and/or performing a digital zoom (e.g., digitally magnifying camera by resizing, interpolating, and/or combining data captured at one or more optical zoom levels) based on the one or more inputs. In some embodiments, the third and/or fourth processes for selecting the zoom level include displaying the camera preview with the currently-selected zoom level (e.g., providing a live preview of the zoom operation). Reducing the range of zoom controls provided when the portrait capture mode is enabled provides additional control options without cluttering the user interface with additional displayed controls. Doing so assists the user with composing media captures and reduces the risk that transient media capture opportunities are missed or captured in an unintended manner by helping the user to provide proper inputs and reduce user mistakes while capturing media, which makes the media capture user interface more efficient (e.g., reducing power usage and/or improving battery life of the system by enabling the user to capture media more quickly and efficiently). For example, reducing the range of zoom levels in the portrait mode reduces the risk of inadvertently changing the zoom level to a level that reduces the quality of capture in the portrait capture mode.

In some embodiments, a lowest zoom level of the first zoom range (e.g., 0.5×, as described with respect to FIGS. 8A-8D) (e.g., the least magnified zoom level available outside of portrait mode) is lower than a lowest zoom level of the second zoom range (e.g., 1×, as described with respect to FIGS. 8F-8L and/or 8P-8R) (e.g., the least magnified zoom level available in portrait mode). For example, in the portrait capture mode, the zoom level cannot be adjusted as low as 0.5×, e.g., media capture cannot be performed using a wide-angle lens of the one or more cameras. Limiting the zoom range (such as by excluding the lowest zoom level otherwise available) while the portrait capture mode is enabled allows the computer system to have sufficiently overlapping fields-of-view for the plurality of cameras, thereby allowing for sufficient capturing of depth information, thereby improving the man-machine interface and not allowing zoom levels that would otherwise prevent the computer system from operating in the portrait capture mode.

In some embodiments, while displaying the media capture user interface including the portrait filter control object (e.g., 820A) (e.g., while the portrait capture mode is enabled), the computer system detects, via the one or more input devices, an input directed to the portrait filter control object (e.g., 822C). In some embodiments, the input includes a touch, tap, press, gesture, and/or air gesture directed to the portrait filter control object in the media capture user interface and/or directed to/detected by a hardware button associated with the portrait filter setting (e.g., tapping or pressing the portrait filter control object). In some embodiments, the input includes a movement component, such as a swipe, drag, and/or flick gesture, for instance, detected via a touch-sensitive display of the one or more display generation components and/or the hardware button associated with the portrait filter setting (e.g., swiping across the portrait filter control object). In some embodiments, in response to detecting the input directed to the portrait filter control object, the computer system initiates the process for selecting, from the set of one or more portrait filters, a portrait filter to be used when capturing media with the portrait mode enabled. In some embodiments, initiating the process for selecting a portrait filter to be used when capturing media with the portrait mode enabled includes displaying, via the one or more display generation components, an expanded portrait filter control object (e.g., as described with respect to FIGS. 8G-8H). In some embodiments, the expanded portrait filter control object includes a set of portrait filter control objects each corresponding to a portrait filter from the set of one or more portrait filters, including a respective portrait filter control object corresponding to the respective portrait filter (e.g., wherein the sequence of one or more inputs includes an input directed to the respective portrait filter control object within the expanded filter control object). For example, the expanded portrait filter control object includes a static or scrollable platter, menu, and/or dial including individual portrait filter software buttons. In some embodiments, initiating the process for selecting a portrait filter to be used when capturing media with the portrait mode enabled includes ceasing displaying one or more user interface objects (e.g., 608A, 608B, 608C, 608F, 820B, and/or 824) of the media capture user interface (e.g., as described with respect to FIGS. 8G-8H) (e.g., the portrait capture mode user interface object, a zoom control object, a flash control object, a multi-frame capture control object, and/or another user interface element). In some embodiments, the expanded portrait filter control object covers (e.g., overlays) former display locations of the one or more user interface objects (e.g., the zoom control object and portrait capture mode user interface object). In some embodiments, while the expanded portrait filter control object is displayed (e.g., while portrait controls are expanded), the computer system responds to movement inputs (e.g., swipes) by adjusting the portrait filter, for instance, changing which portrait filter is selected. In some embodiments, the computer system maintains displaying the expanded portrait filter control object while detecting inputs directed to the expanded portrait filter control object (e.g., while the user is interacting with the expanded portrait controls). In some embodiments, the computer system maintains displaying the expanded portrait filter control object for a period of time (e.g., 0.5 s, 1 s, and/or 2 s) without detecting inputs directed to the expanded portrait filter control object before ceasing displaying the expanded portrait filter control object if no further inputs are detected within the period of time. Hiding control objects for other functions of a camera user interface while displaying an expanded portrait filter control object in response to an input selecting the portrait filter control object provides additional control options without cluttering the user interface with additional displayed controls. Doing so assists the user with composing media captures and reduces the risk that transient media capture opportunities are missed or captured in an unintended manner by helping the user to provide proper inputs and reduce user mistakes while capturing media, which makes the media capture user interface more efficient (e.g., reducing power usage and/or improving battery life of the system by enabling the user to capture media more quickly and efficiently). For example, hiding other control objects when the portrait filter control is expanded assists the user with selecting a portrait filter to apply while reducing the likelihood of unintended inputs (e.g., inadvertently changing the zoom level and/or disabling the portrait capture mode instead of controlling portrait filter effects).

In some embodiments, while displaying the media capture user interface including the portrait filter control object (e.g., 820A) (e.g., while the portrait capture mode is enabled), the computer system displays, via the one or more display generation components, a respective zoom control object (e.g., 608C). In some embodiments, the respective zoom control object is also displayed while displaying the media capture user interface with the portrait capture mode disabled. For example, the respective zoom control object is displayed in an initial location, with an initial appearance (e.g., including a particular set of zoom values), when the portrait capture mode is not enabled, and is displayed in a different location and/or with a different appearance when the portrait capture mode is enabled (e.g., as described above). In some embodiments, while displaying the media capture user interface including the portrait filter control object (e.g., 820A), the computer system detects, via the one or more input devices, a first input (e.g., 822D, 832D, 836, 854, 856D, and/or 856E) directed to the respective zoom control object. In some embodiments, the first input is an input of a first type, e.g., a held press, a hard press, a double-tap input, a gesture input, and/or another specific type of input. In some embodiments, the input includes a touch, tap, press, gesture, and/or air gesture directed to the respective zoom control object in the media capture user interface and/or directed to/detected by a hardware button associated with the zoom setting (e.g., tapping or pressing the zoom control object). In some embodiments, the input includes a movement component, such as a swipe, drag, and/or flick gesture, for instance, detected via a touch-sensitive display of the one or more display generation components and/or the hardware button associated with the zoom setting (e.g., swiping across the zoom control object). In some embodiments, in response to detecting the first input directed to the respective zoom control object, the computer system initiates a process for selecting a zoom level to be used when capturing media. In some embodiments, initiating the process for selecting a zoom level to be used when capturing media includes displaying, via the one or more display generation components, a first expanded zoom control object (e.g., as described with respect to FIGS. 8J and/or 8Q). In some embodiments, the expanded zoom control object includes a static or scrollable platter, menu, and/or dial. In some embodiments, the expanded zoom control object includes a set of individual zoom software buttons, each corresponding to a respective zoom level, that can be selected to use the corresponding zoom level for media capture. In some embodiments, the expanded zoom control object includes a representation of an incremented set of zoom levels within a range (e.g., a dial or slider corresponding to a 1× to 8× zoom zoom range with 0.1× intervals) that can be selected using movement inputs to increment or decrement the zoom level for media capture. In some embodiments, initiating the process for selecting a zoom level to be used when capturing media includes ceasing displaying one or more user interface objects (e.g., 608A, 608B, 608F, 820A, 820B, and/or 824) of the media capture user interface (e.g., as described with respect to FIGS. 8J and/or 8Q) (e.g., the portrait capture mode user interface object, the portrait filter control object, a flash control object, a multi-frame capture control object, and/or another user interface element). In some embodiments, the expanded zoom control object covers (e.g., overlays) the former display locations of the one or more user interface objects (e.g., the portrait filter control object and portrait capture mode user interface object). In some embodiments, while the expanded zoom control object is displayed (e.g., while zoom controls are expanded), the computer system responds to movement inputs (e.g., swipes) by adjusting the zoom level, for instance, zooming in or out based on the direction of the swipe. In some embodiments, the computer system maintains displaying the expanded zoom control object while detecting inputs directed to the expanded zoom control object (e.g., while the user is interacting with the expanded zoom controls). In some embodiments, the computer system maintains displaying the expanded zoom control object for a period of time (e.g., 0.5 s, 1 s, and/or 2 s) without detecting inputs directed to the expanded zoom control object before ceasing displaying the expanded zoom control object if no further inputs are detected within the period of time. Hiding control objects for other functions of a camera user interface while displaying an expanded zoom control object in response to an input selecting the zoom control object provides additional control options without cluttering the user interface with additional displayed controls. Doing so assists the user with composing media captures and reduces the risk that transient media capture opportunities are missed or captured in an unintended manner by helping the user to provide proper inputs and reduce user mistakes while capturing media, which makes the media capture user interface more efficient (e.g., reducing power usage and/or improving battery life of the system by enabling the user to capture media more quickly and efficiently). For example, hiding other control objects when the zoom control is expanded assists the user with selecting a zoom level for capture while reducing the likelihood of unintended inputs (e.g., inadvertently changing the portrait filter and/or disabling the portrait capture mode instead of zooming in or out).

In some embodiments, while displaying the media capture user interface including the portrait filter control object (e.g., 820A) (e.g., while the portrait capture mode is enabled), the computer system displays, via the one or more display generation components, a respective zoom control object (e.g., 608C). In some embodiments, the respective zoom control object is also displayed while displaying the media capture user interface with the portrait capture mode disabled. For example, the respective zoom control object is displayed in an initial location, with an initial appearance (e.g., including a particular set of zoom values), when the portrait capture mode is not enabled, and is displayed in a different location and/or with a different appearance when the portrait capture mode is enabled (e.g., as described above). In some embodiments, while displaying the media capture user interface including the portrait filter control object (e.g., 820A), the computer system detects, via the one or more input devices, a second input directed to the respective zoom control object (e.g., 822D, 832D, 836, 854, 856D, and/or 856E). In some embodiments, the second input is an input of a second type, different from the first type, e.g., a short press, a single-tap input, a gesture input, and/or another specific type of input. In some embodiments, in response to detecting the second input directed to the respective zoom control object, the computer system initiates a process for selecting a zoom level to be used when capturing media. In some embodiments, initiating the process for selecting a zoom level to be used when capturing media includes displaying, via the one or more display generation components, a second expanded zoom control object (e.g., as described with respect to FIGS. 8J and/or 8Q). In some embodiments, the expanded zoom control object includes a static or scrollable platter, menu, and/or dial. In some embodiments, the expanded zoom control object includes a set of individual zoom software buttons, each corresponding to a respective zoom level, that can be selected to use the corresponding zoom level for media capture. In some embodiments, the expanded zoom control object includes a representation of an incremented set of zoom levels within a range (e.g., a dial or slider corresponding to a 1× to 8× zoom zoom range with 0.1× intervals) that can be selected using movement inputs to increment or decrement the zoom level for media capture. In some embodiments, initiating the process for selecting the zoom level to be used when capturing media includes maintaining displaying one or more user interface objects (e.g., 608F and/or 820A) of the media capture user interface (e.g., as described with respect to FIG. 8J) (e.g., the portrait capture mode user interface object, the portrait filter control object, a flash control object, a multi-frame capture control object, and/or another user interface element). In some embodiments, the process for selecting the zoom level includes, in response to an input directed to the second expanded zoom control object, performing an optical zoom (e.g., switching between different fixed focal-length lenses of different magnifications and/or varying the focal length of a hardware zoom lens) and/or performing a digital zoom (e.g., digitally magnifying camera by resizing, interpolating, and/or combining data captured at one or more optical zoom levels). In some embodiments, the process for selecting the zoom level includes, in response to an input directed to the second expanded zoom control object, displaying the camera preview with the currently-selected zoom level (e.g., providing a live preview of the zoom operation). Maintaining the display of control objects for other functions of a camera user interface while displaying an expanded zoom control object in response to an input selecting the zoom control object provides additional control options without cluttering the user interface with additional displayed controls. Doing so assists the user with composing media captures and reduces the risk that transient media capture opportunities are missed or captured in an unintended manner by helping the user to provide proper inputs and reduce user mistakes while capturing media, which makes the media capture user interface more efficient (e.g., reducing power usage and/or improving battery life of the system by enabling the user to capture media more quickly and efficiently). For example, expanding the zoom control object provides additional options for media capture zoom levels while continuing to provide controls for other media capture functions for quick access.

In some embodiments, while displaying the media capture user interface, the computer system (e.g., 600) detects, via the one or more input devices, an input (e.g., 802D, 802E, 822D, 822E, 828D, 828E, 832D, 832E, 836, 854, 856D, 856E, 864D, and/or 864E) directed to a respective location within the camera preview. In some embodiments, the respective location within the camera preview is a location at which a portrait filter control object (In some embodiments, the portrait filter control object; In some embodiments, an expanded portrait filter control object; In some embodiments, an individual portrait filter control object within the expanded portrait filter control object) is conditionally displayed. In some embodiments, the input directed to the respective location includes a discrete input (e.g., a tap and/or press) at the respective location. In some embodiments, the input directed to the respective location includes a movement input (e.g., a swipe, flick, and/or other gesture) moving through, towards, and/or around the respective location. In some embodiments, in response to detecting the input directed to the respective location within the camera preview and in accordance with a determination that a first set of criteria is satisfied, the computer system selects, from the set of one or more portrait filters, the portrait filter to be used when capturing media with the portrait capture mode enabled (e.g., as described with respect to FIGS. 8G-8H), wherein the first set of criteria includes a criterion that is satisfied when the portrait capture mode is enabled. In some embodiments, the first set of criteria includes a criterion that is satisfied when the expanded portrait filter control is displayed at the respective location (e.g., the criterion is satisfied when the portrait filter control is expanded). In some embodiments, selecting the portrait filter to be used when capturing media with the portrait capture mode enabled includes applying the selected portrait filter to the camera preview (e.g., displaying a live preview of the selected portrait filter effect). In some embodiments, in response to detecting the input directed to the respective location within the camera preview and in accordance with a determination that the first set of criteria is not satisfied, the computer system foregoes selecting the portrait filter to be used when capturing media with the portrait capture mode enabled (e.g., as described with respect to FIG. 8A). In some embodiments, the computer system performs an operation other than selecting the portrait filter in response to the detected input, e.g., performing a zoom operation if the input is detected while a zoom control (In some embodiments, an expanded zoom control) is displayed at the respective location, selecting a focus point if the input is a tap input on the camera preview while the camera preview is not overlaid by any user interface objects at the respective location, and/or performing another camera operation in other conditions. Adjusting the response to an input to select a portrait filter only when the portrait capture mode is enabled assists the user with creating media items by performing an operation when a set of conditions has been met without cluttering the display, which assists the user with control of the computer system via the media capture user interface. For example, a particular input can be used to perform the operation of selecting the portrait filter to be used when relevant (e.g., when the portrait mode is enabled) and can be used for other operations and/or not responded to at all in other circumstances, providing more flexible control options and reducing the likelihood of inadvertently changing the portrait filter.

In some embodiments, while displaying the media capture user interface, the computer system detects, via the one or more input devices, an input directed to a respective location within the camera preview (e.g., 802D, 802E, 822D, 822E, 828D, 828E, 832D, 832E, 836, 854, 856D, 856E, 864D, and/or 864E). In some embodiments, the respective location within the camera preview is a location at which a zoom control object and/or an expanded zoom control object is displayed while the portrait capture mode is enabled. In some embodiments, the respective location within the camera preview is a location at which the portrait mode user interface object is displayed. In some embodiments, the input directed to the respective location includes a discrete input (e.g., a tap and/or press) at the respective location. In some embodiments, the input directed to the respective location includes a movement input (e.g., a swipe, flick, and/or other gesture) moving through, towards, and/or around the respective location. In some embodiments, in response to detecting the input directed to the respective location within the camera preview and in accordance with a determination that a second set of criteria is satisfied, the computer system changes a zoom level (e.g., magnification) to be used when capturing media with the portrait capture mode enabled (e.g., as described with respect to FIGS. 8J-8K and/or 8Q-8R), wherein the second set of criteria includes a criterion that is satisfied when the portrait capture mode is enabled. In some embodiments, the second set of criteria includes a criterion that is satisfied when an expanded zoom control is displayed at the respective location (e.g., the criterion is satisfied when the zoom control is expanded). In some embodiments, the second set of criteria includes a criterion that is satisfied when the portrait capture mode is enabled in response to the input and a criterion that is satisfied when the input is detected while the current zoom level is not included in a set of portrait mode zoom levels. For example, in response to an input enabling the portrait capture mode detected while the zoom is set to 0.5×, the computer system enables the portrait capture mode and automatically zooms in to 1× (e.g., the next allowable zoom level for portrait mode). In some embodiments, changing the zoom level to be used when capturing media includes displaying the camera preview at the selected zoom level. In some embodiments, changing the zoom level includes performing an optical zoom (e.g., switching between different fixed focal-length lenses of different magnifications and/or varying the focal length of a hardware zoom lens) and/or performing a digital zoom (e.g., digitally magnifying camera by resizing, interpolating, and/or combining data captured at one or more optical zoom levels). In some embodiments, changing the zoom level includes displaying the camera preview with the currently-selected zoom level (e.g., providing a live preview of the zoom operation). In some embodiments, in response to detecting the input directed to the respective location within the camera preview and in accordance with a determination that the first set of criteria is not satisfied, the computer system foregoes changing the zoom level to be used when capturing media (e.g., as described with respect to FIG. 8A). In some embodiments, the computer system performs an operation other than a zoom operation in response to the detected input, e.g., performing a zoom operation if the input is detected while a zoom control (In some embodiments, an expanded zoom control) is displayed at the respective location, selecting a focus point if the input is a tap input on the camera preview while the camera preview is not overlaid by any user interface objects at the respective location, and/or performing another camera operation in other conditions. For example, if the capture mode is disabled in response to the input, the computer system maintains the zoom level selected while in the portrait capture mode. Adjusting the response to a particular input to adjust a zoom level only when the portrait capture mode is enabled assists the user with creating media items by performing an operation when a set of conditions has been met without cluttering the display, which assists the user with control of the computer system via the media capture user interface. For example, a particular input can be used to perform a zoom operation in the portrait capture mode and can be used for other operations and/or not responded to at all in other circumstances, providing more flexible control options and reducing the likelihood of inadvertently performing an unintended zoom operation.

In some embodiments, while displaying the media capture user interface and while the portrait capture mode is enabled, the computer system (e.g., 600), via the one or more input devices, an input requesting to disable the portrait capture mode (e.g., 858). In some embodiments, the input requesting to disable the portrait capture mode includes an input directed to (e.g., selecting and/or activating) the portrait capture mode user interface object. In some embodiments, the input requesting to disable the portrait capture mode includes an input requesting a non-portrait capture mode, e.g., an input directed to a mode control object to select a standard video capture mode, a cinematic video capture mode, and/or a panoramic photo capture mode. In some embodiments, in response to detecting the input requesting to disable the portrait capture mode, the computer system changes an appearance of the media capture user interface to indicate that the portrait capture mode has been disabled and ceases displaying the portrait filter control object (e.g., as described with respect to FIGS. 8S-8T). Hiding the portrait filter control object when the portrait capture mode is no longer enabled provides additional control options without cluttering the user interface with additional displayed controls. Doing so assists the user with composing media captures and reduces the risk that transient media capture opportunities are missed or captured in an unintended manner by helping the user to provide proper inputs and reduce user mistakes while capturing media, which makes the media capture user interface more efficient (e.g., reducing power usage and/or improving battery life of the system by enabling the user to capture media more quickly and efficiently). For example, the portrait filter control object is provided when relevant (e.g., when the portrait capture mode is enabled), but removed when the portrait capture mode is no longer being used, decluttering the display and providing more flexible control options.

In some embodiments, while the portrait capture mode is enabled (e.g., enabled in response to detecting the input directed to the portrait capture mode user interface object) and after selecting (e.g., in response to the sequence of one or more inputs) the respective portrait filter from the set of one or more portrait filters as the portrait filter to be used when capturing media with the portrait capture mode enabled (In some embodiments, without receiving a subsequent input/sequence of inputs selecting another portrait filter as the portrait filter to be used when capturing media), the computer system (e.g., 600) detects, via the one or more input devices, a respective input requesting to capture media (e.g., 830A, 830B, 834A, 834B, 840A, and/or 840B). For example, the respective input includes a touch, tap, press, gesture, speech, and/or air gesture input. In some embodiments, the respective input is directed to a location of a media capture user interface object displayed within the media capture user interface (e.g., a software shutter button). In some embodiments, the respective input is directed to a hardware button of the one or more input devices (e.g., a hardware button associated with a media capture operation). In some embodiments, in response to detecting the respective input requesting to capture media, the computer system captures, via the one or more cameras, respective media (e.g., 844) that includes a representation of a field-of-view of the one or more cameras, wherein capturing the respective media includes applying the respective portrait filter to the representation of the field-of-view of the one or more cameras (e.g., as described with respect to FIGS. 8L-8M). In some embodiments, applying the respective portrait filter to the representation of the field-of-view of the one or more cameras includes designating the respective media for display with the respective portrait filter applied. In some embodiments, applying the respective portrait filter to the representation of the field-of-view of the one or more cameras includes modifying an appearance of a portion of the representation of the field-of-view of the one or more cameras that includes a representation of a detected subject in a first manner and modifying an appearance of a different portion of the representation of the field-of-view of the one or more cameras in a different manner (e.g., the portrait filter is applied based on a detected subject). Capturing media with the respective portrait filter applied enables the computer system to capture media with varying appearances based on user inputs, thereby improving the man-machine interface.

In some embodiments, the computer system displays, via the one or more display generation components, the respective media (e.g., 844) with the respective portrait filter applied to the representation of a field-of-view of the one or more cameras (e.g., as described with respect to FIGS. 8L-8M). In some embodiments, the computer system displays the respective media in a photo well within the media capture user interface, in a media viewing user interface (e.g., a media application), and/or in a media editing user interface. In some embodiments, while displaying the respective media with the respective portrait filter applied, the computer system displays a filter indicator (e.g., an object indicating that the respective portrait filter is being applied) and/or a filter editing user interface object (e.g., a control object for modifying portrait filter effects). In some embodiments, while displaying the respective media with the respective portrait filter applied, the computer system detects, via the one or more input devices, a second sequence of one or more inputs (e.g., 848A, 848B, and/or 852). In some embodiments, the second sequence of one or more inputs includes an input directed to the filter editing user interface object, such as an input selecting/activating a toggle control for applying the respective portrait filter, an input selecting an option to remove portrait filter effects (e.g., selecting a “no filter” or “natural lighting” option and/or reducing a filter intensity to zero), and/or an input selecting/activating a toggle control for applying all portrait mode effects. In some embodiments, the second sequence of one or more inputs includes an input requesting to edit the respective media (e.g., via a media viewing or media editing user interface). In some embodiments, the second sequence of one or more inputs includes an input requesting to finalize edits made to the respective media (e.g., selecting a “save” or “done” option following editing inputs). In some embodiments, the second sequence of one or more inputs includes one or more touch, tap, press, gesture, and/or air gesture inputs (e.g., inputs with or without movement, such as a tap input directed to a “natural lighting” option and/or a swipe across a filter intensity slider). In some embodiments, in response to detecting the second sequence of one or more inputs, the computer system displays, via the one or more display generation components, the respective media without the respective portrait filter applied to the representation of a field-of-view of the one or more cameras (e.g., as described with respect to FIGS. 80-8P). For example, the portrait filter selected for use when capturing the respective media can be edited, changed, and/or removed at a later time. In some embodiments, displaying the respective media without the respective portrait filter includes applying a different filter of the one or more portrait filters to the representation of a field-of-view of the one or more cameras (e.g., in response to a sequence of inputs changing the portrait filter). Allowing the portrait filter used when capturing media to be removed from the media at a later time assists the user with composing media captures and reduces the risk that transient media capture opportunities are missed or captured in an unintended manner by helping the user to provide proper inputs and reduce user mistakes while capturing media, which makes the media capture user interface more efficient (e.g., reducing power usage and/or improving battery life of the system by enabling the user to capture media more quickly and efficiently).

In some embodiments, while the portrait capture mode is enabled (e.g., enabled in response to detecting the input directed to the portrait capture mode user interface object) and after selecting (e.g., in response to the sequence of one or more inputs) the respective portrait filter from the set of one or more portrait filters as the portrait filter to be used when capturing media with the portrait capture mode enabled (In some embodiments, without receiving a subsequent input/sequence of inputs selecting another portrait filter as the portrait filter to be used when capturing media), the computer system (e.g., 600) applies the respective portrait filter to the camera preview (e.g., as described with respect to FIGS. 8H-8L). For example, applying the respective portrait filter to the camera preview includes modifying an appearance of the live or near-live representation of the field-of-view of the one or more cameras displayed within the camera preview (e.g., applying the filter to the camera feed/viewfinder). In some embodiments, applying the respective portrait filter to the camera preview includes detecting a subject in the camera preview and applying the respective portrait filter based on the detected subject (e.g., modifying the appearance of the subject in a first manner and modifying the appearance of other portions of the field-of-view in a different manner). Applying a portrait filter to a live camera preview provides users with improved visual feedback about a state of the computer system (e.g., about a result of the sequence of one or more inputs) without cluttering the display, which assists the user with control of the computer system via the media capture user interface. Doing so assists the user with composing media captures and reduces the risk that transient media capture opportunities are missed or captured in an unintended manner by helping the user to provide proper inputs and reduce user mistakes while capturing media, which makes the media capture user interface more efficient (e.g., reducing power usage and/or improving battery life of the system by enabling the user to capture media more quickly and efficiently).

In some embodiments, the media capture user interface includes a capture control object (e.g., 610A) (e.g., a software shutter button). In some embodiments, the computer system maintains displaying the capture control object both while the portrait capture mode is enabled and disabled. In some embodiments, the computer system detects, via the one or more input devices, an input (e.g., 804A, 814A, 826A, 826B, 830A, 830B, 834A, 834B, 840A, 840B, 860A, and/or 860B) directed to the capture control object. In some embodiments, the input includes a touch, tap, press, gesture, and/or air gesture directed to the capture control object in the media capture user interface and/or directed to/detected by a hardware button associated with capturing media via the media capture user interface. In some embodiments, in response to detecting the input directed to the capture control object and in accordance with a determination that, when the input directed to the capture control object is detected, a first set of one or more capture settings is selected to be used when capturing media, the computer system captures, via the one or more cameras, first media, wherein the first media is captured with the first set of media capture settings. For example, selected media capture settings define whether the respective media is captured and/or stored with or without portrait mode effects applied, with or without portrait filter effects applied, with portrait mode effects/portrait filter effects applied in a particular manner (e.g., a particular simulated depth-of-field, filter intensity, and/or focus subject), with a particular zoom level, and/or with a “live” photo setting enabled or disabled. In some embodiments, the computer system selects (e.g., configures) a set of media capture settings to be used when capturing media based on one or more inputs directed to the media capture user interface, e.g., via the portrait capture mode user interface object, portrait filter control object, zoom control object, the camera preview, and/or other user interface elements. In some embodiments, in response to detecting the input directed to the capture control object and in accordance with a determination that, when the input directed to the capture control object is detected, a second set of one or more capture settings is selected to be used when capturing media, the computer system captures, via the one or more cameras, second media, wherein the second media is captured with the second set of media capture settings and the second set of one or more capture settings is different from the first set of one or more capture settings. Capturing media with different media capture settings based on the currently selected settings enables the computer system to vary the appearance of media captured based on the user's preferences and selections, thereby improving the man-machine interface, and provides feedback to the user about what settings were selected when the media was captured, thereby providing improved visual feedback.

In some embodiments, while displaying the media capture user interface and while the portrait capture mode is enabled and in accordance with a determination that a zoom level selected to be used when capturing media is included a respective set of one or more zoom levels (In some embodiments, a respective range of zoom levels), the computer system enables a low light capture process to be used when capturing media (e.g., as described with respect to FIG. 8F). In some embodiments, the respective set of one or more zoom levels includes a single zoom level (e.g., 1×, 2×, or 5×). In some embodiments, the respective set of one or more zoom levels includes a range of zoom levels (e.g., at least 1×, less than 5×, and/or between 1.0× and 1.9×) and/or a set of zoom levels (e.g., zoom levels using particular lenses of the one or more cameras and/or not using other lenses of the one or more cameras). For example, performing the process for enabling a low-light capture process includes enabling a night mode or long-exposure capture mode that includes capturing multiple images that are combined (e.g., using computational photography and/or other image processing techniques) to generate an image with increased brightness (e.g., using the light data captured across the multiple images). In some embodiments, the process for enabling the low-light capture process setting includes selecting (In some embodiments, dynamically selecting) an exposure value to be used when capturing media based on a detected brightness of the field-of-view of the one or more cameras. In some embodiments, the process for enabling the low-light capture process includes displaying a low-light user interface object with a respective appearance. For example, an low-light user interface object is automatically displayed at the respective zoom levels and/or is displayed with a selected or activated appearance. In some embodiments, the low-light user interface object includes an indication of a current exposure value (e.g., a current maximum exposure length). In some embodiments, the low-light user interface object can be selected to adjust an exposure or brightness value to be used when capturing media. In some embodiments, modifying an exposure or brightness value includes simulating different camera exposure times, shutter speeds, aperture sizes, and/or ISO speeds, where higher exposure/brightness values correspond to brighter captures (e.g., longer exposure times/slower shutter speeds, slower ISO speeds, and/or larger aperture sizes) and lower exposure/brightness values correspond to darker captures (e.g., shorter exposure times/faster shutter speeds, faster ISO speeds, and/or smaller aperture sizes). For example, at a higher exposure/brightness value, the computer system combines image data from a higher number of captured frames (e.g., simulating a longer exposure, slower speed, and/or larger aperture) to create a brighter image. Automatically performing a night/long-exposure mode function when the current zoom level is an acceptable value provides additional control options for media capture without cluttering the user interface with additional displayed controls or requiring further user input. Doing so assists the user with composing media captures and reduces the risk that transient media capture opportunities are missed or captured in an unintended manner by helping the user to provide proper inputs and reduce user mistakes while capturing media, which makes the media capture user interface more efficient (e.g., reducing power usage and/or improving battery life of the system by enabling the user to capture media more quickly and efficiently). For example, when the current zoom level is compatible with a night/long-exposure mode capture, the mode is automatically enabled and/or adjusted to optimize low-light captures, and when the current zoom level is not compatible, the mode is automatically disabled.

In some embodiments, while displaying the media capture user interface and while the portrait capture mode is enabled and in accordance with a determination that the zoom level selected to be used when capturing media is not included the respective set of one or more zoom levels, the computer system (e.g., 600) foregoes performing the process for enabling the low-light capture process to be used when capturing media (e.g., as described with respect to FIG. 8K). In some embodiments, if the process was previously initiated (e.g., while the current zoom was included in the respective set), the computer system ceases performing the process, for example, disabling the night/long-exposure capture mode, ceasing displaying the exposure user interface object and/or displaying the low-light user interface object with a deselected/deactivated appearance, and/or selecting a predetermined exposure/brightness value to be used when capturing media (e.g., a standard exposure value that is not adjusted based on the detected brightness). Disabling a respective exposure setting adjustment based on a current zoom level being within a range of zoom levels enables the computer system to capture media at various zoom levels that may be incompatible with the exposure setting adjustment, thereby providing the user with more options for capturing media and improving the man-machine interface.

In some embodiments, while displaying the media capture user interface and while the portrait capture mode is enabled, the computer system (e.g., 600) displays a plurality of user interface objects (e.g., 608A, 608B, 608C, 608F, 820A, 820B, and/or 824) (e.g., the portrait control user interface object, the portrait filter control object, a zoom control object, a flash control object, an exposure control object, and/or a multi-frame photo capture control object). In some embodiments, the computer system detects, via the one or more input devices, an input (e.g., 822C, 832D, and/or 854) directed to a first user interface object of the plurality of user interface objects. In some embodiments, in response to detecting the input directed to the first user interface object of the plurality of user interface objects, the computer system initiates a process for performing an operation associated with the first user interface object (e.g., as described with respect to FIGS. 8F-8H, 8I-8K, and/or 8P-8R). In some embodiments, the process for performing the operation includes adjusting (e.g., changing) a capture setting based on the input, such as changing a portrait capture setting (e.g., as described above); a zoom setting (e.g., as described above); a flash setting (e.g., turning flash on, off, and/or selecting an automatic mode); exposure, brightness, and/or low-light capture setting (e.g., enabling or disabling a process for low-light capture and/or selectign a custom exposure/brightness value); a limited-duration photo capture setting (e.g., enabling or disabling capturing limited-duration photos, e.g., photos with a “live” effect), and/or a media format setting (e.g., selecting resolution, format, and/or frame rate for a media capture). In some embodiments, the process for performing the operation includes displaying an expanded control for the setting, receiving one or more additional inputs directed to the expanded control for the setting, and adjusting (e.g., changing) the setting value based on the one or more additional inputs. In some embodiments, in response to detecting the input directed to the first user interface object of the plurality of user interface objects, the computer system reduces a visual prominence of at least one user interface object (e.g., 608A, 608B, 608C, 608F, 820A, 820B, and/or 824), different from the first user interface object, of the plurality of user interface objects (e.g., as described with respect to FIGS. 8G-8H, 8J, and/or 8Q). For example, reducing the visual prominence of a user interface object includes changing the color of the object, changing the opacity of the object, fading the object, shrinking the object, and/or moving the object. In some embodiments, the computer system increases the visual prominence of the first user interface object. Reducing the visual prominence of control objects associated with certain operations of a camera user interface while performing a different operation (e.g., using a different control object) provides additional control options without cluttering the user interface with additional displayed controls. Doing so assists the user with composing media captures and reduces the risk that transient media capture opportunities are missed or captured in an unintended manner by helping the user to provide proper inputs and reduce user mistakes while capturing media, which makes the media capture user interface more efficient (e.g., reducing power usage and/or improving battery life of the system by enabling the user to capture media more quickly and efficiently). For example, hiding other control objects when using a particular control object assists the user with adjusting capture settings while reducing the likelihood of unintended inputs (e.g., inadvertently changing an unintended setting).

In some embodiments, reducing the visual prominence of the at least one user interface object of the plurality of user interface objects includes reducing a visual prominence of the at least one user interface object relative to the camera preview (e.g., as described with respect to 608A, 608B, 820B, and/or 824 in FIGS. 8G-8H, 8J, and/or 8Q). For example, reducing the visual prominence relative to the camera preview includes reducing the opacity of a user interface object (e.g., one that overlays the camera preview), reducing the contrast between the user interface object at the camera preview (e.g., based on the contents represented in the camera preview), reducing the size of the user interface object, and/or moving the user interface object relative to the camera preview. Reducing the visual prominence of control objects associated with certain operations of a camera user interface relative to a camera preview while performing a different operation (e.g., using a different control object) provides improved visual feedback about a state of the computer system without cluttering the user interface with additional displayed controls. Doing so assists the user with composing media captures and reduces the risk that transient media capture opportunities are missed or captured in an unintended manner by helping the user to provide proper inputs and reduce user mistakes while capturing media, which makes the media capture user interface more efficient (e.g., reducing power usage and/or improving battery life of the system by enabling the user to capture media more quickly and efficiently). For example, deemphasizing other controls relative to the camera preview allows users to better monitor the effects of the operation being performed on the capture (e.g., previewing changes to the settings in the live or near-live viewfinder).

Note that details of the processes described above with respect to method 900 (e.g., FIGS. 9A-9B) are also applicable in an analogous manner to the methods described below and above. For example, methods 700 and 1100 optionally includes one or more of the characteristics of the various methods described above with reference to method 900. For example, the portrait capture controls described with respect to method 900 are integrated into camera user interfaces that also integrate the capture controls for stopping and pausing video described with respect to method 700 and/or the spatial capture mode described with respect to method 1100. For brevity, these details are not repeated below.

FIGS. 10A-10K illustrate exemplary user interfaces for controlling spatial media captures, in accordance with some embodiments. The user interfaces in these figures are used to illustrate the processes described below, including the processes in FIG. 11.

Computer system 600 can be configured capture spatial media using the set of cameras and/or other sensors of computer system 600 (e.g., depth sensors) described with respect to FIG. 6A. For example, spatial media includes one or more images for a left eye of a user and one or more images for a right eye of a user that, when viewed together, create the illusion of three-dimensionality (e.g., simulating binocular vision of a three-dimensional object or environment). Accordingly, spatial media can be captured using a camera array or stereo camera, for example, two or more spaced apart cameras where the perspective/field-of-view of one camera differs from the perspective/field-of-view of the other. For example, in the examples described with respect to FIGS. 10A-10K, first camera 604A and third camera 604C are used as the cameras for spatial capture; however, it is to be understood that different combinations or configurations of camera and sensor hardware could be used to a similar effect.

At FIGS. 10A-10B, computer system 600 displays camera user interface 608 in the standard video capture mode (e.g., as described with respect to FIG. 6C) with the “video” menu item horizontally centered within camera user interface 608. At FIGS. 10A-10B, camera user interface 608 includes flash control 608A, low-light capture control 824, zoom control 608C, camera selection control 608D, capture mode control 608G, video format control 608H, spatial mode control 608I, and video capture timer 608J, and capture control 610A is displayed with the “start recording” appearance. The controls displayed in the standard video mode can be interacted with in the manner described above (e.g., with respect to FIGS. 6B-6C and 8F) via inputs such as 1002A, 1002B, 1002C, 1002D, 1006A, 1006B, 1006C, and/or 1006D. At FIGS. 10A-10B, a professional (e.g., visually lossless) resolution and a frame rate of 60 FPS are selected in the standard video capture mode, as indicated by video format control 608H.

At FIGS. 10A-10B, computer system 600 detects an input requesting to change from the standard video capture mode to a spatial capture mode, such as a tap directed to the “spatial” element in capture mode control 608G (e.g., input 1004A and/or input 1010A), a swipe across capture mode control 608G to select the “spatial” element (e.g., input 1004B and/or input 1010B), and/or a tap directed to spatial mode control 608I (e.g., input 1004C and/or input 1010C). In response to the input requesting to change to the spatial capture mode, computer system 600 updates camera user interface 608 to the spatial capture mode as illustrated in FIGS. 10C-10D.

In the spatial capture mode, camera user interface 608 includes spatial media type control 1014, a software control for changing between multiple types of spatial media captures, such as limited-duration photo captures, indicated by a point-and-shoot camera icon, and variable-duration video captures, indicated by a video camera icon. As illustrated in FIGS. 10C-10D, spatial media type control 1014 replaces camera selection control 608D. As illustrated in FIGS. 10C-10D, spatial media type control 1014 is a toggle user interface element; however, in some embodiments, spatial media type control 1014 may include other user interface elements, such as button 1014A, corresponding to the limited-duration photo capture type, and button 1014B, corresponding to the variable-duration video capture type, as illustrated in the inset of FIG. 10D. As illustrated in FIGS. 10C-10D, when computer system 600 initially changes to the spatial capture mode, the variable-duration video capture type is selected (e.g., by default), as indicated by the appearance spatial media type control 1014.

Additionally, in the spatial capture mode, flash control 608A is removed and replaced with low-light capture control 824, while zoom control 608C, capture mode control 608G (updated to center the “spatial” element), video format control 608H, spatial mode control 608I, video capture timer 608J, capture control 610A (displayed with the “start recording” appearance) remain displayed. Accordingly, in the spatial capture mode, computer system 600 still adjusts the video format in response to inputs such as 1016A and/or 1020A, but will adjust exposure (e.g., instead of flash) in response to inputs 1016C and/or 1020C, and may forego responding to inputs such as 1016D and/or 1020D, which are directed to portions of camera user interface 608 without touch controls in the spatial capture mode. In some embodiments, the settings values available in the spatial capture mode are different from those available in the standard video capture mode (e.g., and/or the standard photo capture mode). For example, ProRes resolution and 60 FPS capture are not format settings compatible with spatial capture. As illustrated in FIGS. 10C-10D, computer system 600 automatically changes the video format to HD resolution and 30 FPS frame rate (e.g., one of the format settings compatible with spatial capture), as indicated by updating video format control 608H as illustrated in FIGS. 10C-10D. The appearance of spatial mode control 608I is also updated to a selected appearance.

At FIG. 10A, computer system 600 is oriented in a horizontal (e.g., landscape) orientation with respect to the environment, such that the line between the two lenses for first camera 604A and third camera 604C is aligned (e.g., or approximately aligned) to the horizon. Accordingly, in embodiments where first camera 604A and third camera 604C are used to capture spatial media, in response to inputs 1004A, 1004B, and/or 1004C, computer system 600 directly updates camera user interface 608 to the spatial capture mode as illustrated in FIG. 10D. At FIG. 10D, spatial media type control 1014 is displayed with a visually emphasized (e.g., active) appearance, indicating that it can be interacted with (e.g., via input 1020B) to change between the multiple types of spatial media captures, as described in further detail below.

In contrast, at FIG. 10B, computer system 600 is oriented in a vertical (e.g., portrait orientation) with respect to the environment, such that the line between first camera 604A and third camera 604C is perpendicular (e.g., or approximately) to the horizon (e.g., aligned with the direction of gravity's pull). Accordingly, in embodiments where first camera 604A and third camera 604C are used to capture spatial media, in response to inputs 1010A, 1010B, and/or 1010C, computer system 600 first updates camera user interface 608 to the spatial capture mode as illustrated in FIG. 10C, obscuring camera preview 612 with orientation alert 1012 and/or displaying spatial media type control 1014 with a visually-deemphasized (e.g., inactive) appearance. Orientation alert 1012 includes an instruction to rotate computer system 600 to align first camera 604A and third camera 604C with the horizon to allow the cameras to be used for spatial capture. While orientation alert 1012 is displayed at FIG. 10C, in some embodiments, computer system 600 allows interactions with video format control 608H and/or low-light capture control 824 (e.g., via inputs 1016A and/or 1016C, as described above), but does not respond to inputs directed spatial media type control 1014 (e.g., input 1016B) and/or capture inputs such as 1018A and/or 1018B. Orientation alert 1012 remains displayed until the orientation of computer system 600 is changed to the horizontal orientation, in response to which computer system 600 removes orientation alert 1012 and displays camera user interface 608 as illustrated in FIG. 10D.

At FIG. 10D, computer system 600 detects a capture input such as touch input 1022A and/or press input 1022B while the variable-duration video media capture type is selected (e.g., as indicated by spatial media type control 1014). In response to the capture input (e.g., 1022A and/or 1022B), at FIG. 10E, computer system 600 initiates capturing spatial video media. For example, computer system 600 initiates capturing video using both first camera 604A and third camera 604C to produce video components for a right and left eye, and/or captures additional depth information via other cameras and/or sensors for use in generating and/or displaying video content with a three-dimensional effect.

Additionally, at FIG. 10E, computer system 600 updates camera user interface 608 (e.g., as described with respect to FIGS. 6D-6E). As illustrated in FIG. 10E, low-light capture control 824 remains displayed, allowing the exposure setting to be adjusted during the capture of video media. However, computer system 600 removes video format control 608H and visually deemphasizes spatial media type control 1014, and in response to inputs such as input 1024A and/or 1024B (e.g., detected while already capturing the spatial video media), computer system 600 will not change the video format settings and/or select a different type of spatial media to capture.

At FIG. 10E, computer system 600 detects a stop capture input, such as input 1025A and/or input 1025B. In response to detecting the stop capture input (e.g., 1026A and/or 1026B), at FIG. 10F, computer system stops capturing the spatial video media and reverts camera user interface 608 to its appearance prior to initiating spatial video capture at FIG. 10D (e.g., as described with respect to FIGS. 6F-6G). In particular, once capturing the spatial video media is stopped, computer system 600 re-displays video format control 608H and re-emphasizes spatial media type control 1014.

At FIG. 10F, while displaying camera user interface 608 in the spatial capture mode with the variable-duration video media capture type selected, computer system 600 displays spatial capture alert 1026A within camera preview 612. In some embodiments, computer system 600 automatically displays alerts, such as spatial capture alert 1026A, based on detected capture conditions. For example, capturing spatial media (e.g., including the differing fields-of-view used to simulate a three-dimensional effect) using first camera 604A and third camera 604C is optimized when subject matter falls within a particular distance range of first camera 604A and third camera 604C. For example, capturing from too close of a distance causes the perspective of first camera 604A and third camera 604C to differ too much (e.g., becoming hard to visually resolve), and capturing from too far of a distance causes the perspectives of first camera 604A and third camera 604C to differ too little to simulate a depth effect. Accordingly, if computer system 600 detects that subject matter within camera preview 612, such as the cake illustrated in FIG. 6F, is too close to first camera 604A and third camera 604C for optimized spatial capture, computer system 600 displays spatial capture alert 1026A with the text “move farther away.”

At FIG. 10F, computer system 600 detects an input (e.g., input 1028A and/or input 1028B) directed to spatial media type control 1014 requesting to select a different type of spatial media to capture via camera user interface 608. For example, as illustrated in FIG. 10F, input 1028A includes a tap on spatial media type control 1014 and/or a swipe from right to left across spatial media type control 1014, corresponding to switching the toggle user interface element from the video camera icon to the point-and-shoot camera icon. Alternatively, as illustrated in FIG. 10F, input 1028B includes a tap input directed to button 1014A, corresponding to the limited-duration photo capture type.

In response to the input (e.g., input 1028A and/or input 1028B), at FIG. 10G, computer system 600 selects the limited-duration photo capture type for capturing media in the spatial capture mode. As illustrated in FIG. 10G, computer system 600 updates camera user interface 608 for photo-type captures, replacing video format control 608H with limited-duration photo control 608B, changing capture control 610A to the “capture photo” appearance, and changing the aspect ratio of camera preview 612 to a 4:3 aspect ratio (e.g., as described with respect to FIG. 6B). However, in contrast to the appearance of camera user interface 608 in the standard photo capture mode, at FIG. 10G, computer system 600 displays capture mode control 608G with the “spatial” menu item horizontally centered within camera user interface 608, indicating that camera user interface 608 is still in the spatial capture mode. Additionally, spatial media type control 1014 is updated to indicate the selection of the limited-duration photo capture type (e.g., switching the toggle and/or button selection to the point-and-shoot photo icon from the video camera icon).

As illustrated in FIG. 10G, upon switching to the limited-duration photo capture type, computer system 600 continues to display spatial capture alert 1026A, for instance, because computer system 600 continues to detect that the subject matter within camera preview 612 (e.g., the cake) is too close to first camera 604A and third camera 604C for optimized spatial capture. While displaying spatial capture alert 1026A, computer system 600 detects a capture input, such as input 1030A and/or input 1030B. In response to the capture input, computer system 600 performs a limited-duration spatial photo capture. For example, computer system 600 captures photo content using both first camera 604A and third camera 604C to produce limited-duration photo components for a right and left eye, and/or captures additional depth information via other cameras and/or sensors for use in generating and/or displaying video content with a three-dimensional effect. As shown by captured media element 608E in FIG. 10H, the limited-duration spatial photo media does not include spatial capture alert 1026A. Accordingly, a user can perform a spatial capture via camera user interface 608 even when optimal conditions for spatial captures are not met.

As illustrated in FIG. 10H, computer system 600 automatically stops displaying spatial capture alert 1026A in camera preview 612 based on the capture conditions, for instance, upon detecting that the distance between computer system 600 and the subject of camera preview 612 has changed to be within the optimized distance range. While displaying camera preview 612 without an alert, computer system 600 detects a capture input, such as input 1034A and/or input 1034B, and in response, performs a limited-duration spatial photo capture (e.g., as described above and illustrated in captured media element 608E in FIG. 10I).

At FIG. 10I, while displaying camera user interface 608 in the spatial capture mode with the limited-duration photo media capture type selected, computer system 600 displays spatial capture alert 1026B within camera preview 612 based on detected lighting conditions. For example, computer system 600 determines that first camera 604A and third camera 604C are not receiving enough light to optimally capture the subject matter in camera preview 612, such as the lit birthday cake in the darkened room illustrated in FIG. 10I. Accordingly, at FIG. 10I, computer system 600 displays spatial capture alert 1026B with the text “more light.”

At FIG. 10I, computer system 600 detects an input (e.g., input 1036A and/or input 1036B) directed to spatial media type control 1014 requesting to select a different type of spatial media to capture via camera user interface 608. For example, as illustrated in FIG. 10I, input 1036A includes a tap on spatial media type control 1014 and/or a swipe from left to right across spatial media type control 1014, corresponding to switching the toggle user interface element from the point-and-shoot camera icon to the video camera icon. Alternatively, as illustrated in FIG. 10F, input 1036B includes a tap input directed to button 1014B, corresponding to the variable-duration video capture type.

In response to the input (e.g., input 1036A and/or input 1036B), at FIG. 10J, computer system 600 selects the variable-duration video capture type for capturing media in the spatial capture mode and updates camera user interface 608 for video-type captures, including replacing limited-duration photo control 608B with video format control 608H, changing capture control 610A to the “start capturing” appearance, changing the aspect ratio of camera preview 612 to a 16:9 aspect ratio, and updating the appearance of spatial media type control 1014 (e.g., reverting to the appearance of camera user interface illustrated in FIG. 10D). As illustrated in FIG. 10G, upon switching to the variable-duration video capture type, computer system 600 continues to display spatial capture alert 1026B, for instance, because computer system 600 continues to detect sub-optimal lighting. As described with respect to spatial capture alert 1026A, while displaying spatial capture alert 1026B, computer system 600 will still capture spatial media in response to capture inputs such as 1040A and/or 1040B.

In some embodiments, rather than selecting the variable-duration video capture type for capturing media in the spatial capture mode and updating camera user interface 608 for video-type captures in response to an input (e.g., 1036A and/or 1036B), computer system 600 changes to the variable-duration video capture type after a threshold period of time passes without receiving an input via camera user interface 608 while camera user interface 608 is in the spatial capture mode. For example, after a threshold period of inactivity, a threshold period where inputs are received via camera user interface 608 in a non-spatial capture mode, and/or a threshold period where inputs are received via other user interfaces of computer system 600, computer system 600 reverts the spatial capture mode to the variable-duration video capture type (e.g., when the user returns to the spatial capture mode in camera user interface 608 as described with respect to FIGS. 10A-10D). For example, if the threshold period has not elapsed (e.g., even if the user has temporarily navigated away from the spatial capture mode and/or camera user interface 608), computer system 600 keeps the spatial capture mode configured to capture the limited-duration photo capture type.

At FIG. 10J, computer system 600 detects an input requesting to change from the portrait capture mode to a non-spatial capture mode, such as a tap directed to spatial mode control 608I (e.g., input 1042A) and/or a swipe across capture mode control 608G (e.g., input 1042B). In response a swipe across capture mode control 608G to select the “photo” element (e.g., input 1042B), computer system 600 updates camera user interface 608 to the standard photo mode, as illustrated in FIG. 10K. Alternatively, in response to an input selecting spatial mode control 608I (e.g., input 1042A), computer system 600 would update camera user interface to the standard video mode (e.g., as illustrated in FIG. 10A).

As illustrated in FIG. 10K, in the standard photo capture mode, computer system 600 replaces spatial media type control 1014 with camera selection control 608D, re-displays flash control 608A, updates capture control 610A to the “capture photo” appearance, centers the “photo” element in capture mode control 608G, stops displaying spatial capture alert 1026B, and removes spatial mode control 608I. Accordingly, in response to an input such as 1044B, directed to camera selection control 608D, computer system 600 will switch camera direction for media capture (e.g., as opposed to changing from a limited-duration photo capture to a variable-duration video capture), and in response to an input such as 1046, computer system 600 will not change to the spatial capture mode. At FIG. 10K, in response to detecting a capture input such as input 1048A and/or input 1048B, computer system 600 captures limited-duration photo media without producing separate components for the right and left eye, in contrast to the limited-duration photo media captured at FIGS. 10G-10H.

FIG. 11 is a flow diagram illustrating a method of controlling spatial media captures using a computer system in accordance with some embodiments. Method 1100 is performed at a computer system (e.g., 100, 300, 500, and/or 600) that is in communication with one or more display generation components (e.g., 606) (e.g., one or more display controllers; a touch-sensitive display system; one or more displays (e.g., integrated and/or connected), a 3D display, a transparent display, one or more projectors, and/or a heads-up display), one or more input devices (e.g., one or more hardware buttons and/or surfaces, such as mechanical (e.g., physically depressible), solid-state, intensity-sensitive, and/or touch-sensitive (e.g., capacitive) buttons and/or surfaces; one or more audio input devices, such as microphones or vibration sensors; one or more optical input devices, such as cameras and/or depth sensors), and a plurality of cameras including a first camera and a second camera that is different from the first camera (e.g., a camera array/stereo camera for spatial capture, where the first camera and the second camera are located a distance apart, such that the perspective of the first camera is different from the perspective of the second camera and thus at least a portion of a field of view of the first camera is outside of a field of view of the second camera). In some embodiments, the plurality of cameras includes one or more rear (e.g., user-facing) cameras and/or one or more forward (e.g., environment-facing) cameras. In some embodiments, the plurality of cameras includes a plurality of cameras with different lenses/lens types, such as a standard camera, a telephoto camera, and/or a wide-angle camera. In some embodiments, the computer system is optionally configured to communicate with one or more sensors, such as camera sensors, optical sensors, depth sensors, capacitive sensors, intensity sensors, motion sensors, vibration sensors, and/or audio sensors. Some operations in method 1100 are, optionally, combined, the orders of some operations are, optionally, changed, and some operations are, optionally, omitted.

As described below, method 1100 provides an intuitive way of controlling spatial media captures. The method reduces the cognitive burden on a user when controlling spatial media captures, thereby creating a more efficient human-machine interface. For battery-operated computing devices, enabling a user to control spatial media captures faster and more efficiently conserves power and increases the time between battery charges.

The computer system displays (1102), via the one or more display generation components, a spatial media capture user interface (e.g., 608) (e.g., of a camera application) that includes a spatial capture type user interface object (e.g., 1014, 1014A, and/or 1014B) (e.g., a toggle, a plurality of options, and/or a slider). In some embodiments, the computer system changes between different capture types in the spatial capture mode in response to detecting input directed to the spatial capture type user interface object. In some embodiments, the spatial capture type user interface object includes one or more elements (e.g., e.g., icons, text, and/or selectable user interface elements) representing the plurality of different types of spatial media (e.g., a point-and-shoot camera icon and a video camera icon, text reading “photo” and “video,” and/or separately selectable buttons or menu items).

While displaying the spatial media capture user interface (e.g., as described with respect to FIGS. 10C-10J), the computer system detects (1104), via the one or more input devices, an input (e.g., 1020B, 1028A, 1028B, 1036A, and/or 1036B) directed to the spatial capture type user interface object while a spatial capture mode is configured to capture a respective type of spatial media of a plurality of different types of spatial media. In some embodiments, the input includes a touch, tap, press, gesture, and/or air gesture directed to the spatial capture type user interface object in the media capture user interface, for instance, detected via a touch-sensitive display of the one or more display generation components and/or another hardware input device.

In response to detecting the input directed to the spatial capture type user interface object, the computer system changes (1106) a type of spatial media that the spatial capture mode is configured to capture (e.g., as described with respect to FIGS. 10G and/or 10J). After changing the type of spatial media that the spatial capture mode is configured to capture, the computer system detects (1108), via the one or more input devices, a request (e.g., 1022A, 1022B, 1030A, 1030B, 1034A, 1034B, 1040A, and/or 1040B) to capture media using the spatial media capture user interface (e.g., of a camera application). In response to detecting the request to capture media, the computer system captures (1110) respective spatial media that includes stereoscopic depth information captured by two or more of the plurality of cameras.

In accordance with a determination that the spatial capture mode is configured to capture a first type of spatial media of the plurality of different types of spatial media when the request to capture media is detected (1112), the respective spatial media is the first type of spatial media (e.g., as described with respect to FIGS. 10H-10I) (e.g., one or more spatial photos with stereoscopic depth information). In some embodiments, the spatial photo includes spatial media content such as depth information associated with the captured image(s). In some embodiments, the spatial photo includes still (e.g., single-frame) photo media. In some embodiments, the spatial photo includes photo media with a limited (e.g., 0.5 s, 1 s, 3 s, and/or 5 s) duration, such as a multi-frame capture that includes content (e.g., frames) from before and/or after a capture input is detected, creating a “live” effect. In some embodiments, the spatial photo includes one or more images (e.g., frames) that are displayed in sequence, such as a media item that saved in the graphical interface file format.

In accordance with a determination that the spatial capture mode is configured to capture a second type of spatial media of the plurality of different types of spatial media when the request to capture media is detected (1114), the respective spatial media is the second type of spatial media (e.g., as described with respect to FIG. 10E) (e.g., a stereoscopic video), wherein the first type of spatial media has a fixed duration (e.g., the first type of spatial media includes a still (e.g., single-frame) photo and/or a photo media with a limited duration, such as a multi-frame capture that includes one or more frames corresponding to a time of the request to capture spatial media and one or more frames corresponding to a time before and/or after the request) and the second type of spatial media has a variable duration determined based on user input (e.g., based on a time when recording of the spatial media was started and stopped based on start and stop user inputs). For example, the captured duration of the second type of spatial media varies based on the duration of a user input requesting to capture media and/or the time elapsed between one or more requests to capture media and one or more requests to pause or stop capturing media (e.g., as described with respect to FIGS. 6A-7B). In some embodiments, the spatial video includes spatial media content such as depth information associated with the captured video. Providing a spatial media capture user interface with a spatial capture type control provides improved control of media capture, reducing the time and number of inputs needed to perform different spatial capture operations, including capture operations of limited duration (e.g., spatial photo captures) and capture operations of variable duration (e.g., spatial video captures). Doing so assists the user with composing spatial media captures and reduces the risk that transient media capture opportunities are missed or captured in an unintended manner, which makes the spatial media capture user interface more efficient (e.g., reducing power usage and/or improving battery life of the system by enabling the user to capture media more quickly and efficiently). For example, the spatial media capture user interface with the spatial capture type control allows users to efficiently switch between performing limited- and variable-duration spatial captures with a consistent user interface, which also helps the user to provide proper inputs via the user interface.

In some embodiments, the first type of spatial media includes a plurality of spatial images (e.g., spatial photo frames) that are captured, via the plurality of cameras (In some embodiments, using two more cameras of the plurality of cameras), at a respective plurality of times (e.g., sequentially) during a period of the fixed duration (e.g., as described with respect to FIGS. 10H-10I). For example, spatial photos are captured with multiple frames that, when viewed in succession, create a “live” photo effect. In some embodiments, the period of the fixed duration spans the before, during, and/or after detecting the request to capture media, e.g., the plurality of images include images captured before, during, and/or after detecting the request to capture media. In some embodiments, the first type of spatial media includes stereoscopic depth information corresponding to each of the plurality of images, e.g., stereoscopic depth information is captured using two or more of the plurality of cameras at the respective plurality of times during the period of the fixed duration. In some embodiments, in response to an input requesting to view captured media of the first type of spatial media, the computer system displays the captured media, including displaying the plurality of spatial images in succession (e.g., as an animation and/or short video). Capturing spatial photo media that includes multiple, sequentially-captured frames assists the user with composing spatial media captures and reduces the risk that transient media capture opportunities are missed or captured in an unintended manner, which makes the spatial media capture user interface more efficient (e.g., reducing power usage and/or improving battery life of the system by enabling the user to capture media more quickly and efficiently). For example, doing so reduces the number of inputs needed to capture spatial photo media (e.g., by capturing multiple frames without requiring additional user inputs) and provides a desirable “live” photo effect.

In some embodiments, changing the type of spatial media that the spatial capture mode is configured to capture includes changing an aspect ratio of spatial media that the spatial capture mode is configured to capture (e.g., as illustrated in FIGS. 10F-10G and/or 10I-10J). In some embodiments, the first type of spatial media includes spatial media captured, via the plurality of cameras, at a first aspect ratio (e.g., as described with respect to FIGS. 10G-10H) (e.g., 1:1, 3:2, and/or 4:3). In some embodiments, captured media of the first type includes a representation of a field-of-view of the plurality of cameras cropped to the first aspect ratio. In some embodiments, the second type of spatial media includes spatial media captured, via the plurality of cameras, at a second aspect ratio different from the first aspect ratio (e.g., as described with respect to FIG. 10E) (e.g., 4:3, 14:9, 16:9, or another aspect ratio). In some embodiments, captured media of the second type includes a representation of a field-of-view of the plurality of cameras cropped to the second aspect ratio. In some embodiments, while displaying the spatial media capture user interface, in accordance with a determination that the spatial capture mode is configured to capture the first type of spatial media, the computer system displays a camera preview region of the spatial media capture user interface with the first aspect ratio (e.g., cropped to the first aspect ratio and/or with a border or reticle indicating a capture area of the first aspect ratio), and in accordance with a determination that the spatial capture mode is configured to capture the second type of spatial media, the computer system displays a camera preview region of the spatial media capture user interface with the second aspect ratio. In some embodiments, changing the aspect ratio of spatial media that the spatial capture mode is configured to capture includes displaying the aspect ratio of the camera preview region changing. Using the spatial capture user interface to capture different types of spatial media at different aspect ratios assists the user with composing spatial media captures and reduces the risk that transient media capture opportunities are missed or captured in an unintended manner (e.g., with an unsuitable aspect ratio), which makes the spatial media capture user interface more efficient (e.g., reducing power usage and/or improving battery life of the system by enabling the user to capture media more quickly and efficiently).

In some embodiments, displaying the spatial media capture user interface (e.g., 608) includes displaying, via the one or more display generation components, a media capture user interface object (e.g., 610A) (e.g., a software shutter button that, when selected, initiates capturing media with the plurality of cameras). In some embodiments, the request to capture media includes an input directed to the media capture user interface object. In some embodiments, in response to detecting the input (e.g., 1020B, 1028A, 1028B, 1036A, and/or 1036B) directed to the spatial capture type user interface object (e.g., 1014, 1014A, and/or 1014B) (e.g., the input changing the spatial capture type), the computer system changes an appearance of the media capture user interface object (e.g., as illustrated in FIGS. FIGS. 10F-10G and/or 10I-10J) (e.g., changing a shape, size, color, opacity, pattern, texture, and/or other graphical characteristics of one or more elements of the media capture user interface object). In some embodiments, in accordance with a determination that the type of spatial media that the capture mode is configured to capture is changed to the first type of spatial media, the appearance of the media capture user interface is changed to a first appearance, and in accordance with a determination that the type of spatial media that the capture mode is configured to capture is changed to the second type of spatial media, the appearance of the media capture user interface is changed to a second appearance. For example, when the spatial capture mode is changed to a photo capture mode, the media capture user interface object is displayed with a photo capture button appearance (e.g., a solid white circle inside a white ring), and when the spatial capture mode is changed to a video capture mode, the media capture user interface object is displayed with a video capture button appearance (e.g., a solid red circle inside a while ring). Changing the appearance of a media capture button in response to an input changing the type of spatial media being captured provides users with improved visual feedback about a state of the computer system without cluttering the display, which assists the user with control of the computer system via the media capture user interface. For example, the change to the media capture button intuitively indicates to a user that the capture type is being changed and/or what the capture type is being changed to without displaying additional content that obscures or distracts from the media capture.

In some embodiments, while displaying the spatial media capture user interface and in accordance with a determination that a set of one or more alert criteria (e.g., a set of one or more criteria indicating that current capture conditions may detrimentally impact capture quality) is satisfied, the computer system displays, via the one or more display generation components, a respective alert indicator (e.g., 1026A and/or 1026B) (e.g., a capture instruction, a warning, and/or an error message corresponding to the alert criterion). For example, the alert criterion is a criterion satisfied when a detected state of the environment being captured via the plurality of cameras (e.g., light levels) and/or a state of the computer system with respect to the environment (e.g., position, motion, and/or alignment) are likely to result in a spatial capture of reduced quality. In some embodiments, the respective alert criterion and corresponding respective alert indicator are included in a set of alert criteria with corresponding alert indicators, such as a low-light criterion corresponding to a “more light” alert, an insufficient distance criterion corresponding to a “move farther away” alert, an excessive distance criterion corresponding to a “move closer” alert, and/or a misalignment criterion corresponding to a camera orientation indicator (e.g., an indicator showing the current aligntment of the first camera and second camera relative to each other and/or relative to a target orientation, such that the user can monitor when the cameras used for spatial capture are horizontally aligned). For example, when a low-light criterion (e.g., a criterion satisfied when the detected light level of the environment being captured via the plurality of cameras and/or the determined brightness level of the camera preview falls below a respective threshold) is satisfied, the computer system displays a “more light” warning. For example, when an insufficient distance criterion (e.g., a criterion satisfied when the plurality of cameras are too close to a subject to effectively capture the subject in a spatial capture) is satisfied, the computer system displays a “move farther away” warning. In some embodiments, while displaying the respective alert indicator, in accordance with a determination that the respective alert criterion is no longer satisfied, the computer system ceases displaying the respective alert indicator. In some embodiments, in response to detecting the input (e.g., 1020B, 1028A, 1028B, 1036A, and/or 1036B) directed to the spatial capture type user interface object (e.g., 1014, 1014A, and/or 1014B) (e.g., the input changing the spatial capture type) and in accordance with a determination that the input directed to the spatial capture type user interface object was detected while the set of one or more alert criteria were met (e.g., and while displaying the respective alert indicator), the computer system maintains displaying the respective alert indicator (e.g., as described with respect to FIGS. 10F-10G and/or 10I-10J). For example, alert indicators persist when switching between spatial capture types. In some embodiments, while maintaining displaying the respective alert indicator in the changed capture mode, in accordance with a determination that the respective alert criterion is no longer satisfied, the computer system ceases displaying the respective alert indicator. Maintaining the display of a capture alert (e.g., alerting the user to conditions that may affect the quality of a spatial media capture) when switching between spatial capture types provides users with improved visual feedback about a state of the computer system and assists the user with composing spatial media captures and reduces the risk that transient media capture opportunities are missed or captured in an unintended manner, which makes the spatial media capture user interface more efficient (e.g., reducing power usage and/or improving battery life of the system by enabling the user to capture media more quickly and efficiently). For example, by maintaining display of an alert when switching between spatial photo and spatial video captures, the user can view and respond to the alert (e.g., continuing to compose media as desired) without interruption or waiting for the type switch to complete.

In some embodiments, detecting the request to capture media using the spatial media capture user interface includes detecting, via the one or more input devices, an input directed to a media capture user interface object (e.g., 610A) (e.g., a software shutter button that, when selected, initiates capturing media with the plurality of cameras). In some embodiments, the input directed to the media capture user interface is detected via a touch-sensitive surface of the display generation components. In some embodiments, capturing the respective spatial media that includes the stereoscopic depth information captured by two or more of the plurality of cameras (e.g., in response to the input directed to the media capture user interface object) includes, in accordance with a determination that the spatial capture mode is configured to capture the first type of spatial media of the plurality of different types of spatial media when the request to capture media is detected, capturing spatial media of the first type (e.g., spatial media with a fixed duration) using the plurality of cameras (e.g., as described with respect to FIGS. 10G-10I). For example, the media capture user interface object acts as a photo shutter button for triggering a fixed-duration capture (e.g., a still or multi-frame capture of a limited duration). In some embodiments, capturing the respective spatial media that includes the stereoscopic depth information captured by two or more of the plurality of cameras includes, in accordance with a determination that the spatial capture mode is configured to capture the second type of spatial media of the plurality of different types of spatial media when the request to capture media is detected, initiating capturing spatial media of the second type (e.g., as described with respect to FIG. 10E) (e.g., spatial media with a flexible duration, such as video) using the plurality of cameras. For example, the media capture user interface object acts as a video record button for starting a video capture. In some embodiments, after initiating capturing the spatial media of the second type, the computer system continues to capture the spatial media of the second type (e.g., continues recording spatial video) until paused or stopped. In some embodiments, after initiating capturing the spatial media of the second type, in response to another input directed to the media capture user interface object, the computer system ceases capturing the spatial media (e.g., the media capture user interface acts as a stop recording button once video capture has been initiated, e.g., as described above with respect to FIGS. 6A-7B). Changing the function of a media capture button based on the type of spatial media the spatial capture mode is currently configured to capture provides additional control options without cluttering the user interface with additional displayed controls and reduces the time and number of inputs needed to perform different spatial capture operations. Doing so assists the user with composing spatial media captures and reduces the risk that transient media capture opportunities are missed or captured in an unintended manner, which makes the spatial media capture user interface more efficient (e.g., reducing power usage and/or improving battery life of the system by enabling the user to capture media more quickly and efficiently). For example, using the same button to perform spatial photo captures and to initiate spatial video captures allows users to efficiently and ergonomically capture different types of spatial media.

In some embodiments, the one or more input devices includes a first hardware button (e.g., 602A, 602B, and/or 602C). In some embodiments, the first hardware button includes a mechanical button, such as a button that can be physically depressed to one or more states. In some embodiments, the first hardware button includes a solid-state button, such as a button that simulates the tactile sensation (e.g., via tactile/haptic output generators) of pressing a mechanical button. In some embodiments, the first hardware button includes one or more sensors, such as pressure sensors, touch sensors, capacitive sensors, and/or motion sensors. In some embodiments, detecting the request to capture media using the spatial media capture user interface includes detecting, via the first hardware button, an input (e.g., 1022B, 1030B, 1034A, 1034B, and/or 1040B) (e.g., a press and/or a press-and-hold) requesting to capture media (e.g., the request to capture media includes a hardware button input). In some embodiments, capturing the respective spatial media that includes the stereoscopic depth information captured by two or more of the plurality of cameras (e.g., in response to the hardware button input) includes, in accordance with a determination that the spatial capture mode is configured to capture the first type of spatial media of the plurality of different types of spatial media when the request to capture media is detected, capturing spatial media of the first type (e.g., as described with respect to FIGS. 10G-10I) (e.g., spatial media with a fixed duration) using the plurality of cameras; and For example, the hardware button acts as a photo shutter button for triggering a fixed-duration capture (e.g., a still or multi-frame capture of a limited duration). In some embodiments, capturing the respective spatial media that includes the stereoscopic depth information captured by two or more of the plurality of cameras includes, in accordance with a determination that the spatial capture mode is configured to capture the second type of spatial media of the plurality of different types of spatial media when the request to capture media is detected, initiating capturing spatial media of the second type (e.g., as described with respect to FIG. 10E) (e.g., spatial media with a flexible duration, such as video) using the plurality of cameras. For example, the hardware button acts as a video record button for starting a video capture. In some embodiments, after initiating capturing the spatial media of the second type, the computer system continues to capture the spatial media of the second type (e.g., continues recording spatial video) until paused or stopped. In some embodiments, after initiating capturing the spatial media of the second type, in response to another input directed to the first hardware button, the computer system ceases capturing the spatial media of the second type (e.g., the hardware button acts as a stop recording button once video capture has been initiated). Changing the function of a hardware button based on the type of spatial media the spatial capture mode is currently configured to capture provides additional control options without cluttering the user interface with additional displayed controls and reduces the time and number of inputs needed to perform different spatial capture operations. Doing so assists the user with composing spatial media captures and reduces the risk that transient media capture opportunities are missed or captured in an unintended manner, which makes the spatial media capture user interface more efficient (e.g., reducing power usage and/or improving battery life of the system by enabling the user to capture media more quickly and efficiently). For example, using the same hardware button to perform spatial photo captures and to initiate spatial video captures allows users to efficiently and ergonomically capture different types of spatial media.

In some embodiments, while displaying the spatial media capture user interface, the computer system displays, via the one or more display generation components, an indication of the type of spatial media that the spatial capture mode is configured to capture (e.g., 1014, 1014A, and/or 1014B). For example, the indication includes text, icons, pictures, and/or other graphics representing whether the first type of spatial media or the second type of spatial media (e.g., and/or another type of the plurality of different types of spatial media) is currently selected. In some embodiments, the indication of the type of spatial media that the spatial capture mode is configured to capture is included in the spatial capture type user interface object. For example, the spatial capture type user interface object includes one or more software switches, buttons, toggles, sliders, and/or menus that reflect the currently-selected spatial capture type. In some embodiments, in response to detecting the input (e.g., 1020B, 1028A, 1028B, 1036A, and/or 1036B) directed to the spatial capture type user interface object (e.g., the input requesting to change the type of spatial media that the spatial capture mode is configured to capture), the computer system changes an appearance of the indication of the type of spatial media that the spatial capture mode is configured to capture (e.g., as described with respect to FIGS. 10F-10G and/or 10I-10J) (e.g., while maintaining displaying the indication). In some embodiments, in accordance with a determination that the spatial capture mode is configured to capture the first type of spatial media of the plurality of different types of spatial media, the computer system displays the indication with a first appearance, and in accordance with a determination that the spatial capture mode is configured to capture the second type of spatial media of the plurality of different types of spatial media, the computer system displays the indication with a second appearance different from the first appearance. Displaying a persistent capture type indicator that updates when the spatial capture type is changed (e.g., between fixed- and variable-capture types) provides users with improved visual feedback about a state of the computer system without cluttering the display, which assists the user with control of the computer system via the media capture user interface. For example, the capture type indicator both indicates to the user that the computer system is in the spatial capture mode and the type of spatial capture the spatial capture mode is currently configured to capture.

In some embodiments, changing the type of spatial media that the spatial capture mode is configured to capture includes, in accordance with a determination that the input directed to the spatial capture type user interface object corresponds to a request to configure the media capture user interface for capturing the first type of spatial media (e.g., as described with respect to FIG. 10F) (e.g., spatial media of a limited duration, e.g., a still or multi-frame spatial photo), configuring the media capture user interface for capturing the first type of spatial media (e.g., as described with respect to FIG. 10G). In some embodiments, the input directed to the spatial capture type user interface object corresponds to a request to configure the media capture user interface for capturing the first type of spatial media when the input has certain detected characteristics and/or when the input is detected in a particular context, for example, an input directed to a particular location (e.g., a dedicated photo button or control), moving in a particular direction (e.g., sliding or swiping to select the photo type), and/or received while a type of spatial media other than the first type of spatial media is detected (e.g., toggling or cycling between the plurality of spatial capture types). In some embodiments, changing the type of spatial media that the spatial capture mode is configured to capture includes, in accordance with a determination that the input directed to the spatial capture type user interface object corresponds to a request to configure the media capture user interface for capturing spatial video media (e.g., as described with respect to FIG. 10I), configuring the media capture user interface for capturing spatial video media (e.g., as described with respect to FIG. 10J). In some embodiments, the input directed to the spatial capture type user interface object corresponds to a request to configure the media capture user interface for capturing the second type of spatial media when the input has certain detected characteristics and/or when the input is detected in a particular context., for example, an input directed to a particular location (e.g., a dedicated video button or control), moving in a particular direction (e.g., sliding or swiping to select the video type), and/or received while a type of spatial media other than the second type of spatial media is detected (e.g., toggling or cycling between the plurality of spatial capture types). Switching between configuring the media user interface for one type of media capture and another type of media capture based on user input enables the computer system to quickly transition between states for capturing media based on the user's preferences, thereby improving the man-machine interface.

In some embodiments, the input directed to the spatial capture type user interface object corresponds to a request to configure the media capture user interface for capturing the first type of spatial media when the input directed to the spatial capture type user interface object is directed to a first portion of the spatial capture type user interface object (e.g., 1028B), wherein the first portion corresponds to the first type of spatial media (e.g., as described with respect to FIG. 10F). For example, the input selects a dedicated photo button, menu item, toggle position, and/or other discrete component of the spatial capture type control. In some embodiments, the input directed to the spatial capture type user interface object corresponds to a request to configure the media capture user interface for capturing the second type of spatial media when the input directed to the spatial capture type user interface object is directed to a second portion of the spatial capture type user interface object that is different from the first portion (e.g., 1036B), wherein the second portion corresponds to the second type of spatial media (e.g., as described with respect to FIG. 10I). For example, the input selects a dedicated video button, menu item, toggle position, and/or other discrete component of the spatial capture type control. Configuring the media user interface between one type of media capture and another type of media capture based on user input enables the computer system to quickly transition between states for capturing media based on the user's preferences, thereby improving the man-machine interface.

In some embodiments, the input directed to the spatial capture type user interface object corresponds to a request to configure the media capture user interface for capturing the first type of spatial media when the input directed to the spatial capture type user interface object (e.g., 1028A and/or 1028B) is detected while the spatial capture mode is configured to capture the second type of spatial media (e.g., as described with respect to FIG. 10F). In some embodiments, the second type of spatial media is deselected when the first type of spatial media is selected. In some embodiments, the input directed to the spatial capture type user interface object corresponds to a request to configure the media capture user interface for capturing the second type of spatial media when the input directed to the spatial capture type user interface object (e.g., 1036A and/or 1036B) is detected while the spatial capture mode is configured to capture the first type of spatial media (e.g., as described with respect to FIG. 10I). In some embodiments, the first type of spatial media is deselected when the second type of spatial media is selected. For example, selecting the spatial capture type user interface object toggles between the first type of spatial media (e.g., spatial photo) and the second type of spatial media (e.g., spatial video). Configuring the media user interface between one type of media capture and another type of media capture based on user input enables the computer system to quickly transition between states for capturing media based on the user's preferences, thereby improving the man-machine interface.

In some embodiments, in response to detecting the input directed to the spatial capture type user interface object (e.g., the input requesting to change the type of spatial media that the spatial capture mode is configured to capture), the computer system (e.g., 600) maintains displaying at least a portion of the spatial media capture user interface with an unchanged appearance (e.g., 608G) (e.g., foregoing changing an appearance of at least a portion of the spatial media capture user interface). For example, one or more control objects (e.g., software buttons for media capture settings and operations), indicator objects (e.g., alerts, status indicators, and/or capture guides), and/or other graphical elements of the spatial media capture user interface are displayed in the same way (e.g., with a consistent appearance) whether the spatial capture mode is configured to capture spatial photo media or spatial video media. For example, a mode selection user interface object remains displayed with the spatial capture mode selected. Maintaining displaying a spatial media capture user interface while changing a spatial capture type via a spatial capture type control provides improved control of media capture, reducing the time and number of inputs needed to perform different spatial capture operations, including capture operations of limited duration (e.g., spatial photo captures) and capture operations of variable duration (e.g., spatial video captures). Doing so assists the user with composing spatial media captures and reduces the risk that transient media capture opportunities are missed or captured in an unintended manner, which makes the spatial media capture user interface more efficient (e.g., reducing power usage and/or improving battery life of the system by enabling the user to capture media more quickly and efficiently). For example, the spatial media capture user interface with the spatial capture type control allows users to efficiently switch between performing limited- and variable-duration spatial captures with a consistent user interface, which also helps the user to provide proper inputs via the user interface.

In some embodiments, while displaying, via the one or more display generation components, a respective user interface that is different from the spatial media capture user interface (e.g., as described with respect to FIGS. 10A-10B), the computer system (e.g., 600) detects, via the one or more input devices, a set of one or more inputs corresponding to a request to enter the spatial capture mode (e.g., 1004A, 1004B, 1004C, 1010A, 1010B, and/or 1010C). In some embodiments, the respective user interface is a camera user interface for a capture mode other than the spatial capture mode (e.g., a standard photo or video capture mode, a portrait photo mode, and/or a cinematic video capture mode). In some embodiments, the request to enter the spatial capture mode includes an input directed to a capture mode control (e.g., different from the spatial capture type user interface object; e.g., a button, menu, and/or slider user interface object) for selecting the spatial capture mode and/or a standard photo or video capture mode, a portrait photo mode, and/or a cinematic video capture mode, e.g., within a camera application. In some embodiments, the respective user interface is a non-camera user interface, such as a home screen user interface, lock screen user interface, or other application user interface. In some embodiments, the set of one or more inputs includes one or more touch, tap, press, gesture, and/or air gesture inputs, such as inputs directed to the capture mode control in the media capture user interface and/or directed to/detected by a hardware button associated with the capture mode control (e.g., tapping an item corresponding to a spatial capture mode displayed in the capture mode control). In some embodiments, the set of one or more inputs includes a movement component, such as a swipe, drag, and/or flick gesture, for instance, detected via a touch-sensitive display of the one or more display generation components and/or the hardware button associated with the capture mode control (e.g., swiping across the capture mode control to select the item corresponding to the spatial capture mode, e.g., sliding the spatial capture mode item to the center and/or another “selected” position). In some embodiments, in response to detecting the request to enter the spatial capture mode, the computer system (e.g., 600) displays (e.g., initially displaying), via the one or more display generation components, the spatial media capture user interface that includes the spatial capture type user interface object (e.g., 1014, 1014A, and/or 1014B) and configures the spatial capture mode to capture the second type of spatial media (e.g., as described with respect to FIGS. 10C-10D) (e.g., the spatial media type of a variable duration, e.g., the spatial video type). For example, the spatial media capture user interface defaults to capturing video in the spatial capture mode and provides the spatial capture type user interface object to allow users to switch to other spatial capture types (e.g., the first type of spatial media). Initially configuring the spatial capture mode to capture spatial media of a variable duration (e.g., spatial video media) when the spatial media capture user interface is opened assists the user with composing spatial media captures and reduces the risk that transient media capture opportunities are missed or captured in an unintended manner, which makes the spatial media capture user interface more efficient (e.g., reducing power usage and/or improving battery life of the system by enabling the user to capture media more quickly and efficiently). For example, users can quickly initiate spatial video captures upon entering the spatial capture mode, reducing the likelihood that dynamic content will be missed or mis-captured while waiting or detecting user inputs to select the video capture type.

In some embodiments, the computer system changes the type of spatial media that the spatial capture mode is configured to capture to a respective type of spatial media, different from the second type of spatial media, of the plurality of different types of spatial media (e.g., as described with respect to FIG. 10G). In some embodiments, the respective type of spatial media is the first type of spatial media (e.g., the spatial photo type). In some embodiments, after changing the type of spatial media that the spatial capture mode is configured to capture to the respective type of spatial media the computer system detects, via the one or more input devices, a set of one or more inputs corresponding to a request to display the spatial capture mode (e.g., 1004A, 1004B, 1004C, 1010A, 1010B, and/or 1010C) (e.g., selection of a spatial capture mode while in a camera application such as a tap, click, or air pinch directed to a spatial capture mode affordance, a swipe on a live preview of a different camera mode, and/or a tap, click, or air pinch directed to a camera launch affordance). In some embodiments, in response to detecting the set of one or more inputs corresponding to the request to display the spatial capture mode, the computer system displays a user interface for the spatial capture mode (e.g., as described with respect to FIGS. 10C-10J) (e.g., including a live preview of a field of view of one or more of the cameras and an affordance for initiating capture of spatial media). In some embodiments, displaying the user interface for the spatial capture mode includes, in accordance with a determination that a set of one or more inactivity criteria is satisfied, displaying the user interface for the spatial capture mode configured to capture the second type of spatial media (e.g., as described with respect to FIGS. 10D-10F and/or 10J), wherein the set of one or more inactivity criteria includes a criterion that is met when a threshold period of time (e.g., ten seconds, thirty seconds, one minute, five minutes, or thirty minutes) has elapsed without detecting, via the one or more input devices, an input directed to the spatial media capture user interface (e.g., as described with respect to FIG. 10J). For example, the spatial capture mode reverts to spatial video capture after the threshold period of time if the user is not actively interacting with the spatial media capture user interface and/or if the user has navigated away from the spatial media capture user interface (e.g., using the camera application in a non-spatial media capture mode and/or closing the camera application, such that when the user navigates back to the spatial media capture user interface, the spatial media capture mode is configured to capture spatial video). In some embodiments, if the inactivity criteria are satisfied while displaying the spatial media capture user interface, configuring the spatial capture mode to capture the second type of spatial media includes updating the display of the spatial capture mode, e.g., to a video capture appearance (e.g., as illustrated in FIG. 10D). In some embodiments, displaying the user interface for the spatial capture mode includes, in accordance with a determination that a set of one or more inactivity criteria is satisfied, displaying the user interface for the spatial capture mode configured to capture the first type of spatial media (e.g., as described with respect to FIGS. 10G-10J) (e.g., and foregoing configuring the spatial capture mode to capture the second type of spatial media) (e.g., maintaining the respective type of spatial media as the type of spatial media that the spatial capture mode is configured to capture). For example, the spatial capture mode does not revert to spatial video capture after the threshold period of time if the user is actively interacting with the spatial media capture user interface, e.g., even if the user temporarily navigates away from the spatial media capture user interface (e.g., briefly using the camera application in a non-spatial media capture mode and/or closing the camera application, such that when the user navigates back to the spatial media capture user interface, the spatial media capture mode remains configured to capture the previously-selected spatial capture type). Reverting configuring the spatial capture mode to capture spatial media of a variable duration (e.g., spatial video media) when the spatial media capture user interface is inactive for a threshold period of time assists the user with composing spatial media captures and reduces the risk that transient media capture opportunities are missed or captured in an unintended manner, which makes the spatial media capture user interface more efficient (e.g., reducing power usage and/or improving battery life of the system by enabling the user to capture media more quickly and efficiently). For example, users can quickly initiate spatial video captures after a period of inactivity or performing other operations, reducing the likelihood that dynamic content will be missed or mis-captured while waiting or detecting user inputs to select the video capture type.

In some embodiments, while displaying, via the one or more display generation components, a respective user interface that is different from the spatial media capture user interface (e.g., as described with respect to FIGS. 10A-10B), the computer system detects, via the one or more input devices, a set of one or more inputs (e.g., 1004A, 1004B, 1004C, 1010A, 1010B, and/or 1010C) corresponding to a request to enter the spatial capture mode. In some embodiments, the respective user interface is a camera user interface for a capture mode other than the spatial capture mode (e.g., a standard photo or video capture mode, a portrait photo mode, and/or a cinematic video capture mode). In some embodiments, the request to enter the spatial capture mode includes an input directed to a capture mode control (e.g., different from the spatial capture type user interface object) for selecting the spatial capture mode, a standard photo or video capture mode, a portrait photo mode, and/or a cinematic video capture mode, e.g., within a camera application. In some embodiments, the respective user interface is a non-camera user interface, such as a home screen user interface, lock screen user interface, or other application user interface. In some embodiments, the set of one or more inputs includes one or more touch, tap, press, gesture, and/or air gesture inputs, such as inputs directed to the capture mode control in the media capture user interface and/or directed to/detected by a hardware button associated with the capture mode control (e.g., tapping an item corresponding to a spatial capture mode displayed in the capture mode control). In some embodiments, the set of one or more inputs includes a movement component, such as a swipe, drag, and/or flick gesture, for instance, detected via a touch-sensitive display of the one or more display generation components and/or the hardware button associated with the capture mode control (e.g., swiping across the capture mode control to select the item corresponding to the spatial capture mode, e.g., sliding the spatial capture mode item to the center and/or another “selected” position). In some embodiments, in response to detecting the request to enter the spatial capture mode, the computer system displays (e.g., initially displaying), via the one or more display generation components, the spatial media capture user interface (e.g., as described with respect to FIGS. 10C-10D) and displays (e.g., initially displaying), via the one or more display generation components, the spatial capture type user interface object (e.g., 1014, 1014A, and/or 1014B) (e.g., the toggle, plurality of options, and/or slider). In some embodiments, the spatial capture type user interface object includes one or more elements (e.g., e.g., icons, text, and/or selectable user interface elements) representing the plurality of different types of spatial media (e.g., a point-and-shoot camera icon and a video camera icon, text reading “photo” and “video,” and/or separately selectable buttons or menu items). Displaying the spatial capture type user interface object in response to detecting the request to enter the spatial capture mode provides the user with visual feedback about the mode that the computer system is in (e.g., a spatial capture mode), thereby providing improved visual feedback.

In some embodiments, while displaying the spatial media capture user interface, the computer system detects, via the one or more input devices, an input including a movement component in a respective direction (e.g., 1042B) (e.g., with respect to the spatial media capture user interface). In some embodiments, the input is an input directed to a mode control object, e.g., of a camera application in which the spatial media capture user interface is included. For example, the movement is a gesture in a lateral direction along the mode control object, e.g., a vertical swipe or flick across a capture mode control object when the camera application is in a landscape orientation. In some embodiments, the input is an input directed to a particular region, e.g., a camera preview region. For example, the movement is a gesture in a lateral direction across and/or from an edge of a camera preview, e.g., a vertical swipe or flick across a camera preview region when the camera application is in a landscape orientation. In some embodiments, the input includes one or more touch, tap, press, gesture, and/or air gesture inputs, such as inputs directed to a camera user interface (e.g., via a touch-sensitive surface) and/or directed to/detected by a hardware button associated with the camera user interface. In response to detecting the input including the movement component in the respective direction, the computer system displays, via the display generation component, a respective media capture user interface, different from the spatial media capture user interface, for a respective capture mode different from the spatial capture mode and ceases displaying the spatial media capture user interface (e.g., as described with respect to FIG. 10K). For example, the respective media capture interface is a media capture interface for a standard (e.g., non-spatial) photo capture mode (e.g., as described with respect to FIGS. 6B, 8A, and/or 10K), a standard video (e.g., non-spatial) capture mode (e.g., as described with respect to FIGS. 6C and/or 10A-10B), a portrait photo capture mode (e.g., as described with respect to FIG. 8V), a cinematic video capture mode, and/or a panoramic photo capture mode. For example, the respective media capture interface is a different capture interface (e.g., for a different capture mode) displayed within the same camera application as the spatial media capture user interface. In some embodiments, while displaying the respective media capture user interface, the computer system detects, via the one or more input devices, a request to capture media using the respective media capture user interface; and in response, the computer system captures standard media using one or more of the plurality of cameras. In some embodiments, the standard media does not include stereoscopic depth information and/or includes a smaller and/or less detailed amount of stereoscopic depth information than the respective spatial media capture. Providing a media capture user interface for a non-spatial capture mode in response to a movement input in a particular direction provides additional control options for media capture without cluttering the display, which assists the user with control of the computer system via the media capture user interface. For example, swiping to change a capture mode allows users to efficiently and intuitively switch between spatial and non-spatial captures, e.g., without needing to display additional content that obscures or distracts from the media capture.

In some embodiments, the respective media capture user interface includes a first set of capture control objects (e.g., 608A, 608B, 608C, 608D, 608E, 608F, 608G, 608H, and/or 608I) including at least a first capture control object that, when selected (e.g., via the one or more input devices), initiates performing a respective media capture operation. In some embodiments, the respective media capture operation includes adjusting a respective setting, e.g., changing flash mode, applying a filter, changing a media format). In some embodiments, the respective media capture operation includes adjusting a setting to a respective value, e.g., selecting a particular frame rate, selecting a particular resolution, and/or selecting a particular exposure. In some embodiments, the spatial media capture user interface includes a second set of capture control objects (e.g., 608B, 608E, 608F, 608G, 608H, and/or 608I), wherein the second set of capture control objects does not include the first capture control object (e.g., 608A, 608C, and/or 608D). In some embodiments, performance of the respective media capture operation cannot be initiated from the spatial media capture user interface (e.g., an input directed to the location where the first capture control object was displayed in the respective media capture user interface will not result in performance of the respective media capture operation.). In some embodiments, the second set of capture control objects includes fewer capture control objects than the first set of capture control objects. Displaying the spatial media capture user interface without media capture controls included in non-spatial media capture user interfaces provides additional control options without cluttering the user interface with additional displayed controls. Doing so assists the user with composing media captures and reduces the risk that transient media capture opportunities are missed or captured in an unintended manner by helping the user to provide proper inputs and reduce user mistakes while capturing media, which makes the media capture user interface more efficient (e.g., reducing power usage and/or improving battery life of the system by enabling the user to capture media more quickly and efficiently). For example, removing capture controls that are unavailable and/or incompatible with the spatial capture mode reduces visual clutter while capturing spatial media, while still providing the user with additional capture controls in other capture modes.

Note that details of the processes described above with respect to method 1100 (e.g., FIG. 11) are also applicable in an analogous manner to the methods described above. For example, methods 700 and 900 optionally includes one or more of the characteristics of the various methods described above with reference to method 900. For example, the spatial capture mode and controls described with respect to method 1100 are integrated into camera user interfaces that also integrate the capture controls for stopping and pausing video described with respect to method 700 and/or the portrait capture effect controls described with respect to method 900. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the control of user interfaces such as camera user interfaces. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to personalize media capture user interfaces. Accordingly, use of such personal information data enables users to have customized control of user interfaces such as camera user interfaces. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of media capture user interfaces, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, personalized media capture user interfaces can be provided to users by inferring preferences based on non-personal information data or a bare minimum amount of personal information, such as the content being requested by the device associated with a user, other non-personal information available to the camera user interfaces, or publicly available information.

1-98. (canceled)

99. A computer system configured to communicate with one or more display generation components, one or more input devices, and one or more cameras, comprising:
one or more processors; and
memory storing one or more programs configured to be executed by the one or more processors, the one or more programs including instructions for:
displaying, via the one or more display generation components, a media capture user interface, wherein displaying the media capture user interface includes:
in accordance with a determination that a set of one or more portrait criteria is satisfied, displaying a camera preview and a portrait capture mode user interface object; and
in accordance with a determination that the set of one or more portrait criteria is not satisfied, displaying the camera preview without displaying the portrait capture mode user interface object;
while displaying the media capture user interface and while a portrait capture mode is not enabled, detecting, via the one or more input devices, an input directed to the portrait capture mode user interface object;
in response to detecting the input directed to the portrait capture mode user interface object:
changing an appearance of the media capture user interface to indicate that the portrait capture mode has been enabled; and
displaying, via the one or more display generation components, a portrait filter control object that, when selected, initiate a process for selecting, from a set of one or more portrait filters, a portrait filter to be used when capturing media with the portrait capture mode enabled;
detecting, via the one or more input devices, a sequence of one or more inputs including an input directed to the portrait filter control object; and
in response to detecting the sequence of one or more inputs, selecting a respective portrait filter from the set of one or more portrait filters as the portrait filter to be used when capturing media with the portrait capture mode enabled.

100. The computer system of claim 99, wherein the set of one or more portrait criteria includes a subject criterion that is satisfied when a respective subject is detected in a field of view of the one or more cameras represented in the camera preview.

101. The computer system of claim 99, wherein:
the set of one or more portrait criteria includes a focus criterion that is satisfied when an input directed to the camera preview is detected; and
the input directed to the camera preview is an input of a respective type.

102. The computer system of claim 99, the one or more programs further including instructions for:
while the portrait capture mode is enabled, detecting, via the one or more input devices, a respective input requesting to capture media;
in response to detecting the respective input requesting to capture media, capturing, via the one or more cameras, respective media that includes a representation of a field of view of the one or more cameras, wherein capturing the respective media includes:
in accordance with a determination that the respective portrait filter is selected when the input requesting to capture media is detected, designating the respective media for display with the respective portrait filter applied based on a respective subject detected in the field-of-view of the one or more cameras; and
displaying, via the one or more display generation components, the respective media, including:
in accordance with a determination that the respective media is designated for display with the respective portrait filter applied, applying the respective portrait filter to the representation of the field of view of the one or more cameras based on the respective subject detected in the field-of-view of the one or more cameras, including:
modifying an appearance of a first portion of the representation of the field-of-view of the one or more cameras in a first manner, wherein the first portion of the representation of the field-of-view of the one or more cameras includes a representation of the respective subject; and
modifying an appearance of a second portion of the representation of the field-of-view of the one or more cameras, different from the first portion of the representation of the field-of-view of the one or more cameras, in a second manner different from the first manner.

103. The computer system of claim 102, wherein:
applying the respective portrait filter to the representation of the field of view of the one or more cameras includes modifying an appearance of the representation of the field of view of the one or more cameras to simulate a first set of lighting conditions; and
displaying the respective media includes:
in accordance with a determination that the respective media is designated for display with a second respective portrait filter applied, wherein the second respective portrait filter is different from the respective portrait filter, applying the second respective portrait filter to the representation of the field of view of the one or more cameras based on the respective subject detected in the field-of-view of the one or more cameras, wherein applying the second respective portrait filter to the representation of the field of view of the one or more cameras includes modifying the appearance of the representation of the field of view of the one or more cameras to simulate a second set of lighting conditions different from the first set of lighting conditions.

104. The computer system of claim 102, wherein applying the respective portrait filter to the first portion of the representation of the field-of-view of the one or more cameras in the first manner includes modifying an appearance of the representation of the field of view of the one or more cameras based on depth information associated with the representation of the respective subject.

105. The computer system of claim 102, the one or more programs further including instructions for:
while the portrait capture mode is not enabled, detecting, via the one or more input devices, a second respective input requesting to capture media; and
in response to detecting the second respective input requesting to capture media, capturing, via the one or more cameras, second respective media that includes a second representation of a field-of-view of the one or more cameras, wherein capturing the second respective media includes foregoing designating the second respective media for display with a portrait filter of the set of one or more portrait filters applied.

106. The computer system of claim 99, the one or more programs further including instructions for:
in response to detecting the sequence of one or more inputs, applying the respective portrait filter to the camera preview, wherein applying the respective portrait filter to the camera preview includes modifying an appearance of a representation of a field-of-view of the one or more cameras displayed in the camera preview in a respective manner.

107. The computer system of claim 99, the one or more programs further including instructions for:
while displaying the media capture user interface and while a portrait capture mode is not enabled, displaying, via the one or more display generation components, a respective zoom control object at a first location within the media capture user interface; and
in response to detecting the input directed to the portrait capture mode user interface object, ceasing displaying the respective zoom control object at the first location within the media capture user interface, wherein displaying the portrait filter control object includes displaying the portrait filter control object at the first location within the media capture user interface.

108. The computer system of claim 99, the one or more programs further including instructions for:
while displaying the portrait filter control object, displaying, via the one or more display generation components, a respective zoom control object;
while displaying the respective zoom control object, detecting, via the one or more input devices, a respective input directed to the respective zoom control object; and
in response to detecting the respective input directed to the respective zoom control object, initiating a process for selecting a zoom level.

109. The computer system of claim 108, the one or more programs further including instructions for:
in response to detecting the input directed to the portrait capture mode user interface object, changing a location of the respective zoom control object from an initial location within the media capture user interface to a respective location within the media capture user interface that was not occupied by the zoom control object when the input directed to the portrait capture mode user interface object was detected.

110. The computer system of claim 109, wherein changing the location of the respective zoom control object from the initial location within the media capture user interface to the respective location within the media capture user interface includes displaying, via the one or more display generation components, an animation of the respective zoom control object moving from the initial location to the respective location.

111. The computer system of claim 109, the one or more programs further including instructions for:
while displaying the media capture user interface and while the portrait capture mode is enabled, detecting, via the one or more input devices, a second input directed to the portrait capture mode user interface object; and
in response to detecting the second input directed to the portrait capture mode user interface object:
changing the appearance of the media capture user interface to indicate that the portrait capture mode has been disabled; and
changing the location of the respective zoom control object from the respective location within the media capture user interface to the initial location within the media capture user interface.

112. The computer system of claim 99, the one or more programs further including instructions for:
while displaying the media capture user interface and while a portrait capture mode is not enabled, displaying, via the one or more display generation components, a respective zoom control object including a first set of one or more zoom control objects corresponding to a plurality of zoom levels; and
in response to detecting the input directed to the portrait capture mode user interface object, displaying, via the one or more display generation components, the respective zoom object including a second set of one or more zoom control objects corresponding to a set of one or more zoom levels, wherein the set of one or more zoom levels includes fewer zoom levels than the plurality of zoom levels.

113. The computer system of claim 112, wherein both the first set of one or more zoom control objects corresponding to the plurality of zoom levels and the second set of one or more zoom control objects corresponding to the set of one or more zoom levels include a first zoom control object, the one or more programs further including instructions for:
while displaying the respective zoom object, detecting, via the one or more input devices, an input directed to the first zoom control object; and
in response to detecting the input directed to the first zoom control object:
in accordance with a determination that a first set of one or more criteria is satisfied, initiating a first process for selecting a zoom level to be used when capturing media, wherein the first set of one or more criteria includes a criterion that is satisfied when the input directed to the first zoom control object is detected while the portrait capture mode is not enabled; and
in accordance with a determination that a second set of one or more criteria, different from the first set of one or more criteria, is satisfied, initiating a second process, different from the first process, for selecting the zoom level to be used when capturing media, wherein the second set of one or more criteria includes a criterion that is satisfied when the input directed to the first zoom control object is detected while the portrait capture mode is enabled.

114. The computer system of claim 112, wherein:
the first set of one or more zoom control objects corresponding to the plurality of zoom levels includes a second zoom control object corresponding to a respective zoom level of the plurality of zoom levels; and
the second set of one or more zoom control objects corresponding to the set of one or more zoom levels does not include a zoom control object corresponding to the respective zoom level of the plurality of zoom levels.

115. The computer system of claim 112, the one or more programs further including instructions for:
while displaying the respective zoom control object, detecting, via the one or more input devices, one or more inputs directed to the respective zoom control object; and
in response to detecting the one or more inputs directed to the respective zoom control object:
in accordance with a determination that a third set of one or more criteria is satisfied, initiating a third process for selecting a zoom level from a first zoom range to be used when capturing media, wherein the third set of one or more criteria includes a criterion that is satisfied when the input directed to the respective zoom control object is detected while the portrait capture mode is not enabled; and
in accordance with a determination that a fourth set of one or more criteria, different from the third set of one or more criteria, is satisfied, initiating a fourth process, different from the third process, for selecting the zoom level from a second zoom range to be used when capturing media, wherein:
the second set of one or more criteria includes a criterion that is satisfied when the input directed to the respective zoom control object is detected while the portrait capture mode is enabled; and
the second zoom range is narrower than the first zoom range.

116. The computer system of claim 115, wherein a lowest zoom level of the first zoom range is lower than a lowest zoom level of the second zoom range.

117. The computer system of claim 99, the one or more programs further including instructions for:
while displaying the media capture user interface including the portrait filter control object, detecting, via the one or more input devices, an input directed to the portrait filter control object; and
in response to detecting the input directed to the portrait filter control object, initiating the process for selecting, from the set of one or more portrait filters, a portrait filter to be used when capturing media with the portrait capture mode enabled, wherein initiating the process for selecting a portrait filter to be used when capturing media with the portrait capture mode enabled includes:
displaying, via the one or more display generation components, an expanded portrait filter control object; and
ceasing displaying one or more user interface objects of the media capture user interface.

118. The computer system of claim 99, the one or more programs further including instructions for:
while displaying the media capture user interface including the portrait filter control object:
displaying, via the one or more display generation components, a respective zoom control object; and
detecting, via the one or more input devices, a first input directed to the respective zoom control object; and
in response to detecting the first input directed to the respective zoom control object, initiating a process for selecting a zoom level to be used when capturing media, wherein initiating the process for selecting a zoom level to be used when capturing media includes:
displaying, via the one or more display generation components, a first expanded zoom control object; and
ceasing displaying one or more user interface objects of the media capture user interface.

119. The computer system of claim 99, the one or more programs further including instructions for:
while displaying the media capture user interface including the portrait filter control object:
displaying, via the one or more display generation components, a respective zoom control object; and
detecting, via the one or more input devices, a second input directed to the respective zoom control object; and
in response to detecting the second input directed to the respective zoom control object, initiating a process for selecting a zoom level to be used when capturing media, wherein initiating the process for selecting a zoom level to be used when capturing media includes:
displaying, via the one or more display generation components, a second expanded zoom control object; and
maintaining displaying one or more user interface objects of the media capture user interface.

120. The computer system of claim 99, the one or more programs further including instructions for:
while displaying the media capture user interface, detecting, via the one or more input devices, an input directed to a respective location within the camera preview; and
in response to detecting the input directed to the respective location within the camera preview:
in accordance with a determination that a first set of criteria is satisfied, selecting, from the set of one or more portrait filters, the portrait filter to be used when capturing media with the portrait capture mode enabled, wherein the first set of criteria includes a criterion that is satisfied when the portrait capture mode is enabled; and
in accordance with a determination that the first set of criteria is not satisfied, foregoing selecting the portrait filter to be used when capturing media with the portrait capture mode enabled.

121. The computer system of claim 99, the one or more programs further including instructions for:
while displaying the media capture user interface, detecting, via the one or more input devices, an input directed to a respective location within the camera preview; and
in response to detecting the input directed to the respective location within the camera preview:
in accordance with a determination that a second set of criteria is satisfied, changing a zoom level to be used when capturing media with the portrait capture mode enabled, wherein the second set of criteria includes a criterion that is satisfied when the portrait capture mode is enabled; and
in accordance with a determination that the second set of criteria is not satisfied, foregoing changing the zoom level to be used when capturing media.

122. The computer system of claim 99, the one or more programs further including instructions for:
while displaying the media capture user interface and while the portrait capture mode is enabled, detecting, via the one or more input devices, an input requesting to disable the portrait capture mode; and
in response to detecting the input requesting to disable the portrait capture mode:
changing an appearance of the media capture user interface to indicate that the portrait capture mode has been disabled; and
ceasing displaying the portrait filter control object.

123. The computer system of claim 99, the one or more programs further including instructions for:
while the portrait capture mode is enabled and after selecting the respective portrait filter from the set of one or more portrait filters as the portrait filter to be used when capturing media with the portrait capture mode enabled, detecting, via the one or more input devices, a respective input requesting to capture media; and
in response to detecting the respective input requesting to capture media, capturing, via the one or more cameras, respective media that includes a representation of a field-of-view of the one or more cameras, wherein capturing the respective media includes applying the respective portrait filter to the representation of the field-of-view of the one or more cameras.

124. The computer system of claim 123, the one or more programs further including instructions for:
displaying, via the one or more display generation components, the respective media with the respective portrait filter applied to the representation of a field-of-view of the one or more cameras;
while displaying the respective media with the respective portrait filter applied, detecting, via the one or more input devices, a second sequence of one or more inputs; and
in response to detecting the second sequence of one or more inputs, displaying, via the one or more display generation components, the respective media without the respective portrait filter applied to the representation of a field-of-view of the one or more cameras.

125. The computer system of claim 123, the one or more programs further including instructions for:
while the portrait capture mode is enabled and after selecting the respective portrait filter from the set of one or more portrait filters as the portrait filter to be used when capturing media with the portrait capture mode enabled, applying the respective portrait filter to the camera preview.

126. The computer system of claim 99, wherein:
the media capture user interface includes a capture control object; and
the one or more programs further including instructions for:
detecting, via the one or more input devices, an input directed to the capture control object; and
in response to detecting the input directed to the capture control object:
in accordance with a determination that, when the input directed to the capture control object is detected, a first set of one or more capture settings is selected to be used when capturing media, capturing, via the one or more cameras, first media, wherein the first media is captured with the first set of media capture settings; and
in accordance with a determination that, when the input directed to the capture control object is detected, a second set of one or more capture settings is selected to be used when capturing media, capturing, via the one or more cameras, second media, wherein:
the second media is captured with the second set of media capture settings; and
the second set of one or more capture settings is different from the first set of one or more capture settings.

127. The computer system of claim 99, the one or more programs further including instructions for:
while displaying the media capture user interface and while the portrait capture mode is enabled:
in accordance with a determination that a zoom level selected to be used when capturing media is included a respective set of one or more zoom levels, enabling a low-light capture process to be used when capturing media.

128. The computer system of claim 127, the one or more programs further including instructions for:
while displaying the media capture user interface and while the portrait capture mode is enabled:
in accordance with a determination that the zoom level selected to be used when capturing media is not included the respective set of one or more zoom levels, foregoing enabling the low-light capture process to be used when capturing media.

129. The computer system of claim 99, the one or more programs further including instructions for:
while displaying the media capture user interface and while the portrait capture mode is enabled:
displaying a plurality of user interface objects;
detecting, via the one or more input devices, an input directed to a first user interface object of the plurality of user interface objects; and
in response to detecting the input directed to the first user interface object of the plurality of user interface objects:
initiating a process for performing an operation associated with the first user interface object; and
reducing a visual prominence of at least one user interface object, different from the first user interface object, of the plurality of user interface objects.

130. The computer system of claim 129, wherein reducing the visual prominence of the at least one user interface object of the plurality of user interface objects includes reducing a visual prominence of the at least one user interface object relative to the camera preview.

131. A non-transitory computer-readable storage medium storing one or more programs configured to be executed by one or more processors of a computer system that is in communication with one or more display generation components, one or more input devices, and one or more cameras, the one or more programs including instructions for:
displaying, via the one or more display generation components, a media capture user interface, wherein displaying the media capture user interface includes:
in accordance with a determination that a set of one or more portrait criteria is satisfied, displaying a camera preview and a portrait capture mode user interface object; and
in accordance with a determination that the set of one or more portrait criteria is not satisfied, displaying the camera preview without displaying the portrait capture mode user interface object;
while displaying the media capture user interface and while a portrait capture mode is not enabled, detecting, via the one or more input devices, an input directed to the portrait capture mode user interface object;
in response to detecting the input directed to the portrait capture mode user interface object:
changing an appearance of the media capture user interface to indicate that the portrait capture mode has been enabled; and
displaying, via the one or more display generation components, a portrait filter control object that, when selected, initiate a process for selecting, from a set of one or more portrait filters, a portrait filter to be used when capturing media with the portrait capture mode enabled;
detecting, via the one or more input devices, a sequence of one or more inputs including an input directed to the portrait filter control object; and
in response to detecting the sequence of one or more inputs, selecting a respective portrait filter from the set of one or more portrait filters as the portrait filter to be used when capturing media with the portrait capture mode enabled.

132. A method, comprising:
at a computer system that is in communication with one or more display generation components, one or more input devices, and one or more cameras:
displaying, via the one or more display generation components, a media capture user interface, wherein displaying the media capture user interface includes:
in accordance with a determination that a set of one or more portrait criteria is satisfied, displaying a camera preview and a portrait capture mode user interface object; and
in accordance with a determination that the set of one or more portrait criteria is not satisfied, displaying the camera preview without displaying the portrait capture mode user interface object;
while displaying the media capture user interface and while a portrait capture mode is not enabled, detecting, via the one or more input devices, an input directed to the portrait capture mode user interface object;
in response to detecting the input directed to the portrait capture mode user interface object:
changing an appearance of the media capture user interface to indicate that the portrait capture mode has been enabled; and
displaying, via the one or more display generation components, a portrait filter control object that, when selected, initiate a process for selecting, from a set of one or more portrait filters, a portrait filter to be used when capturing media with the portrait capture mode enabled;
detecting, via the one or more input devices, a sequence of one or more inputs including an input directed to the portrait filter control object; and
in response to detecting the sequence of one or more inputs, selecting a respective portrait filter from the set of one or more portrait filters as the portrait filter to be used when capturing media with the portrait capture mode enabled.
